(19) United States
(12) Patent Application Publication
(10) Pub. No.: US 2025/0242305 A1
(43) Pub. Date: Jul. 31, 2025

(54) TEXTILE GAS-LIQUID-SOLID CONTACTORS AND BIOCATALYTIC MATERIALS AND METHODS COMPRISING SAME

(71) Applicant: North Carolina State University, Raleigh, NC (US)

(72) Inventors: Sonja SALMON, Raleigh, NC (US); Yue YUAN, Raleigh, NC (US); Jialong SHEN, Cary, NC (US)

(21) Appl. No.: 18/287,516

(22) PCT Filed: Apr. 6, 2022
(86) PCT No.: PCT/US22/23646

§ 371 Date: Oct. 19, 2023

Related U.S. Application Data
(60) Provisional application No. 63/197,584, filed on Jun. 7, 2021.
(60) Provisional application No. 63/176,393, filed on Apr. 19, 2021.

(51) Int. Cl. B01D 53/84; B01D 53/62; D06M 15/03; D06M 16/00; D06M 101/06

(52) U.S. Cl. CPC B01D 53/84; B01D 53/62; C12Y 402/01001; D06M 15/03; D06M 16/003; B01D 2255/804; B01D 2257/504; B01D 2258/0283; B01D 2258/06; D06M 2101/06

(57) ABSTRACT

In various exemplary embodiments, the present disclosure provides novel water-absorbent textile-based gas-liquid-solid contactors for carbon dioxide (CO₂) gas separation, as well as novel methods for producing and using these materials. The water-absorbent textile-based contactors of the present invention allow aqueous liquids to penetrate and travel intimately throughout the water-absorbent textile structure. The textile structure comprises many fibers with small diameters which creates a very high surface area. When exposed to a gas, the gas will be in contact with liquid spread throughout the solid wetted textile structure, all three phases “gas-liquid-solid” are in intimate contact. The textile contactor itself has superior performance compared to conventional packing materials, and, when combined with biocatalysts, the performance improves even more dramatically. By incorporating a biocatalyst, the invention enables use of benign solvents that have otherwise been overlooked in conventional systems due to poor kinetics.

### CROSS-REFERENCE

This application claims the benefit of PCT Application PCT/US22/23646 which claims priority to U.S. Provisional Application Ser. No. 63/176,393 filed on Apr. 19, 2021, and U.S. Provisional Application Ser. No. 63/197,584 filed on Jun. 7, 2021, all of which are incorporated herein by reference in their entirety.

The present invention was made with government support under grant number DE-AC36-08GO28308 awarded by the U.S. Department of Energy (DOE/EERE). The government has certain rights in the invention.

### FIELD OF THE INVENTION

The invention relates generally to gas-liquid-solid contactors. This invention pertains to textile-based gas-liquid-solid contactors and materials, and especially pertains to biocatalytically reactive textile-based gas-liquid-solid contactors and materials.

### BACKGROUND

The importance of creating high gas-liquid or gas-liquid-solid contact area is a critical and recurrent theme in gas separations and distillation technology development. Many sophisticated advances in contactor packing design have exactly targeted this issue. Materials used to fabricate both conventional and advanced packings typically include stainless steel, glass and ceramic. The gas-liquid contact area is created by the flow and spread of liquid across the solid non-moisture permeable hard surfaces of the packing, as well as by drops formed when the liquid spills from one packing surface to another. Another conventional way to promote gas-liquid contact is by use of porous hollow fiber membrane contactors. The materials used for these membranes are typically hydrophobic.

Conventional gas-liquid contactors are equipment assemblies, porous media or a non-absorbent solid devices used to promote mass transfer between a gas phase and a liquid phase. Conventional gas-liquid contactors include falling-film columns, packed columns, bubble columns, spray towers, centrifugal contactors, porous hollow fiber membranes and gas-liquid agitated vessels.

There is a need to overcome the persistent issues of inlet liquid distribution, wall effects, channeling and flooding experienced by conventional packings.

There is a need for improved capabilities to capture CO₂ in many diverse carbon dioxide capture and carbon dioxide gas separation applications, including natural gas (NG), liquefied natural gas (LNG) and biogas up-grading, CO₂ capture from combustion exhaust gas (e.g. coal, oil, NG, biomass fired power plants and industrial boilers), ammonia manufacture, CO₂ removal from buildings (e.g. libraries, museums, offices, breweries) and other confined spaces (e.g. submarines, rebreathers), CO₂ management in extended space travel (e.g. Mars mission), and CO₂ removal from blood for medical treatment (e.g. dialysis).

Furthermore, there is a need for the ability to absorb CO₂ at low ppm levels in air, and being able to do that at ambient conditions with completely non-hazardous materials that could be made as light weight modular units, easily fabricated anywhere in the world.

### SUMMARY OF THE INVENTION

According to an exemplary embodiment of the invention, a textile packing comprising: a) hydrophilic fibers and b) a support structure. The support structure holds the hydrophilic fibers. A top end and a bottom end of at least a portion of the hydrophilic fibers are fluidly connected.

According to another exemplary embodiment of the invention, a textile packing comprising: a) hydrophilic fibers; b) an active enzyme; and c) a support structure. The active enzyme is attached to the hydrophilic fibers. The support structure holds the hydrophilic fibers. A top end and a bottom end of at least a portion of the hydrophilic fibers are fluidly connected.

According to another exemplary embodiment of the invention, a process for removing CO₂ from a gas is presented. The process comprises: a) feeding a first CO₂-rich gas to a first reactor, b) feeding a CO₂-lean absorption liquid to the first reactor, c) reacting the CO₂ in the first gas with a component of the absorption liquid as the first gas and the absorption liquid flow through a first reaction zone to form a CO₂-lean gas and a CO₂-rich absorption liquid, d) removing the CO₂-lean gas from the first reactor; and e) removing the CO₂-rich absorption liquid near the bottom of the first reactor. The first reaction zone contains a gas-liquid contact enhancer, and the gas-liquid contact enhancer comprises at least one of a textile packing comprising: a) hydrophilic fibers b) an optional active enzyme; and c) a support structure. The active enzyme is attached to the hydrophilic fibers. The support structure holds the hydrophilic fibers. A top end and a bottom end of at least a portion of the hydrophilic fibers are fluidly connected.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1. Is a schematic of (a) conventional surface wetted solid packing with liquid travelling along the outside packing surfaces, and (b) Hydrophilic yarn or fiber that creates a liquid-saturated solid-gas interface, (c) Hydrophilic yarn or fiber with permeable coating that optionally comprises enzymes, (d) Core-shell yarn construction, with hydrophobic core fibers and hydrophilic shell fibers, with optionally immobilized enzymes, and (e) Core-shell yarn construction, with hydrophilic core fibers comprising optionally immobilized enzymes, and hydrophobic yarn shell with gas permeable construction;

FIG. 2. is a schematic of a conventional process for recirculating solvent-based absorption and desorption for CO₂ separation and capture (a), recirculating solvent-based absorption with air sweep desorption for CO₂ separation and release (b), CO₂ absorption into industrial process water and utilization or sequestration as one or more salts of divalent cations or polycationic compounds (c), and integrated biological system (d) processes utilizing textile-based packing with immobilized CA to enhance CO₂ absorption and/or desorption from gas mixtures comprising CO₂, including from air;

FIG. 3. is two SEM images showing the morphology differences of 1% Chitosan dip-coated on cheesecloth 90 processed by (a) air drying and (b) freeze drying;

FIG. 4. is an illustration of the materials and assembly of a small spiral textile-based packing;

FIG. 5. is an illustration of the materials and assembly of a large spiral textile-based packing;

FIG. 6. is an illustration of how four cones were assembled and wrapped inside an outer support to form a cylinder with both vertical and horizontal contact surfaces;

FIG. 7. is two schematics of CO₂ absorption at laboratory scale operating with flow-through absorption in (a) counter-current flow mode and (b) co-current flow mode;

FIG. 8. is a schematic comparisons of carbonic anhydrase (CA) enzymes immobilized using different immobilization methods;

FIG. 9a is a graph showing activity retention for repeated washing and

testing of CA entrapped in chitosan dip-coated on cheesecloth 90;

FIG. 9b. is a graph showing activity retention for repeated washing and

testing of CA entrapped in chitosan padded on cheesecloth 90;

FIG. 10. is a graph of continuous solvent (30% MDEA, pH unadjusted) and

heat (stepwise increase) stress test for CA entrapped in chitosan dip-coated on cheesecloth 90 (1:0.8 chitosan: CA stock solution);

FIG. 11a. is a graph of CO₂ detector response, in arbitrary units (A.U.), for CO₂ absorption trials of packings #1 (Control) and #2 (Enzyme) at high gas flow (High flow) and low gas flow (Low flow) conditions using nominal 10%-wt. K₂CO₃/KHCO₃ solvent with initial pH 10.2;

FIG. 11b. is a graph of CO₂ detector response, in arbitrary units (A.U.) for second CO₂ absorption trial of packing #1 (P1-Control) and #2 (P2-Enzyme) after 1 week dry storage using 20%-wt. K₂CO₃ solvent with initial pH 12.2 and final pH of 11.2;

FIG. 11c. is a graph of CO₂ absorption test recorded as volume %; Small packings #1 and #2 were previously tested twice and were rinsed with tap water and air dried after each test; Packings #3 and #5 were tested for the first time; All packings were stored dry at room temperature for 2 months; (Total mixed gas flow rate: 4 LPM, nominal 10% K₂CO₃/KHCO₃: 85/15 mixture pH ˜10.5, solvent flow rate: 75 mL/min);

FIG. 11d. is a graph of CO₂ detector response curves of control packing (#1) and enzyme packing constructed using regenerated cellulose nanofibers (Example 5); CO₂ detection in arbitrary units (A.U.);

FIG. 12a. is a graph of CO₂ absorption tests for large cone packings K with total mixed gas flow of 4 L/min and nominal 10% K₂CO₃/KHCO₃ (85/15 mixture pH ˜10.5) solvent flow rate of 150 mL/min;

FIG. 12b. is a graph of CO₂ absorption tests for large spiral packings L in single and double stacked configurations in comparison to the standard (single height) Raschig ring packing;

FIG. 12c. is a graph showing the CO₂ absorption efficiency curves of control cheesecloth 90 packing and enzyme packing constructed using regenerated cellulose nanofibers; CO₂ detection in arbitrary units (A.U.);

FIG. 13. is an optical microscope image of an immobilization formulation prepared by suspending chitosan-NZCA paste in chitosan-salt solution;

FIG. 14. is three optical microscopic images of a) untreated cellulosic substrate and textile-based biocatalytic materials b) prepared in Example 20, and c) prepared in Example 21 on cheesecloth 90;

FIG. 15a. is a graph of a pNP standard curve measured in 25 mM Tris buffer pH 7.2 using a 24-well plate;

FIG. 15b. is a graph of the kinetic pNP release curves for a no-enzyme control and a textile with immobilized CA enzyme;

FIG. 16. is a schematic drawing of rotisserie end-to-end agitation;

FIG. 17. is a graph of activity retention over time in the accelerated durability test using rotisserie-style incubator. Conditions were: End-to-end rotation at 25 RPM, incubated at 27° C. from 0-585 hours and at 45° C. from 586 to 730 hours;

FIG. 18. is a photograph showing the appearances of samples on row B of the assay plate shown at different times over a period of 1 month (730 hours) in the accelerated durability test;

FIG. 19a. is a graph of pNP release rate measured by esterase activity assay;

FIG. 19b. is a graph of immobilized CA activity retention (%). The esterase activity of the first data point for each sample was taken as 100%;

FIG. 20. is a graph of CO₂ capture efficiency vs. liquid to gas flow rates ratio (L/G) of different L packings;

FIG. 21. is three SEM images of (a) polyvinyl alcohol (PVA) nanofiber, (b) Cellulose (deacetylated cellulose acetate) nanofibers coated with 1% chitosan solution, and (c) surface covalently immobilized 3-D aggregate NZCA on cheesecloth #90;

FIG. 22. is a graph of CO₂ absorption tests at ambient temperature (˜22° C.) for packing with total mixed gas flow rate of 4 L/min and nominal 10% K₂CO₃/KHCO₃ (85/15 mixture pH ˜10.5) solvent flow rate of 120 mL/min;

FIG. 23. is a graph of lab scale CO₂ air capture test, using seawater adjusted to pH 10, shows gas-liquid contactor benefit is dramatically enhanced with immobilized enzyme present;

FIG. 24. is a graph of pH change of a 1 L disodium phosphate buffer (25 mM, pH 10.50) over time in CO₂ absorption test running in continuous recirculating mode (Legend format: Packing type/Air flow rate/Buffer flow rate);

FIG. 25a. is a graph of CO₂% in the exiting gas and pH change of the solvent in the reservoir during absorption and desorption in recirculating mode, with markers showing process step points at which gas and liquid flows were turned on and off;

FIG. 25b. is a graph comparing CO₂% readings in the exiting gas in the absorption and desorption processes for L1 no-enzyme control packing and L surface immobilized packing at room temperature;

FIG. 25c. is a graph comparing pH changes of the solvent in the reservoir in the absorption and desorption processes for L1 no-enzyme control packing and L surface immobilized packing at room temperature;

FIG. 25d. is a graph comparing CO₂% readings in the exiting gas in the absorption and desorption processes for L1 no-enzyme control packing and L surface immobilized packing at 45+5° C.;

FIG. 25e. is a graph comparing pH changes of the solvent in the reservoir in the absorption and desorption processes for L1 no-enzyme control packing and L surface immobilized packing at 45+5° C.;

FIG. 26. is an illustration of the materials and assembly of the smocked fabric packing with rigid rods; and

FIG. 27. is an illustration of the materials and assembly of large spiral packing with metal spacers.

### DETAILED DESCRIPTION

The present invention provides in an exemplary embodiment a textile packing comprises: a) hydrophilic fibers and b) a support structure. The support structure holds the hydrophilic fibers. A top end and a bottom end of at least a portion of the hydrophilic fibers are fluidly connected.

It is to be understood that the mention of one or more method steps does not preclude the presence of additional method steps before or after the combined recited steps or intervening method steps between those steps expressly identified. Moreover, the lettering of method steps or ingredients is a conventional means for identifying discrete activities or ingredients and the recited lettering can be arranged in any sequence, unless otherwise indicated.

As used herein, the singular forms “a,” “an,” and “the” include plural referents unless the context clearly dictates otherwise. For example, “a rod” can refer to one or more rods. As such, the terms “a”, “an”, “one or more” and “at least one” can be used interchangeably. Also, the plural referents include the singular form unless the context clearly dictates otherwise.

As used herein, the term “and/or”, when used in a list of two or more items, means that any one of the listed items can be employed by itself, or any combination or two or more of the listed items can be employed. For example, if a composition is described as containing compounds A, B, “and/or” C, the composition may contain A alone; B alone; C alone; A and B in combination; A and C in combination; B and C in combination; or A, B, and C in combination.

As used herein, the term “gas-liquid contactor” refers to chemical process equipment used to realize the mass and/or heat transfer between a gas phase and a liquid phase. As used herein, the term “packing” refers to a type of gas-liquid contactor that is contained within a piece of process equipment. Non-limiting examples of packing include Raschig rings, Pall Rings, Saddle rings, and various structured packings. As used herein, the term “textile packing” refers to a packing comprising hydrophilic fibers.

As used herein, the term “hydrophilic fibers “, refers to fibers that have a moisture regain of at least 0.1% according to Table 1 Commercial Moisture Regain Values in ASTM D1909-13 (2020) e1 “Standard Tables of Commercial Moisture Regains and Commercial Allowances for Textile Fibers”, or, if not specified therein, have a moisture regain of at least 0.1% when tested according to ASTM D629-15 “Standard Test Methods for Quantitative Analysis of Textiles”, Section 9 Moisture Content and Moisture Regain.

As used herein, the term “hydrophobic fibers”, refers to fibers that have a moisture regain of less than 0.1% according to Table 1 Commercial Moisture Regain Values in ASTM D1909-13 (2020) e1 “Standard Tables of Commercial Moisture Regains and Commercial Allowances for Textile Fibers”, or, if not specified therein, have a moisture regain of less than 0.1% when tested according to ASTM D629-15 “Standard Test Methods for Quantitative Analysis of Textiles”, Section 9 Moisture Content and Moisture Regain.

As used herein, the term “holds” as in the “support structure holds the hydrophilic fibers” refers to the support structure sustaining the hydrophobic fibers in the desired shape and direction. Non-limiting examples of a support structure that holds the hydrophilic fibers include, a rod above the hydrophilic fibers to which the fibers are attached (e.g., like a curtain rod), a support mesh around which the fibers are rolled, and a support structure built into a textile.

As used herein, the term “rigid rod”, refers to a long and thin bar that substantially maintains its dimensions when used as the support structure of a textile packing.

As used herein, the term “carbonic anhydrase” and the initials “CA” are used interchangeably and refer to a family of enzymes that catalyze the interconversion between carbon dioxide and water and the dissociated ions of carbonic acid.

As used herein, the term “CO₂-rich gas” generally refers to a gas mixture with a relatively high CO₂ content, or it can be a pure stream of CO₂ gas. A CO₂-rich gas can be a feed gas. The term “CO₂-lean gas” generally refers to a gas mixture that is depleted in CO₂ content compared to the CO₂-rich gas from which at least a portion of CO₂ was removed. A CO₂-lean gas can be a gas that does not comprise CO₂, e.g., a pure stream of nitrogen gas. A CO₂-lean gas can be used as a sweep gas to help remove CO₂ from a CO₂-rich liquid.

As used herein, the terms “CO₂-lean” and “CO₂-rich” absorption liquid refer to the relative amount of carbon (e.g., in the form of dissolved CO₂, chemically reacted CO₂, bicarbonate, carbonic acid and/or carbonate salt) present in the absorption liquid as it circulates through the process. As used herein, the term “CO₂-lean liquid” generally refers to absorption liquid entering an absorption unit. The term “CO₂-rich liquid” generally refers to an absorption liquid entering a desorption unit. It is understood that the term “CO₂-lean liquid” can also be applied to absorption liquid exiting a desorption module, and the term “CO₂-rich liquid” can also be applied to absorption liquid exiting an absorption unit. CO₂-rich liquid contains more carbon compared to CO₂-lean liquid within a given system at a given point in time.

As used herein, the term “component” as in a “component of the absorption liquid” refers to the chemical moiety that takes part in the equilibrium reaction of converting CO₂ in a “CO₂-rich gas” to bicarbonate in a “CO₂-rich liquid” of an absorption process and/or converting bicarbonate in a “CO₂-rich liquid” to CO₂ in a “CO₂-rich gas” of a desorption process. Non-limiting examples include alkanolamines, aqueous soluble salts, and amino acids,

The form of the hydrophilic fibers in the textile packing is not particularly limited. In some aspects, a filament, a yarn, and/or a textile comprises the hydrophilic fibers. In some aspects, a filament comprises the hydrophilic fibers. In some aspects, a yarn comprises the hydrophilic fibers. In some aspects, a textile comprises the hydrophilic fibers. In some aspects, the textile is a knitted, woven, and/or nonwoven fabric.

In some aspects, at least a portion of the hydrophilic fibers comprise polysaccharide fiber, cellulosic fiber, protein fiber, polyamide fiber, acetate fiber, triacetate fiber, modified cellulosic fiber, acrylic fiber, modacrylic fiber, polyvinyl alcohol fiber (vinal), poly(ethylene oxide) (PEO) fiber, crosslinked poly(ethylene glycol) diacrylate fiber, polyester fiber, hydrophilic modified polyester fiber, poly(lactic acid) fiber, poly(hydroxyalkanoate) fiber, and/or poly(etheretherketone) (PEEK) fiber. In some aspects, at least a portion of the hydrophilic fibers comprise cotton, jute, flax, hemp, ramie, viscose (rayon), lyocell, silk, wool, nylon, aromatic polyamide (aramid), cellulose acetate, acrylic, modacrylic, polyvinyl alcohol, poly(ethylene oxide) (PEO), crosslinked poly(ethylene glycol) diacrylate, polyester, hydrophilic modified polyester, poly(lactic acid), poly(hydroxyalkanoate), polyalanine (PANI), poly(phenylenediamine), chitaline, polyvinyl pyrrolidone (PVP), crosslinked polyvinylpyrrolidone and/or poly(etheretherketone) (PEEK). In some aspects, the hydrophilic fibers comprise a natural or synthetic polymer. In some aspects, the hydrophilic fibers comprise a crosslinking agent. In some aspects, the hydrophilic fibers comprise a polysaccharide material. In some aspects, the hydrophilic fibers comprise a polysaccharide material modified by oxidation, e.g., oxidation with sodium periodate or with the N-oxoammonium salt of (2,2,6,6-tetramethylpiperidin-1-yl)oxyl (TEMPO) or structural analogs including 4-hydroxy-TEMPO (TEMPOL). In some aspects, hydrophilic fibers comprise a cellulosic material. In some aspects, the hydrophilic fibers comprise cotton. In some aspects, the cellulosic material comprises lignin, e.g., natural combinations of cellulose and lignin, such as bast fibers, including jute, flax, hemp and ramie, or manufactured combinations of cellulose and lignin. In some aspects, the hydrophilic fibers comprise polyvinyl alcohol (PVA) fibers treated with a cross-linking agent to render the PVA fibers water insoluble. In some aspects, the hydrophilic fibers comprise polyalanine (PANI), poly(phenylenediamine), chitaline, polyvinyl pyrrolidone (PVP), and/or crosslinked polyvinylpyrrolidone. In some aspects, the hydrophilic fibers comprise co-polymers and/or blends of polymers.

In some aspects, the yarn and/or textile comprise hydrophobic fibers. In some aspects, at least a portion of the hydrophobic fibers comprise olefin, fluorocarbon, vinyon, glass, metallic, rubber, polyvinylidene chloride (Saran®), and/or carbon fiber. In some aspects, the hydrophobic fibers comprise co-polymers and/or blends of polymers.

Hydrophilic fibers, whether in a filament, yarn, or textile, are inherently pliable, and can be fabricated into different configurations. When used as a textile packing, the hydrophilic fibers need a support to maintain their functional configuration while the textile packing is in operation. In some aspects, the support also ensures space between layers of the hydrophilic fibers for the gas to pass through the packing. In some aspects, the support structure comprises a mesh and/or rigid rods. In some aspects, the mesh comprises natural polymer, synthetic polymer, and/or metal. In some aspects, the rigid rods comprise glass, plastic, polymer composite, wood, metal, and/or bamboo. In some aspects, the support structure comprises a wire or filament wrapped within or together with the hydrophilic fibers. In some aspects, the wire comprises metal. In some aspects, the filament comprises natural polymer, synthetic polymer, glass, i.e., glass fiber, and/or carbon, i.e., carbon fiber. In some aspects, the support structure comprises a substantially horizontal rigid rod to which at least one end of the textile packing is attached along a length of the rod, e.g., as a curtain. In some aspects, the horizontal rigid rod is formed in a spiral, zig-zag, and/or reversing rows shape to which at least one end of the textile packing is attached in a way that follows the shape, e.g., as a curtain. In some aspects, the textile packing is attached to the support structure in a way that creates gathers and/or folds in the textile packing. In some aspects, the support structure has the shape of a vertical coil and is connected to or interlaced with the textile to support the textile in a vertical configuration. In some aspects, clips, pins, grommets, threads, loops, hooks, glues, adhesives, or other attachment devices are used to attach the textile packing to the support structure. In some aspects, the textile packing is interlaced with or looped around the support structure.

In some aspects, a textile comprises the hydrophilic fibers and the textile packing is in the shape of a jelly roll. In some aspects, the jelly roll is formed by layering the textile and the mesh to form layers and winding the layers together in the horizontal direction. In some aspects, the textile packing is in the shape of a jelly roll formed by wrapping the textile around the mesh to form a support sandwich and winding the support sandwich in the horizontal direction. In some aspects, the textile packing further comprises a spacer attached to the textile or the mesh. The spacer ensures space between the spiral layers for gas flow. The placing of the spacers is not particularly limited, they can be near the top of the textile and/or mesh, near the bottom of the textile and/or mesh, or somewhere in between.

The size of the packing is not particularly limited. In some aspects, a diameter of the packing ranges from 1 cm to 10 m. Other non-limiting examples of diameter ranges include from 1 cm to 10 m, or 1 cm to 5 m, or 1 cm to 3 m, or 1 cm to 1 m, or 1 cm to 100 cm, or 1 cm to 50, or 10 cm to 10 m, or 10 cm to 5 m, or 10 cm to 3 m, or 10 cm to 1 m, or 10 cm to 100 cm, or 10 cm to 50 m, or 100 cm to 10 m, or 100 cm to 5 m, or 100 cm to 3 m, or 100 cm to 1 m. In some aspects, a diameter of the jelly roll is less than 10 m, less than 5 m, less than 3 m, less than 1 m, less than 100 cm, or less than 50 cm. In some aspects, the height of the textile packing ranges from 1 cm to 30 m. Other non-limiting ranges for the textile packing height include 1 cm to 10 m, or 1 cm to 5 m, or 1 cm to 3 m, or 1 cm to 1 m, or 1 cm to 100 cm, or 1 cm to 50, or 10 cm to 10 m, or 10 cm to 5 m, or 10 cm to 3 m, or 10 cm to 1 m, or 10 cm to 100 cm, or 10 cm to 50, or 100 cm to 10 m, or 100 cm to 5 m, or 100 cm to 3 m, or 100 cm to 1 m. In some aspects, the height of the packing is less than 10 m, less than 5 m, less than 3 m, less than 1 m, less than 100 cm, or less than 50 cm.

In some aspects, a textile comprises the hydrophilic fibers and the support structure comprises multiple rigid rods attached substantially vertically across the textile. In some aspects, the textile packing is in the shape of a jelly roll formed by winding the rigid-rod-attached textile in the horizontal direction. In some aspects, the rigid rods are attached to the textile by interlacing the rigid rods in the vertical direction across the textile.

In addition to providing improved gas-liquid contact, the textile packing of the present invention typically weighs less than conventional packing, potentially lowering construction costs of the absorber and/or desorber. In some aspects, a total weight of one or more of the textile packing, on a dry basis, is less than 50 wt. % of one or more glass Raschig ring packing of an equivalent volume. In other non-limiting examples, a total weight of one or more of the textile packing, on a dry basis, is less than 80 wt. %, less than 70 wt. %, less than 60 wt. %, of the weight of a glass Raschig ring packing of an equivalent volume. In some aspects, a total weight of one or more of the textile packing, on a wet basis, is less than 50 wt. % of one or more glass Raschig ring packing of an equivalent volume. In other non-limiting examples, a total weight of one or more of the textile packing, on a wet basis, is less than 90 wt. %, less than 80 wt. %, less than 70 wt. %, or less than 60 wt. % of the weight of glass Raschig ring packing of an equivalent volume.

In some aspects, the filament, the yarn, and or the textile comprise immobilized antibiotic or metal nanoparticles or protease to inhibit biofilm formation and other fouling. In some aspects, the textile packing consists essentially of naturally derived materials. Non-limiting examples of naturally derived materials include cotton, jute, flax, hemp, ramie, viscose, lyocell, silk, wool, cellulose acetate, bamboo, poly(lactic acid), and poly(hydroxyalkanoate).

A top end and a bottom end of at least a portion of the hydrophilic fibers are fluidly connected. The path that the liquid takes moving from the top of the textile packing to the bottom of the textile packing is influenced by the orientation of the hydrophilic fibers. In some aspects, at least a portion of the hydrophilic fibers are fluidly connected in a path from a top of the textile packing to a bottom of the textile packing in a shape that is substantially linear, a zig-zag in the vertical direction, or vertical cork-screw. The zig-zag can be irregular as shown in Example 39. The zig-zag and/or cork-screw can also be intertwined in the three-dimensional space of the textile packing.

According to another exemplary embodiment of the invention, a textile packing comprises: a) hydrophilic fibers; b) an active enzyme; and c) a support structure. The active enzyme is attached to the hydrophilic fibers. The support structure holds the hydrophilic fibers. A top end and a bottom end of at least a portion of the hydrophilic fibers are fluidly connected.

It is to be understood that the various aspects of the textile packing of the previous embodiments, including aspects of the filament, yarn, and/or textile, composition of the hydrophilic fibers and hydrophobic fibers, the support structure, the textile packing shape, size, and relative weight, the use of spacers, additives, and fluid flow paths apply to the present embodiment as well.

In some aspects, the active enzyme is selected from the group consisting of an oxidoreductase, a transferase, a hydrolase, a lyase, an isomerase, and/or a ligase. In some aspects, the active enzyme comprises a carbonic anhydrase. In some aspects, the active enzyme is a carbonic anhydrase selected from the group consisting of alpha-type carbonic anhydrases, beta-type carbonic anhydrases, gamma-type carbonic anhydrases, and/or natural or artificial variants of these. In some aspects, the active enzyme is selected from the group consisting of dehydrogenase, lipase, catalase, carbohydrate oxidase, alcohol oxidase, laccase, peroxidase, nitrogenase, other oxidases, and/or RuBISCO.

How the active enzyme is attached to the hydrophilic fibers is not particularly limiting. Immobilization of enzymes is well known in the art, as described, for example, in Jose M. Guisan (ed.), Immobilization of Enzymes and Cells: Third Edition, Methods in Molecular Biology, 2013, vol. 1051, DOI 10.1007/978-1-62703-550-7_1, Springer Science+Business Media, New York, herein incorporated by reference. In some aspects, the active enzyme attachment is selected from the group consisting of entrapment in the hydrophilic fibers, entrapment in a polymeric coating on the hydrophilic fibers, entrapment in a chitosan material coating on the hydrophilic fibers, covalent bonding to the hydrophilic fibers, covalent bonding to the polymeric coating, and/or covalent bonding to the chitosan material coating. In some aspects, the active enzyme attachment is selected from the group consisting of entrapment in a chitosan material coating on the hydrophilic fibers and/or covalent bonding to a chitosan material coating on the hydrophilic fibers. In some aspects, the active enzyme attachment is by affinity between the active enzyme and the hydrophilic fibers and/or polymeric coating. In some aspects, the affinity between the active enzyme and the hydrophilic fibers and/or polymeric coating is enhanced by the presence of a ligand on the hydrophilic fibers, on the polymer coating, and/or on the active enzyme. In some aspects, the affinity between the active enzyme and the hydrophilic fibers is enhanced by the presence of adhesive peptides. In some aspects, the affinity is enhanced by the presence of a binding domain, for example, a peptide-based binding domain, on the polymer coating, and/or on the active enzyme. In some aspects, the peptide-based binding domain is a cellulose-binding domain.

In some aspects, the active enzyme attachment comprises covalent bonding and the hydrophilic fibers comprise the residue of a crosslinker. In some aspects the crosslinker is selected from the group consisting of dialdehyde, glutaraldehyde, compounds functionalized with glyoxyl groups, succinic acid or sebacic acid activated by 1-ethyl-3-(3-dimethylaminopropyl) carbodiimide hydrochloride and stabilized by N-hydroxysuccinimide, genipin, dimethyloldihydroxyethyleneurea (DMDHEU), 1,2,3,4-butanetetracarboxylic acid (BTCA), citric acid, maleic anhydride, trichlorotriazine, diisocyanate, formaldehyde, urea-formaldehyde, phenol-formaldehyde, epoxy, polyepoxide, silane, vinyl sulfone, other methylol-functional cross-linkers, hydroxyl-functional UV-curable vinyl acrylate crosslinkers, and/or other textile crosslinkers. In some aspects, the residue of a crosslinker is selected from compounds that perform click chemistry. In some aspects, the click chemistry is performed by reacting an azido-functionalized enzyme with a triple bond ethynyl group by cycloaddition, for example, as described on pp. 209-212 of the Guisan (2013) cited above. In some aspects, the click chemistry is performed as a thiol click reaction, in which a thiol group reacts with a carbon-carbon double bond by a radical (thiol-ene) or anionic chain (thiol Michael addition) reaction. In some aspects the thiol-ene reaction is photoinitiated, for example with UV-light. In some aspects, the residue of a crosslinker comprises a polyhydroxy and/or a polyamine compound, for example, ethylenediamine, polyethyleneimine (PEI), or branched polyethyleneimine.

In some aspects, the active enzyme attachment is selected from the group consisting of entrapment in a chitosan material coating on the hydrophilic fibers, and/or covalent bonding to the chitosan material coating and a mass ratio of the chitosan to the active enzyme (on a dry basis) ranges from 0.1 to 10,000. Other non-limiting examples of ranges of the mass ratio of the chitosan to the active enzyme (on a dry basis) are 0.5 to 1,000, or 0.5 to 500, or 0.5 to 100. In some aspects, a mass ratio of the chitosan to the active enzyme (on a dry basis) is greater than about 0.5, or greater than about 2, or greater than about 5, or greater than about 10, or greater than about 100.

In some aspects, a filament, a yarn and/or a textile comprises the hydrophilic fibers, and a weight ratio of the filament, the yarn and/or the textile to the active enzyme is from 1 g/g to 20,000 g/g on a dry basis. Other non-limiting examples of the weight ratio of the filament, the yarn, and/or the textile to the active enzyme are 5 g/g to 10,000 g/g, or from 50 g/g to 10,000 g/g, or 100 g/g to 10,000 g/g on a dry basis.

In some aspects, an initial enzyme activity of the textile packing is at least 20% of an equivalent amount of the free active enzyme (i.e., the active enzyme not attached to hydrophilic fibers) as measured by rate of p-Nitrophenol (pNP) production from p-Nitrophenyl Acetate (pNPAC). In some aspects, the initial enzyme activity is at least 30%, or at least 45%, or at least 60%, or at least 70% of an equivalent amount of the free active enzyme (i.e., the active enzyme not attached to hydrophilic fibers). In some aspects, the active enzyme is a carbonic anhydrase, and an initial enzyme activity is at least 20%, or at least 30%, or at least 45%, or at least 60%, or at least 70% of an equivalent amount of the free active enzyme (i.e., the active enzyme not attached to hydrophilic fibers), as measured by rate of p-Nitrophenol (pNP) production from p-Nitrophenyl Acetate (pNPAC).

In some aspects, a retained enzyme activity after 10 cycles of washing the textile packing in a Tris buffer (pH 7.2) and drying the textile packing is at least 20% of an initial enzyme activity. In some aspects, the retained enzyme activity after 10 cycles of washing the packing in a Tris buffer (pH 7.2) and drying the packing is at least 50% or at least 60% or at least 70% or at least 75% of an initial enzyme activity. In some aspects, a retained enzyme activity after 10 days incubated continuously in 30% MDEA (pH 10.5) at 45° C. in a dry bath orbital shaker set at 120 RPM is at least 20% of an initial enzyme activity. In some aspects, the retained enzyme activity after 10 days incubated continuously in 30% MDEA (pH 10.5) at 45° C. in a dry bath orbital shaker set at 120 RPM is at least 40% or at least 50% or at least 60% of an initial enzyme activity

According to another exemplary embodiment of the invention, a process for removing CO₂ from a gas is presented. The process comprises: a) feeding a first CO₂-rich gas to a first reactor, b) feeding a CO₂-lean absorption liquid near a top of the first reactor, c) reacting the CO₂ in the first gas with a component of the absorption liquid as the first gas and the absorption liquid flow through a first reaction zone to form a CO₂-lean gas and a CO₂-rich absorption liquid, d) removing the CO₂-lean gas from the first reactor; and e) removing the CO₂-rich absorption liquid near the bottom of the first reactor. The first reaction zone contains a gas-liquid contact enhancer, and the gas-liquid contact enhancer comprises at least one of a textile packing comprising: a) hydrophilic fibers, b) an optional active enzyme, and c) a support structure. The active enzyme is attached to the hydrophilic fibers. The support structure holds the hydrophilic fibers. A top end and a bottom end of at least a portion of the hydrophilic fibers are fluidly connected. In some aspects, the absorption liquid flows down through the first reaction zone and the gas flows up (counter-current), down (co-current), or substantially perpendicular to the flow of the absorption liquid through the first reaction zone.

It is to be understood that the various aspects of the textile packing of the previous embodiments including aspects of the filament, yarn, and/or textile, composition of the hydrophilic fibers and hydrophobic fibers, the support structure, the textile packing shape, size, and relative weight, the use of spacers, additives, fluid flow paths, enzymes, enzyme attachment methods, cross-linkers, weight ratio of chitosan to active enzyme, weight ratio of hydrophilic fibers to active enzyme, and enzyme activity apply to the present embodiment as well.

In some aspects, the first reaction zone comprises at least one section, and the gas-liquid contact enhancer for each of the sections is independently selected from the group consisting of the textile packing, structured packing, and/or random packing, wherein the structured packing and/or random packing consist essentially of metal, glass, ceramic, and/or plastic. In some aspects, the gas-liquid contact enhancer proximate to the top of the first reaction zone is the textile packing. In some aspects, a cross-sectional area of at least one of the sections is substantially filled with multiple ones of the textile packings, and wherein the textile packings are grouped in close contact and substantially fill the cross-sectional area of the at least one of the sections.

In some aspects, the component of the CO₂-lean absorption liquid comprises aqueous alkanolamines selected from the group consisting of monoethanolamine (MEA), diethanolamine (DEA), N-methyldiethanolamine (MDEA), 2-amino-2-hydroxymethyl-1,3-propanediol (Tris or AHPD), diglycolamine (DGA), 1-amino-2-propanol (A2P), 2-amino-2-methyl-1-propanol (AMP), methylmonoethanolamine (MMEA), dimethylmonoethanolamine (DMMEA), diethylmonoethanolamine (DEMEA), diisopropanol amine (DIPA), triisopropanolamine (TIPA), aqueous soluble salts (e.g., sodium or potassium salts) of N-methylaminopropionic acid or N,N-dimethylaminoacetic acid or N-methylalanine, N-methylglycine (sarcosine), N,N-diethylglycine, N,N-dimethylglycine (DMG), beta-alanine (3-aminopropanoic acid) or other natural or modified amino acids (e.g., N-substituted amino acid derivatives), 2-(2-aminoethylamino) ethanol (AEE), triethanolamine (TEA); aqueous soluble salts of glycine (e.g., sodium or potassium glycinate) and taurine; or the absorption liquid and the component are selected from the group consisting of aqueous solutions comprising NaOH, KOH, LiOH, alkali-metal carbonate salts (e.g., lithium, sodium, potassium, or ammonium), alkali-metal bicarbonate salts, alkali-metal phosphate salts, or borate salts; seawater or pH adjusted seawater; industrial process water comprising divalent cations or pH adjusted industrial process water comprising divalent cations; saline aquifer water or pH adjusted saline aquifer water; aqueous ammonium (NH₄OH); and/or aqueous electrolyte solutions and promoters. In some aspects, the absorption liquid and the component are selected from the group consisting of aqueous solutions comprising NaOH, KOH, LiOH, alkali-metal carbonate salts (e.g., lithium, sodium, potassium, or ammonium), alkali-metal bicarbonate salts, alkali-metal phosphate salts, or borate salts; seawater or pH adjusted seawater; industrial process water comprising divalent cations or pH adjusted industrial process water comprising divalent cations; saline aquifer water or pH adjusted saline aquifer water; aqueous ammonium (NH₄OH); and/or aqueous electrolyte solutions and promoters.

In some aspects, the component of the CO₂-lean absorption liquid comprises potassium carbonate in an amount ranging from 0.5 wt. % to 30 wt. %. Other non-limiting examples of the amount of potassium carbonate include 0.5 wt. % to 20 wt. %., 0.5 wt. % to 15 wt. %, 5 wt. % to 20 wt. %, and 5 wt. % to 15 wt. %. In some aspects, the component of the CO₂-lean absorption liquid comprises N-methyldiethanolamine (MDEA), in an amount less than 50% wt. %. Other non-limiting examples of the amount of MDEA include less than 30 wt. % or less than 15 wt. % or less than 10 wt. % or less than 7 wt. %. In some aspects, the component of the CO₂-lean absorption liquid comprises dimethylglycine (DMG), in an amount less than 30 wt. %. Other non-limiting examples of the amount of DMG include less than 15 wt. % or less than 10 wt. % or less than 7 wt. %. In some aspects, the absorption liquid comprises preservatives and/or antimicrobial agents (to prevent fouling of the packing). In some aspects, the absorption liquid comprises Proxel, penicillin, and/or nanosilver.

In some aspects, the CO₂-lean absorption liquid comprises an active enzyme, and wherein the active enzyme is selected from the group consisting of an oxidoreductase, a transferase, a hydrolase, a lyase, an isomerase, and a ligase.

The source of the first CO₂-rich gas is not particularly limited. In some aspects, the source of the first CO₂-rich gas is selected from the group consisting of natural gas, biogas, industrial process gas, combustion flue gas, contained environments (e.g., submarine, spacecraft), respiration gas, and ambient air (for direct air capture). The amount of CO₂ in the first CO₂-rich gas can vary depending upon the source of the first CO₂-rich gas. In some aspects, the first CO₂-rich gas comprises an amount of CO₂ ranging from 1 ppm to 10,000 ppm, or 0.1 vol % to 10 vol, or 1 vol % to 80 vol %. Other non-limiting examples of the amount of CO₂ in the first CO₂-rich gas include ranging from 10 ppm to 1,000 ppm, or 10 ppm to 10,000 ppm, or 1 vol % to 20 vol %, or 20 vol % to 60 vol %, or 1 vol % to 60 vol %.

The textile packings of the present invention can be used in various size reactors. In some aspects, a diameter of the first reactor ranges in size from 1 cm to 10 m. Other non-limiting examples of the diameter range of the first reactor include from 1 cm to 50 cm, or 1 cm to 100 cm, or 1 cm to 500 cm, or 1 cm to 1 m, or 1 cm to 3 m, 1 cm to 5 m, or 10 cm to 100 cm, or 10 cm to 500 cm, or 10 cm to 1 m, or 10 cm to 5 m, or 10 cm to 10 m, or 100 cm to 500 cm, or 100 cm to 1 m, or 100 cm to 3 m, or 100 cm to 5 m, or 100 cm to 10 m, or 500 cm to 1 m, or 500 cm to 1 m, or 500 cm to 3 m, or 500 cm to 5 m, or 500 cm to 10 m, or 1 m to 3 m, or 1 m to 5 m, or 1 m to 10 m.

In some aspects, a flow rate of the absorption liquid divided by a cross-sectional area of the first reactor ranges from 0.1 L/min.m² to 5,000 L/min.m². Other non-limiting examples of the flow rate of the absorption liquid divided by a cross-sectional area of the first reactor include from 1 L/min.m² to 1,000 L/min.m², or 1 L/min.m² to 500 L/min.m², or 1 L/min.m² to 100 L/min.m².

In some aspects, the flow rate of the first CO₂-rich gas divided by a cross-sectional area of the first reactor ranges from 60 L/min.m² to 2,000,000 L/min.m². Other non-limiting examples of the flow rate of the first CO₂-rich gas divided by a cross-sectional area of the first reactor include from 60 L/min.m² to 1,000,000 L/min.m², or 60 L/min.m² to 600,000 L/min.m², or 100 L/min.m² to 100,000 L/min.m², or 100 L/min.m² to 50,000 L/min.m², or 100 L/min.m² to 10,000 L/min.m².

In some aspects, the CO₂-rich absorption liquid is further treated to remove at least part of the CO₂ and produce a CO₂-lean absorption liquid that can be recycled back to the first reactor. In some aspects, the process further comprises the steps of f) feeding the CO₂-rich absorption liquid to a pond; g) releasing CO₂ from the CO₂-rich absorption liquid as the growth medium for a biological system (such as algae); and h) recovering the CO₂-lean absorption liquid from the pond. In some aspects, the first CO₂-rich gas comprises ambient air.

In some aspects, the process further comprises i) feeding the CO₂-rich absorption liquid near a top of a second reactor; j) releasing CO₂ to a second CO₂-rich gas by a reverse reaction of the component of the CO₂-rich absorption liquid as the second CO₂-rich gas and the CO₂-rich absorption liquid flow through a second reaction zone to form the second CO₂-rich gas and the CO₂-lean absorption liquid; k) removing the second CO₂-rich gas from the second reactor; and I) removing the CO₂-lean absorption liquid near the bottom of the second reactor. The second reactor comprises the second reaction zone, and the second reaction zone contains a second gas-liquid contact enhancer. In some aspects, the gas-liquid contact enhancer comprises at least one of the textile packing comprising: a) hydrophilic fibers, b) an optional active enzyme, and c) a support structure.

In some aspects, textile packing of the present invention allows for a fluid to flow from top to bottom within a subset of the hydrophilic fibers. This subset of the hydrophilic fibers serve as a conduit through which the liquid flows. The subset has a top end(s) and a bottom end(s) of the hydrophilic fibers that are fluidly connected. In another aspect of the present invention, the subset of hydrophilic fibers can be assembled to have a substantially horizontal or diagonal configuration that serves as a conduit through which the liquid flows and remains fluidly connected. Liquid may flow through the subset of hydrophilic fibers aided by the force of gravity, aided by the process of wicking, or aided by other means, such as the force of cocurrent gas flow and/or the centrifugal force of a rapidly rotating module comprising the subset of hydrophilic fibers. A system comprising a rapidly rotating module can be called a rotating packed bed reactor.

The water-absorbent textile-based contactors of the present invention function to promote contact between all three of the gas, liquid and solid phases, which may optionally comprise a catalyst, and serves to constrain and direct fluid flow through the textile in a manner that further promotes gas-liquid mass transfer and improves process operation by reducing or eliminating wall effects, channeling and flooding. In particular, the contactors and materials can be useful as packing materials for accelerating carbon dioxide (CO₂) absorption into CO₂ solvents in counter-current, co-current and perpendicular flow gas-liquid absorption columns and devices. The materials enhance gas absorption efficiency by creating a high gas-liquid contact area through controlled flow of liquid through the hydrophilic textile. Therefore, even absent biocatalyst, the textile-based contactor outperforms standard solid contactor materials, like raschig rings, by increasing CO₂ absorption, controlling liquid flow, decreasing the weight of the packing material, and allowing for self-supported modular designs.

Our invention uses moisture-absorbent textile materials (fibers, yarns, fabrics) as conduits that constrain, direct and control liquid flow while creating high surface area through the intimate interaction between the aqueous-based solvent and the hydrophilic textile. Instead of excluding the liquid from the solid packing and forcing it to flow at the surface, we have chosen moisture-absorbent textiles to both convey the liquid flow and simultaneously create high surface area by allowing the liquid to travel intimately through the textile material, creating a gas-liquid-solid contactor. The constrained flow behavior of liquid through the textile packing means that even if the packing tilts, leans, turns or shifts to some extent during the process of fluid flow, the flow of liquid through the packing will not be substantially disturbed. Therefore, in addition to use in stationary environments, the textile packing can be used as a gas-liquid contactor in mobile environments, e.g., on the deck of a ship or on the platform of a buoyant offshore gas rig, without experiencing disruption in uniform liquid flow, e.g., undesired channeling or splashing, that can happen with conventional solid contactors wherein the liquid is not constrained. Furthermore, because the flowing liquid is constrained within the textile packing and/or is constrained in narrow spaces or capillaries between adjacent fibers within yarns of the textile packing, it is protected from the force of a gas flowing through the packing. In other words, the force of a gas flowing through conventional solid packing, e.g., blown by a fan, can push liquid off the solid surfaces or cause liquid to pool or flow unevenly across solid packing surfaces, whereas this will not occur or will occur to a much lesser extent when liquid is constrained to flow through textile packing. The moisture-absorbent textile packing will protect the liquid from moving away from its intended flow path. The textile-based contactor can be constructed with fine, medium or thick fibers, yarns or fabrics, and by conventional or advanced textile manufacturing techniques, depending on the packing design and performance requirement. Individual fibers can have a widest cross-sectional dimension of about 1 μm or less for fine fibers, about 1 to 30 μm for medium fibers, and greater than about 30 μm for thick fibers. Some fabrics are made using continuous filaments, and many fabrics are made using yarns that comprise staple length fibers, typically about 2-5 cm long, that are twisted together to make the yarns. Friction between twisted fibers holds them together. High twist gives cohesive, strong and compact yarns whereas low twist results in yarns that are looser and bulky. A very lightweight fabric may have a dry weight of less than around 10 grams per square meter (g/m²), a lightweight fabric may weigh between around 10 to 150 g/m², a medium weight fabric may weigh between around 150 to 350 g/m² and a heavy weight fabric may weigh around 350 g/m² or more. The yarns in a fabric may be interlocked in a dense, medium or loose fabric construction. In a preferred embodiment, the fabric construction is sufficiently loose to allow air to pass through when the fabric is wet. In another preferred embodiment, the pressure drop is low when a gas or gas mixture passes through the dry or wet packing. The polymer composition of textile fibers, moisture absorbent behavior of textile fibers and other fiber properties and methods of characterization are well known in the art, as described, for example, in W. E. Morton and J. W. S. Hearle, “Physical Properties of Textile Fibres,” 4th Edition, Woodhead Publishing, Philadelphia, PA, 2001 herein incorporated by reference. The composition, microstructure, cross sectional shape, mechanical and physical properties of textile fibers are well known in the art, as described, for example in Steven B. Warner, “Fiber Science,” Prentice Hall, Inc., Englewood Cliffs, NJ, 1995 and Betty F. Smith and Ira Block, “Textiles in Perspective,” Prentice Hall, Inc., Englewood Cliffs, NJ 1982 herein incorporated by reference. Traditional textile fibers have moisture regain values on the low end for poly(ethylene terephthalate) (PET) (around 0.4%), acrylic and nylon (1-4%), in the mid-range of around 6-8% for cotton and cellulose acetate, and at the high end of around 10-18% for mercerized cotton, rayon, silk and wool. Most natural fibers, notably cotton and wool, have high moisture absorbance capability whereas commonly used synthetic fibers, like nylon and polyester, have relatively low moisture absorbance. Textiles are well known for use as particle filtration media, to remove particles from air or from liquids, e.g. water or oil, described, for example, in Chapter 5 Filtration Textiles in R. Senthil Kumar, “Textiles for Industrial Applications,” CRC Press, Taylor & Francis Group, LLC, Boca Raton, 2014, pp. 135-166 herein incorporated by reference. Therefore, textiles can be used in the methods of the present invention to remove potentially interfering particulates from gaseous and/or liquid streams prior to or in the processes of the present invention.

With biocatalyst present, the enhancement effect can increase by at least a factor of two times. The catalytic efficiency of enzymes immobilized in a reaction containing solid, liquid and gas phases is facilitated when gaseous substrate is contacted with liquid (e.g. aqueous liquid) flowing through a (e.g. hydrophilic) textile structure coated with enzymes, where the exaggerated interfaces between gas, liquid and solid, by virtue of the liquid flowing through the textile, allow fast reaction to occur in which the gaseous substrate (e.g. CO₂) is converted to a soluble ion (HCO₃⁻) product by an immobilized enzyme (e.g. carbonic anhydrase, EC 4.2.1.1), and the product can be transported by the liquid away from the enzyme active site leading to improved reaction mass transfer efficiency.

In one embodiment, a spiral, “jelly roll”, contactor design was found to efficiently direct liquid flow throughout the packing while preventing unproductive liquid channeling, wall effects and flooding, and was easier to fabricate and more efficient than other designs tested. The spiral design may optionally include spacers in one or more locations within the spiral wraps to provide structural support and/or provide gaps between material layers that improve gas and/or liquid flow. The gaps may be any size or shape or placed in any position or orientation that provides the necessary performance. Especially emphasized is the fact that the aqueous liquid absorbs into and intimately flows through the hydrophilic textile (e.g., comprising a cellulosic material, such as cotton), rather than just flowing across the surface as happens with conventional non-absorbent packing materials such as stainless steel and glass. Therefore, the good water-absorption property of the textile is a preferred feature that contributes to the novelty of this disclosure. The combination of textile-based contactor and biocatalyst enables use of benign aqueous CO₂ absorption solvents, such as potassium carbonate (K₂CO₃) based solvents that, absent catalyst, are too kinetically slow for use in conventional processes. In preferred embodiments, the contactors have high surface area to promote gas-liquid contact. For example, a textile-based contactor installed in a gas absorption column may have a surface area of 100 m²/m³ of packed column volume, or higher, such as at least 500 m²/m³, or at least 1,000 m²/m³, or at least 2,000 m²/m³, or at least 3,000 m²/m³ or higher.

The contactors and materials can optionally be made from sustainable materials that can be disposed or decomposed after use with low environmental impacts. The textile-based materials of the contactors can be structurally self-supporting or can be attached to, suspended from, or integrated with a non-textile-based and/or textile-based support material. The textile-based materials can be fabricated in many different ways, with different sizes and shapes and different types of interlacing and fiber-to-fiber contact or adhesion (e.g., twisting, braiding, weaving, knitting, felting, needle punching, sewing, knotting, tying and any of these in two or three dimensions). The fabrication of textile fibers into yarns, fabrics and other linear, two dimensional and three dimensional textile structures is well known in the art, by processes such as spinning, weaving, knitting, sewing, braiding, netting, matting, batting, needle punching, spinlacing, spunbonding, or stitch bonding, as described, for example, in Prabir Kumar Banerjee, “Principles of Fabric Formation,” Taylor & Francis Group, LLC, eBook, 2015 herein incorporated by reference, and in Chapter 2 Fiber, Yarn and Fabric Structures used in Industrial Textiles in R. Senthil Kumar, “Textiles for Industrial Applications,” CRC Press, Taylor & Francis Group, LLC, Boca Raton, 2014, pp. 11-38 herein incorporated by reference. Mechanical manipulation, such as pleating, smocking or interlacing, can be applied to create or enhance three-dimensional shapes in textile materials. Structural manipulation during manufacturing can impart three dimensional shapes to textile materials, as described, for example, in Jinlian Hu, “3-D Fibrous Assemblies: Properties, Applications and Modelling of Three-dimensional Textile Structures,” Woodhead Publishing Limited and CRC Press LLC, Boca Raton, 2008 herein incorporated by reference. Different types of textile structures can be combined or assembled to create a functional component or system. The contactors can be made from single materials or combinations of different materials, which may be hydrophilic or hydrophobic or have combined properties, provided that at least a functional portion of the materials is hydrophilic. Materials can include glues or adhesives or melting materials that can be thermally bonded. Preferred materials are those that withstand exposure to the gases and liquids of the application without undesirable chemical or physical changes. Textile chemical, coating and finishing technologies can be used to enhance performance, described, for example, in Chapter 4 Finishing of Industrial Textiles in R. Senthil Kumar, “Textiles for Industrial Applications,” CRC Press, Taylor & Francis Group, LLC, Boca Raton, 2014, pp. 101-133 herein incorporated by reference. For example, antimicrobial agents can be incorporated to prevent fouling and preserve packing material function. Crosslinking agents can be incorporated to physically stabilize the packing materials. Colorants can be applied to identify or distinguish packing materials or packing material components or alter the packing material aesthetics. Chemical treatments, plasma treatments, and/or coatings can be applied to alter the packing hydrophilicity or hydrophobicity.

An additional device, such as a detector, a conductor, a reinforcing material, a heating element, or a cooling element, can be embedded in the contactor structure or within or combined with the textile itself, such as a threadlike heating element or a conductive fiber or yarn spun or woven together with the hydrophilic textile fibers. The additional device, can be metallic or non-metallic or a combination with or without coatings or other treatments applied. In some aspects, the device is a conductor. In some aspects, the conductor is selected from the group consisting of metal, carbon, carbon nanotube, graphite, graphene, polyalanine (PANI), poly(phenylenediamine), polyvinylpyrrolidone (PVP), or chitaline. In some aspects, the device is a reinforcing material. In some aspects, the reinforcing material is an adhesive or a glue. In some aspects, the reinforcing material is lignin. In some aspects the reinforcing material is carbon black, activated carbon, silica, or fumed silica. In some aspects, the reinforcing material is a nanomaterial, including a nanocrystal, a nanofiber, a nanosheet, or a nanoparticle. In some aspects, the nanomaterial is a nanometal, a carbon nanotube, or a nanocellulose. In some aspects, the nanosheet is graphene or graphene oxide. The contactors can be stationary or can be mobile (e.g., bend, lean, turn or pivot, move as conveyors, or have responsive actuator-type properties). The contactors can be fabricated in such a way that makes them easy to install in different sizes and shapes of contactor housing, such as columns. For example, the flexible, bendable, compressible property of textile-based materials allows them to be made in a compact shape that is expanded to a larger shape or made in a larger shape that is contracted into a smaller shape.

The following is a partial listing of key benefits of the present invention. Increased process efficiency leading to smaller, lighter weight, easily handled modular packing and contactor designs with lower costs. Possibility to make new packing and contactor designs that can take advantage of the structural, wicking, fluid confinement and fluid transport properties of textiles. New packing designs that provide high surface area for gas-liquid contact. Safer packing designs that have no sharp edges, as may commonly be encountered with conventional metal packing, and have no risk of crushing to sharp hazardous fragments, which may occur with glass packing. Use of less aggressive, more sustainable solvents. Improved and simplified control of liquid distribution throughout the contactor, including improved inlet liquid distribution and reduced or eliminated wall effects, channeling and flooding compared to that encountered with conventional packing materials. Potential to use packing materials with sustainable end-of-life disposal options.

Equipment, process conditions, and chemical solvent approaches for conventional CO₂ gas separation are described, for example, in A. Kohl and R. Nielsen, “Gas Purification,” 5th ed., Gulf Professional Publishing, Houston, TX, 1977 herein incorporated by reference. Properties and process design considerations for using conventional amine-based CO₂ absorption solvents, including drawbacks to conventional methods, are described, for example, in Helei Liu, Raphael Idem, Paitoon Tontiwachwuthikul, “Post-combustion CO₂ Capture Technology by Using the Amine Based Solvents,” Springer Nature Switzerland AG, 2019 herein incorporated by reference. Carbonic anhydrase enzymes known in the art of CO₂ gas absorption are described, for example, in S. Salmon and A. House, “Enzyme-catalyzed solvents for CO₂ separation,” in Novel Materials for Carbon Dioxide Mitigation Technology, F. Shi and B. Morreale, Eds., Amsterdam, Elsevier B. V., 2015, pp. 23-86 herein incorporated by reference. Also, WO 2018/017792 A1 and US 2020/0276057 A1 are incorporated herein by reference in their entirety.

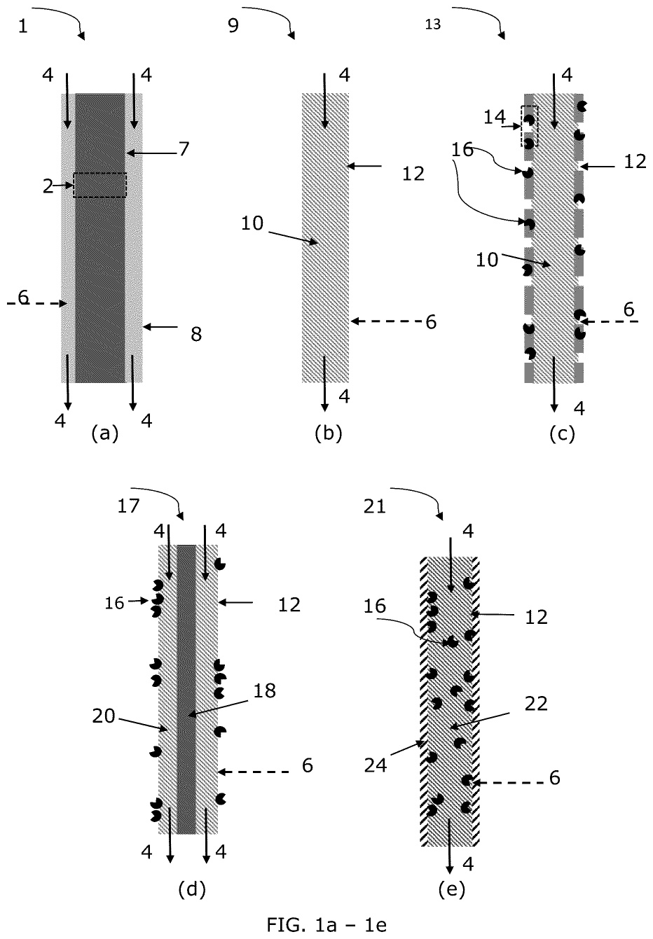

FIG. 1a is a schematic illustrating the gas-liquid contact mechanism 1 for traditional wettable surface solid packing 2. Liquid 4 flows down the outside surface 7 of solid packing 2 because the solid packing does not absorb liquid 4. Likewise, the CO₂ gas 6 only contacts the surface 8 of liquid 4 that surrounds the packing 2. The liquid 4 is lean in bicarbonate when it first contacts the packing 2, and liquid 4 is rich in bicarbonate when it has passed packing 2. FIGS. 1b-1e are non-limiting embodiments of the present invention of textile packings made from yarns comprising hydrophilic fibers and a support (not shown) which holds the yarns in a substantially vertical position. In each of FIGS. 1b-1e, the liquid 4 is lean in bicarbonate when it first contacts the packing 10, and liquid 4 is rich in bicarbonate when it exits the hydrophilic yarn packing 10. FIG. 1b is a schematic illustrating the gas-liquid contact mechanism 9. The hydrophilic yarn packing 10 itself functions to transport the liquid 4 inside and through the hydrophilic yarn packing 10, resulting in a semi-solid packing 10 that is saturated with liquid 4, which also results in a wetted packing surface 12 that contacts CO₂ gas 6. FIG. 1c is a schematic illustrating the gas-liquid contact mechanism 13. The hydrophilic yarn packing 10 itself functions to transport the liquid 4 inside and through the hydrophilic yarn packing 10, resulting in a semi-solid packing 10 that is saturated with liquid 4, which also results in a wetted packing surface 12. Application of a semi-permeable coating 14 to the surface of the hydrophilic textile packing 10 can both help constrain the liquid 4 to travel within the textile packing 12, and can hold compounds (e.g., enzyme catalysts) near the surface of the packing 12. Semi-permeable coating 14 comprises enzymes 16. When the hydrophilic yarn packing 10 is wetted, the coating 14 is also wetted, allowing CO₂ gas 6 to react with H₂O at the active site of enzymes 16 immobilized by the coating 14 at the gas-liquid-solid interface 12. FIG. 1d is a schematic illustrating the gas-liquid contact mechanism 17. The packing comprises a hydrophobic yarn core 18 surrounded by a hydrophilic yarn shell 20. Hydrophilic yarn shell 20 itself functions to transport the liquid 4 inside and through the hydrophilic yarn shell 20, which results in a wetted packing surface 12. Enzymes 16 are shown attached at the surface of hydrophilic yarn shell 20 where they can interact with CO₂ gas 6 to catalyze the CO₂ absorption reaction. FIG. 1e is a schematic illustrating the gas-liquid contact mechanism 21. The packing comprises a hydrophilic yarn core 22 surrounded by a hydrophobic yarn shell 24. Hydrophilic yarn core 22 itself functions to transport the liquid 4 inside and through the hydrophilic yarn core 22. A wetted packing surface 12 occurs in permeable locations of hydrophobic yarn shell 24. Enzymes 16 are shown attached throughout the structure, including at the surface, of hydrophilic yarn core 22. The permeable hydrophobic yarn shell 24 illustrated in FIG. 1e could alternatively be a permeable hydrophobic coating (not shown).

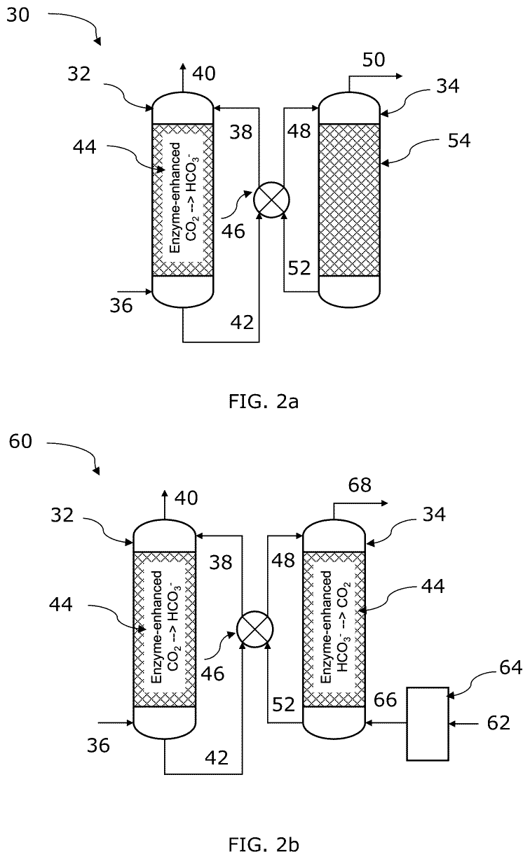

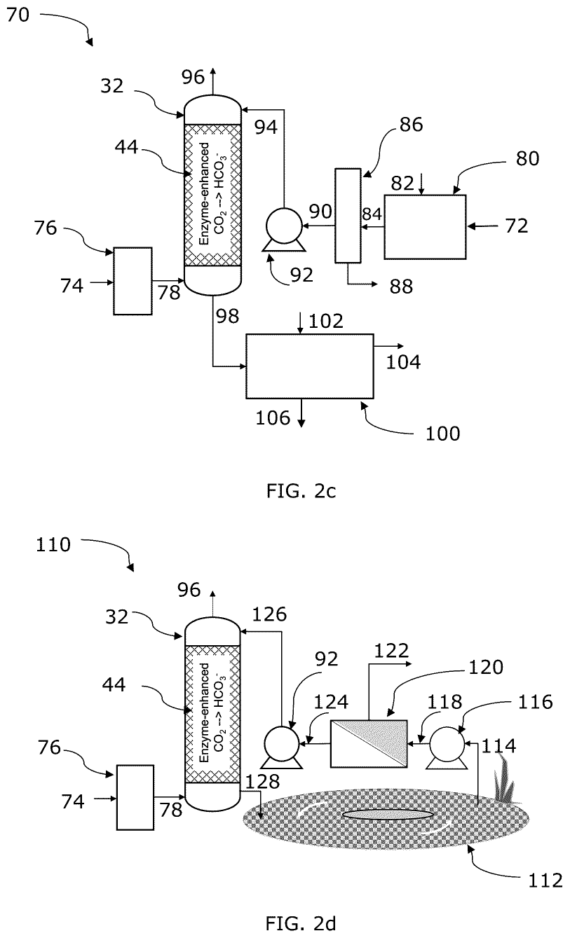

FIG. 2a shows a schematic illustrating a non-limiting embodiment of the present invention using a counter-current recirculating solvent-based gas-liquid CO₂ absorption/desorption process 30 with absorber 32 and desorber 34. A gas mixture comprising CO₂ 36 is fed to the bottom of the absorber 32 while cool CO₂-lean absorption liquid 38 is fed near the top of the absorber 32. As CO₂ is absorbed into the liquid by chemo-physical reactions, the liquid becomes “loaded” with CO₂ and is called “rich” liquid. Scrubbed gas 40, which is depleted in CO₂ relative to gas mixture 36, exits the top of absorber 32 and cool CO₂-rich solvent 42 exits the bottom of the absorber 32. A textile-based packing comprising immobilized CA 44 is installed in the absorber 32 to increase the CO₂ absorption into the solvent. The driving force for absorbing CO₂ in the absorber 32 is the increased solubility of bicarbonate, which is the reaction product of CO₂ and the component in the liquid, catalyzed by CA. The driving force for releasing CO₂ in the desorber 34 is typically heat or decreased pressure (e.g., vacuum) or combination of driving forces. In this schematic, the absorber 32 operates at a lower temperature (e.g., 30-50° C.) than the desorber 34 (e.g., >100° C.). The cool CO₂-rich solvent 42 exits the absorber 32 and passes through heat exchanger 46 and warm CO₂-rich solvent 48 exits heat exchanger 46 and enters near the top of the desorber 34. Using temperature differences as the driving force to cause bicarbonate to decompose and release CO₂, CO₂ gas 50 exits the top of desorber 34 to subsequent drying, compression, and storage, release, or use (not shown) and warm CO₂-lean solvent 52 exits near the bottom of the desorber 34 and flows through heat exchanger 46 with cool CO₂-lean solvent 38 exiting heat exchanger 46 before re-entering near the top of the absorber 32. A conventional packing or textile packing, optionally with enzymes 54, is installed in desorber 34 to increase CO₂ desorption from the solvent.

Packing materials 44 or 54 are placed inside the absorber 32 and desorber 34 to enhance gas-liquid contact and improve process efficiency. Conventional packed column type gas-liquid separation contactors utilize metal, glass, ceramic or plastic trays, perforated plates, random packing or structured packing to promote gas-liquid contact. Packing surfaces are designed to cause liquid, flowing by the force of gravity down through the packing, to spread across the packing surfaces. Ideally, this creates a uniform thin liquid film over all the packing surfaces. Gas flowing upwards through the packing comes in contact with the liquid film. At the gas-liquid contact interface, certain gas components (e.g., CO₂) can diffuse into or react with components in the liquid, causing those gas components to become absorbed, or “captured” by the liquid. Gas flow through the packing 44 or 54 occurs because of its low density or because it is forced to flow through by pressure differences across the packing 44 or 54, such as induced by a fan or vacuum (not shown). CO₂ can be removed from mixed gases of different types for various purposes. Usual applications are natural gas (i.e., methane) upgrading, biogas upgrading and CO₂ removal from industrial process gases and combustion flue gas. Other applications are CO₂ removal from contained environments (e.g., submarines, spacecraft) and CO₂ removal from air, called direct air capture.

The presence of enzymes, whether attached to packing 44 or dissolved in the solvent (not shown), dramatically increases the CO₂ absorption efficiency compared to non-catalyzed packings, and the benefit of the immobilized enzyme packing 44 is that the enzyme will remain in the absorber 32 and not risk inactivation by travelling outside of the absorber (such as to a hot desorber 34), as would be the case for dissolved enzyme (not shown). Therefore, immobilized enzyme packing 44 will have higher longevity compared to dissolved enzyme, which can reduce process cost.

FIG. 2b shows a schematic of a non-limiting embodiment of the present invention using a gas-liquid CO₂ absorption/desorption process 60 with absorber 32 and desorber 34. The absorber 32 operation and the solvent recirculation are as described for FIG. 2a, except that the absorber 32 typically operates at a lower temperature (e.g., 5-50° C.). In this embodiment, air 62 optionally enters a blower with a filter 64 and exiting air 66 enters near the bottom of desorber 34. The gas stream 68 exiting desorber 34 comprises the air 66 and any desorbed CO₂ and is vented to the atmosphere. A textile-based packing comprising immobilized CA 44 is installed in the desorber 34 to increase the CO₂ desorption from the solvent, and the desorber 34 typically operates at a lower temperature (e.g., >40° C.) than in FIG. 2a.

FIG. 2c shows a schematic of another non-limiting embodiment of the present invention, a process for recovering CO₂ 70 using an absorber 32 and industrial process water 72 as the absorption solvent. Air 74 enters a blower 76 with an optional filter (not shown) and exiting air 78 enters near the bottom of absorber 32. Industrial process water 72 enters tank 80 where a pH adjustment component 82 optionally can be added. Industrial process water 84 exits the tank 80 and enters a separation device 86 where any solids 88 are removed. Solid-free industrial process water 90 exits separation device 86 and enters pump 92. Industrial process water 94 exits the pump 92 and enters near the top of absorber 32. A textile-based packing comprising immobilized CA 44 is installed in the absorber 32 to increase the CO₂ absorption into the solvent. Scrubbed air 96, depleted in CO₂ relative to inlet air 78, exits the top of the absorber 32 and HCO₃″ rich process water 98 exits the bottom of absorber 32. The absorber 32 is typically operated at ambient conditions (e.g., about 25° C.). HCO₃″ rich process water 98 enters a solids separation device or settling tank 100 where a pH adjustment component 102 optionally can be added. Exiting the solids separation device or settling tank 100 is treated process water 104 and solids 106 containing the captured carbon dioxide. Process 70 as can be combined with mine tailing effluent treatment or with desalination processes. Integrating the CO₂ absorber with industrial process water treatment can both remove CO₂ from air and sequester it as carbonate-based salts of cationic metal ions or polycationic compounds present in the process water.

FIG. 2d shows a schematic of another non-limiting embodiment of the present invention, an integrated biological system process for recovering CO₂ 110 using an absorber 32 and an algae pond 112. Operating the CO₂ absorber 32 adjacent to an algae pond 112 replaces an energy-expensive conventional desorber (not shown) with a biological system that utilizes CO₂ and related compounds for photosynthesis. This embodiment provides a route to direct capture of CO₂ from air and utilization of the CO₂ to make food, feed, fuels and other beneficial compounds. Air 74 enters a blower with an optional filter 76 and exiting air 78 enters near the bottom of absorber 32. Pond material 114, comprising both algae and HCO₃″ lean pond water, enters pump 116, with an optional prefilter or screen (not shown), and the outlet 118 of pump 116 is fed to separation tank 120. Separated algae 122 exits tank 120 and can go to downstream processing (not shown). HCO₃″ lean pond water 124 exits the separations tank 120 and enters pump 92 which transports HCO₃ lean pond water 126 to near the top of absorber 32. A textile-based packing comprising immobilized CA 44 is installed in the absorber 32 to increase the CO₂ absorption into the pond water. Scrubbed air 96, depleted in CO₂ relative to inlet air 78, exits the top of the absorber 32 and HCO₃ rich pond water 128 exits the bottom of absorber 32. The absorber 32 is typically operated at ambient conditions (e.g., about 25° C.). HCO₃ rich pond water 128 enters the algae pond 112 where it can be a growth medium for algae, resulting in the HCO₃″ lean pond water 126 that can be delivered back to the top of the absorber 32 to repeat the process. HCO₃″ lean pond water 126 typically has a pH of greater than approximately 10 and HCO₃-rich pond water 128 typically has a pH of less than approximately 10.

### EXAMPLES

### Example 1. Chitosan Solution Preparation

Chitosan (degree of deacetylation=95% and viscosity of 21 cP at 1% chitosan concentration) was first dissolved in 5% acetic acid water solution at a concentration of 5% and the dissolved solution was poured into a casting plate for air-drying over a two-day period. After the solvent had evaporated, a protonated chitosan film was obtained and was redissolved immediately (excess air drying will render the film harder to redissolve) in deionized water at a concentration of 1%. The chitosan solution thus prepared was used to coat no-enzyme textile controls. For enzyme immobilization, stock concentrated carbonic anhydrase solution can be added slowly into the chitosan solution at varying concentrations with continuous stirring. A typical carbonic anhydrase solution to chitosan film ratio of 1:1 (mL: g) in the solution was used in most examples described here unless noted otherwise.

### Example 2. Coating Hydrophilic Textile Substrate Materials Using Chitosan Solution

Hydrophilic textile substrate materials, such as various cellulosic fabrics and yarns, can be coated using the solution prepared in Example 1 through a dip-coating method or a solution padding process that is capable of higher throughput. Dip-coating was achieved by first immersing and completely wetting the selected textile materials in a solution bath with the help of mild mechanical agitation and the inherent hydrophilicity of the textile fibers. Excess solution was then squeezed out manually or using a mechanical press apparatus to the desired % wet pickup. In the solution padding process, the selected textile materials were wetted and squeezed simultaneously between a pair of rollers pushed tightly against each other forming a solution reservoir for wetting and squeezing out excess solution as the textile materials exit the padder. The % wet pickup can be controlled through adjustment of the roller pressure. A typical drying process for the wet coated textile materials involves air drying at room temperature on a drying rack for two days and was used for all other examples except for those where a different drying method was specifically mentioned.

### Example 3. Coating Pre-Formed Textile Packings

Textile packings can be fabricated using either the coated materials prepared in Example 2 or using the uncoated raw materials and then coating the preformed packings in their final forms (Example 6, 7, or 8) using the solution prepared in Example 1. Coating of the preformed textile packings can be performed in_a column-shaped container, such as a suitably sized graduated cylinder or a trough or a groove, that permits the complete immersion of the packing in the solution. Typically, the packings were dipped and drained repeatedly for 3 times over a total of 15 minutes of immersion time to allow for complete wetting and coating of all available surfaces. The wet coated textile packings were hung and air-dried at room temperature for a period of two days unless otherwise noted.

### Example 4. Freeze drying of chitosan coatings

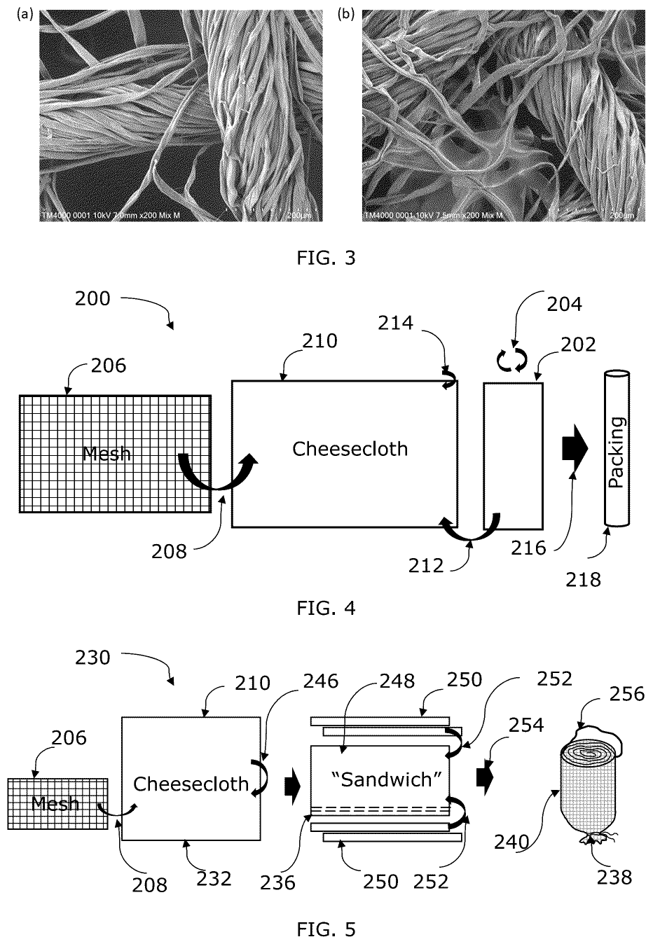

In addition to air drying, wet coated textile fabrics or packings can be freeze-dried for lowering the moisture content and generating finer structures. In FIG. 3a, the very thin coating on the single fibers of air-dried samples conformed to the shape of the fibers, whereas in FIG. 3b, some of the coating in freeze dried samples appeared as thin membranes occupying interstitial space between fibers. Cooling rates, potentially affecting the finer structures, can be varied using different cooling mediums such as isopropanol/dry ice mixture, liquid nitrogen, or most conveniently cold air in the laboratory freezer. Large-scale freeze dryers that would accommodate different sizes and shapes of packing materials are readily accessible in industry and university_laboratories making the process easy to scale up. In the examples described here, cold air freezing was used in a laboratory freezer with constant temperature of −30° C. before drying in a freeze dryer for 24 hours with a collector temperature of −50° C. and a vacuum pressure of 5 Pa.

### Example 5. Incorporating cellulose nanofibers in packing

Electrospun nanofibers are well-known for their large surface areas, but usually lack the necessary mechanical strength needed for fabricating packing materials. This was overcome by electrospinning a nanofiber mat directly onto a physical support such as the thin nylon mesh that was also used as spacer in the textile packing design. The nylon mesh/nanofiber composite is much easier to handle than the nanofiber itself. It can be made into packings using regular techniques and is able to withstand other wet chemistry methods and coating processes. In this example, a cellulose acetate nanofiber mat was electrospun from 16% cellulose acetate in 90% acetic acid and directly deposited on the nylon mesh using the following parameters: 15 kV, 15 cm tip-to-collector distance, G18 blunt needle, and 1 mL/hr. The nylon mesh/cellulose acetate nanofiber mat combination was fabricated into a 2 cm×10 cm packing using the methods described in Example 6. The preformed packing was subsequently deacetylated in 0.05N NaOH for 1 day and rinsed with water until neutral. The regenerated cellulose (deacetylated cellulose acetate) nanofiber packing was then air dried and coated using the solution prepared in Example 1 and coating method described in Example 3. The prepared packing was tested in the laboratory gas scrubber according to Example 9 (a).

### Example 6. Small Spiral Packing

A small “jelly roll” spiral packing design (designated “H”) was used to make 2 cm diameter textile-based contactors for use in a 2 cm inside diameter glass column. The fabrication procedure 200 comprised the following steps, as summarized in FIG. 4. Step 1: A “center tube” 202 of cotton cheesecloth 210, alternatively written “cheese cloth” (Grade 90, Testfabrics Inc., West Pittson, NJ) was made by rolling 204 a 6 cm wide by 17 cm tall piece of cheesecloth 210 into a 1 cm diameter tube 202 and securing it with loose stitches (not shown) placed at 90 degrees through the center of the tube 202 along its length. Step 2: A 20 cm wide by 15 cm tall piece of nylon netting 206 (with approx. ⅛″ mesh) was centered on 208 a 25 cm wide by 17 cm tall piece of cheesecloth 210, and one 17 cm edge was folded over the corresponding nylon edge and sewn into place (not shown). Step 3: The “center tube” 202 from Step 1 was placed on the folded fabric in Step 2 212, and the nylon-cheesecloth sandwich was rolled 214 one complete turn around the “center tube” 202. Stitches (not shown) were placed through the center of the tube along its length to secure it in place. Step 4: Rolling 214 around the center tube 202 continued to form 216 a final roll 218 with a 2 cm diameter which was secured by sewing. In one embodiment, after fabrication, the packing 218 was dip-coated in chitosan solution, with or without enzyme. In another embodiment, the cheesecloth 210 was dip-coated or padded with a chitosan solution, with or without enzyme, prior to fabricating the packing.

### Example 7. Large Spiral Packing

A “jelly roll” spiral packing design (designated “L”) was used to make approximately 2.25-inch diameter textile-based contactors for use in a 2.25 inch inside diameter glass column. The fabrication procedure comprised the following steps 230, which are summarized in FIG. 5. Step 1: The long edges 232 of 99 cm wide by 53.5 cm tall piece of cotton cheesecloth 210 (Grade 90, Testfabrics Inc., West Pittson, NJ) were overlock stitched (not shown) and two rows of machine basting stitches 236 were sewn along one long edge, to gather the fabric 210 into a cone 238 at the bottom of the jelly-roll packing 240 as the last step in assembly. Step 2: A 93 cm wide by 22.5 cm tall piece of 50/50 polyester/cotton latch hook canvas 206 (5 Mesh, Dimensions IG Design Group Americas Inc., Atlanta, GA) was placed 208 on one half of the cheesecloth 210 at the approximate center. The other half of the cheesecloth was folded 246 over the top of the canvas 206 and was sewn into place at the top middle and bottom (not shown) to make a cheesecloth and canvas sandwich 248. Step 3: A stack 250 of two 93 cm wide by 3 cm tall canvas spacers was placed 252 at each of the top and bottom long edges of the sandwich 248 from Step 2. Each stack 250 was sewn in place 252 with a double row of stitching (not shown). Step 4: The loose edge (not shown) of cheesecloth 210 on one 22.5 cm end was folded over in a tight bunch and the canvas cheesecloth sandwich 248 was rolled 254 into a spiral “jelly roll” packing 240 with the spacer rectangles facing the inside and making a rigid supporting rim at the top and bottom of the assembly 240 while producing vertical gaps between spiral layers. The rolled packing 240 was test-fitted in a 2.25″ diameter glass column (not shown), adjusted to fit securely, and then sewn at the edges (not shown) to hold the packing assembly 240 securely together. Step 5: A heavy thread loop 256 was sewn to the top of the packing 240 for ease of hanging and handling the packing 240. The assembled contactor 240 was optionally dip-coated in chitosan solution (control) or in chitosan solution comprising enzyme (enzyme), as described in Example 3, and air dried at least overnight before testing. The completed assembly 240 rested firmly against the lower packing support lip of the column (not shown), ensuring that gas would pass upwards through the packing.

Considering the average diameter of the cheesecloth 90 yarns to be 220 μm and the combined total length of all cheesecloth yarns in one “L” packing to be 1.56 km, and by considering the yarn to be a single long cylinder, the yarn surface area can be approximated as about 1.1 m². This is a simplification and an underestimate of the actual dry surface area, because the individual surface areas of each fiber within the yarn are not considered. Considering the average diameter of the latch hook canvas yarns to be 1 mm and the combined total length of all latch hook canvas yarns in one “L” packing to be 0.127 km, and by considering the yarn to be a single long cylinder, the yarn surface area can be approximated as about 0.4 m². Again, this is a simplification and an underestimate of the actual dry surface area. When adding these estimated surface areas and dividing by the empty glass column volume that corresponds to a 23 cm packing height, namely 650 cm³, an approximated textile surface area per column volume of 2300 m²/m³ is obtained. This is a much higher surface area than the 583 m²/m³ of column volume calculated for 8 mm diameter×8 mm long×1 mm wall thickness glass Raschig rings, indicating that gas molecules have more opportunity to interact with the textile packing surfaces than with the surfaces of glass Raschig rings. The water absorbent properties of the cheesecloth and canvas mesh base packing materials were measured in a liquid hold-up test in which a weighed rectangular piece of each material was submerged in deionized water at 21° C. for 15 minutes to wet the material, and was then held vertically in air by one edge for five minutes to allow water to drain from the material, after which any obvious water drops at the lower edge were quickly shaken from the materials and the drained wet mass was measured. The percent liquid hold-up was calculated as 100×(drained wet mass-initial mass)/(initial mass). The latch hook canvas mesh had a liquid hold-up of 37% and the cheesecloth had a liquid hold-up of 300%, illustrating the water absorbent properties of these materials.

### Example 8. Large Cone Packing

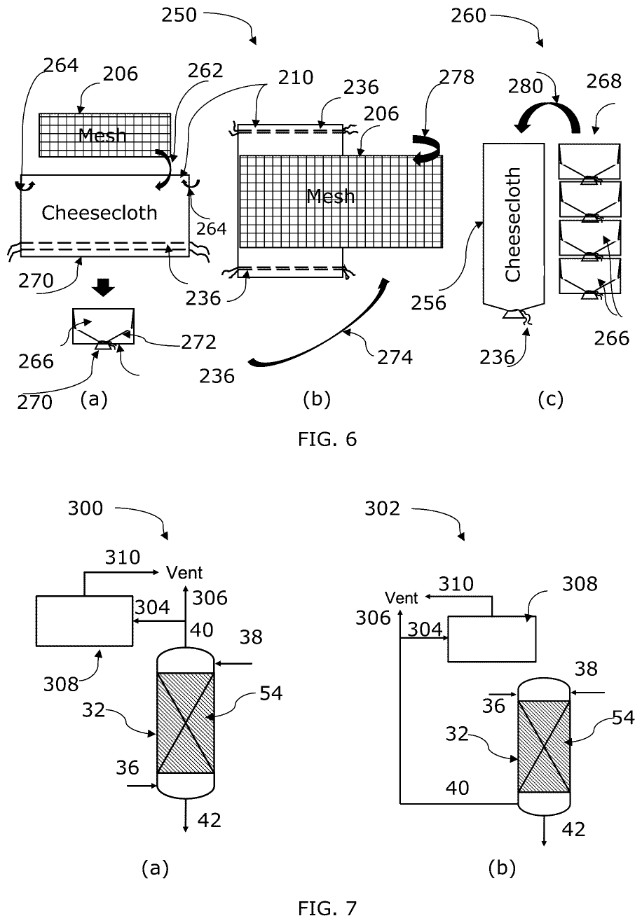

FIG. 6 is a schematic of the fabrication for the “K” textile packing. The fabrication procedures 250 and 260 for making the small cones 266, and for wrapping a stack 268 of the small cones 266 are illustrated in FIG. 6a and FIG. 6b/c, respectively. As shown in FIG. 6a, a 10 cm×21 cm piece of cotton cheesecloth 210 (Grade 90, Testfabrics Inc., West Pittson, NJ) was sewn to 262 and folded over 264 rectangles of 5 cm×17 cm 50/50 polyester/cotton latch hook canvas 206 (5 Mesh, Dimensions IG Design Group Americas Inc., Atlanta, GA) to make short 5 cm tall cones 266 with a rigid canvas rim (not shown) to hold the cone 266 open at the top and allow for stacked assembly 268. The latch hook canvas 206 is a semi-rigid mesh rug backing material (210 g/m²) that provides a permeable supporting structure for the cheesecloth 210. The stiff sized mesh yarns have a linear density of 531 g/km. Cheesecloth 210 was overlock stitched (not shown) and two rows of machine basting stitches 236 were sewn along one long edge, to gather the fabric 210 into a cone 266 by pulling long machine stitches 236 to the desired tightness, and then pushing the gathered edge 270 through the intentional hole remaining at the center (not shown) to form a downward facing cone 266 that facilitated liquid flow and created an angled cheesecloth surface 272 for gas to pass through. An outer support of latch hook canvas 206 (23 cm tall and 38 cm wide) was placed on cheesecloth 210. The cheesecloth 210 included a 34 cm tall by 24 cm tall section with the sections above and below the mesh 206 shown and a 23 cm tall and 12 cm wide section (not shown) behind the mesh that extends beyond the cheesecloth 210 section that is shown. The stack of cones 268 were placed vertically on and sewn into 274 starting at the side of the latch hook canvas mesh 206 lying on top cheesecloth 210 (not shown) and distal to the 34 cm tall by 24 cm wide section of cheesecloth 210. The mesh 206 and cheesecloth 210 (not shown) were rolled 278 around the stack of cones 268, and the 34 cm tall by 24 cm wide section of cheesecloth 210 was included in the roll-up to produce the outer support tube 256. FIG. 6c. illustrates the completed assembly 260 as the stack of cones 268, inserted 280 into the outer support tube 256. The completed assembly 260 had a diameter that fit snugly inside a 2.25″ diameter glass column. The completed assembly 260 (designated “K”) rested firmly against the lower packing support lip of the column, ensuring that gas would pass upwards through the packing.

### Example 9. Scrubber Set-Up and Operation

FIG. 7 is a schematic of how the laboratory gas scrubber was operated alternatively in counter-current mode 300 (FIG. 7a) or co-current mode 302 (FIG. 7b). In counter-current mode 300, the laboratory gas scrubber 32 was operated in single-pass flow through absorption mode, meaning that lean fresh solvent 38 was delivered to the top of the column 32, flowed downward through the packing 54, or alternatively with enzyme immobilized packing 44 (not shown), installed in the column 32, and came in contact with the pre-humidified defined gas mixture 36 that entered at the bottom of the column 32 and flowed upwards through the packing 54. The volume % composition of the gas mixture delivered to the bottom of the column 36 was defined by setting the flow rate of two mass flow controllers (not shown), one for CO₂ and one for N₂, that were located upstream of a gas mixing chamber (not shown). The premixed gas then passed through a controlled temperature gas humidifier (not shown) before entering the absorber column 32. The absorber 32 was fitted with one or more glass columns of different sizes, depending on the experiment. The “small” column had a contact zone size of 2 cm I.D. and 10 cm long, while the “large” column had a size of 2.25″ I.D. and 12″ long. The “small” and “large” columns were used for testing small packings prepared according to Example 6, and large packings prepared according to Examples 7 and 8. After exiting the top of the column 32, the gas stream 40 was split into two streams, 304 and 306. Stream 304 was analyzed by a CO₂ gas analyzer 308 and then vented as stream 310 and stream 306 was also vented. For co-current mode 302, the only difference as shown in FIG. 7b is that the gas mixture 36 entered near the top of the absorber 32 and gas stream 40 exited near the bottom.

Two gas analysis options were used in the examples described here.
Option (a): A simple IR-based CO₂ gas detector which reported relative values for CO₂ level in the gas stream was used for the purpose of comparing and contrasting the differences in CO₂ detector response of control and enzyme packings of the same design. This is a lower-cost and easy-to-setup option which can function with a humidified gas stream. The entire humid gas stream enters into a chamber fitted with the detector head and leaves on the opposite end and out into a chemical fume hood duct.
Option (b): A more accurate gas analyzer was equipped with an active sample pump that draws a portion of the wet exit gas through a gas drying column before entering the gas analyzer IR detector. The remaining portion of the wet gas stream was vented into a chemical fume hood duct. The gas analyzer can be calibrated with a calibration CO₂ gas mixture and measures and reports the CO₂ amount in volume percentage.

### Example 10. Amine Functionalization of Fiber Surfaces

Chitosan coating on fiber surfaces, such as those described in Examples 2 and 3, is not only able to serve as a matrix for entrapment immobilization of enzymes, but also able to confer amine functionalities to the textile surfaces it has coated. Subsequently, the amine groups on the textile surfaces are able to react with crosslinking agents, such as those described in Example 11, to which enzymes can be covalently attached. The advantages of using chitosan coating as amine functionalized surface material include its biodegradability, self-fiber or film-forming ability, excellent coating ability with natural cellulosic fibrous materials, and its abundance as a natural derivative which contribute to its relatively low cost. Amine functionalization of textiles surfaces can also be achieved through the use of reagents such as dopamine, which bonds well to most types of surfaces including stainless steel, glass, and plastics. At alkaline conditions, dopamine self-polymerizes and deposits as a thin coating on the fiber surfaces. In the examples here, a typical dopamine concentration of 2 mg/ml in 12.5 mM Tris buffer pH 8.3 was used for coating the textile fabric at 28° C. for 20 hours with a constant shaker speed of 100 RPM.

### Example 11. Alternative Immobilization Methods

An entrapment immobilization method, where enzymes are embedded in a matrix such as the chitosan coating process described in Examples 1-3, was selected for the packing designs described in Example 6-8 because of its advantages such as high activity yield, low cost and low environmental impact. Other immobilization methods, such as surface covalent attachment, are also compatible with the packing design described in Examples 6-8. The chemical reactions can take place after the packing has been made using techniques described in Examples 3 and 5.

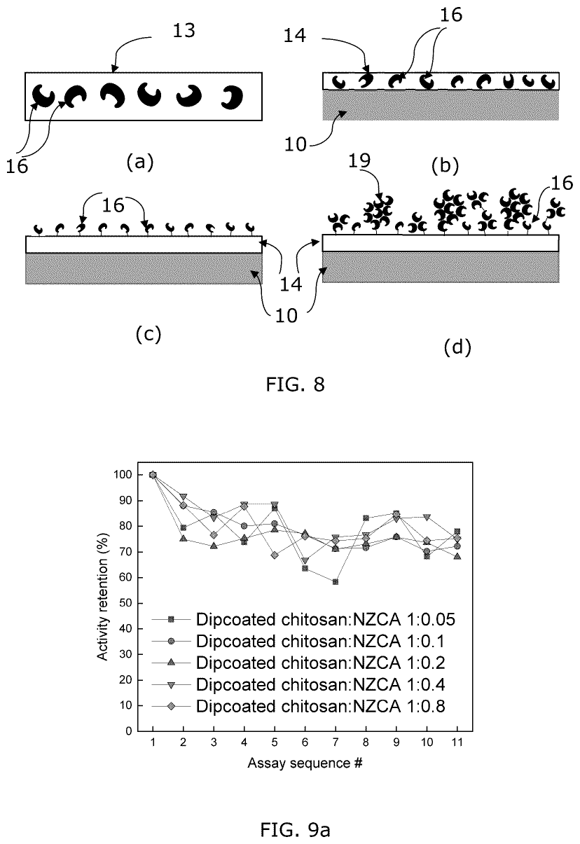

FIG. 8. shows comparisons of different surface morphologies created by different immobilization methods. FIG. 8a illustrates the results of entrapping enzymes 16 inside a self-supporting polymer structure 13. FIG. 8b illustrates the results of using the dip-coated or padded method where yarn 10 is placed in contact with a solution containing enzymes (not shown) and the coating 14 with entrapped enzymes 16 coats the yarn 10 at the contact location. FIG. 8c illustrates the results of using the multi-step surface attachment method with a cross-linker (not shown) and enzyme 16 introduced in sequence to the coated 14 yarn 10. The coating 14 with attached enzymes 16 is shown attached to one side of the yarn 10. FIG. 8d illustrates the results of using the one-pot surface attachment method with a cross-linker (not shown) and enzyme 16 introduced simultaneously to the coated 14 yarn 10. The coating 14 with attached enzymes 16 forming some enzyme clusters 19 is shown attached to one side of the yarn 10.

### (a) Multi-Step Surface Attachment

The multi-step surface attachment method involves a separate step for activation of the surface, i.e., rendering the surface reactive toward enzymes, and a subsequent step bringing the activated surface and enzyme solution together. Due to the fact that excess unreacted cross-linking agents are removed prior to the enzyme immobilization step, enzyme—to enzyme crosslinking is eliminated, leaving enzymes only attachable to the available reactive groups on the activated surfaces. In this Example 11 (a), amine functionalized surfaces were obtained using chitosan coating as described in Example 10, and the amine groups was reacted with glutaraldehyde or bi-functional activated esters (lab-synthesized: succinic acid or sebacic acid activated by 1-Ethyl-3-(3-dimethylaminopropyl) carbodiimide hydrochloride and stabilized by N-Hydroxysuccinimide) rendering the surface reactive towards surface lysine amino group on CAs. The immobilization step took place in phosphate buffered saline (PBS) pH 7.4 with a stock CA concentration of 10 μl/mL assisted by constant stirring at room temperature for 1 hour. According to the esterase activity results listed on Table 1, CAs immobilized using this method had active enzyme loadings equivalent to that of the entrapped CAs at enzyme loadings between 1:0.05 and 1:0.1 (chitosan: stock CA solution (g: mL)).

### (b) One-Pot Surface Attachment

In the one-pot surface attachment method, crosslinkers and enzymes are introduced simultaneously and therefore a significant amount of enzyme-to-enzyme cross-linking occurs. The total enzyme loading can be increased in comparison to the multi-step surface attachment method, while activity yield can be relatively low due to a large portion of the added CAs remaining in the immobilization solution. In this Example 11 (b), amine surfaces were achieved by dip-coating with a chitosan solution, padding with a chitosan solution, or coating with dopamine with or without chitosan or polyethyleneimine (PEI). For the examples listed in Table E11, stock CA (5 μl/mL) with glutaraldehyde (0.2%) in PBS pH 7.4 was used for the one-pot surface attachment and the reaction proceeded at 28° C. for 16 hours with constant shaker speed of 140 RPM. The total active CAs loadings obtained using this method were much higher than those achieved by the multi-step method and corresponded to the higher amounts of CA dosing (>1:0.5 Chitosan: CA stock solution g/mL) based on the dip-coated entrapped CAs. In another embodiment, crosslinker and CA could be sprayed or padded on the amine surfaces in one or more layers, which could improve the activity yield by applying the entire immobilization solution directly to the amine surfaces.

Table E11 shows comparisons of PNP release rate indicative of the esterase activity of the immobilized carbonic anhydrase (CA) enzymes used in the examples. A typical esterase assay using pNPAc as the substrate was adapted according to Example 12 for the measurement of solid immobilized CAs.

TABLE E11
p-Nitrophenol (PNP) release rate of immobilized CAs on substrates
with the same macroscopic two-dimensional area.

| | | | | PNP release |
|---|---|---|---|---|
| | | | | rate |
| Textile type | Immobilization Method | Surface Treatment | Crosslinker | (mmol/min) |
| Cotton | Surface attachment | Padded w/chitosan | Glutaraldehyde | 2.26 |
| woven fabric | one-pot | solution | | |
| Cotton | Surface attachment | Coated w/dopamine | Glutaraldehyde | 3.47 |
| woven fabric | one-pot | | | |
| Cheesecloth | Surface attachment | Dip-coated w/chitosan | Glutaraldehyde | 1.74 |
| 90 | one-pot | solution | | |
| Cheesecloth | Surface attachment | Padded w/chitosan | Glutaraldehyde | 2.14 |
| 90 | one-pot | solution | | |
| Cheesecloth | Surface attachment | Coated w/dopamine | Glutaraldehyde | 3.07 |
| 90 | one-pot | | | |
| Cheesecloth | Surface attachment | First dip-coated with | Glutaraldehyde | 2.53 |
| 90 | one-pot | chitosan solution | | |
| | | then coated w/dopamine | | |
| Cheesecloth | Surface attachment | Coated with dopamine | Glutaraldehyde | 2.90 |
| 90 | one-pot | and PEI at the same | | |
| | | step | | |
| 4-Ply Cotton | Surface attachment | Dip-coated w/chitosan | Glutaraldehyde | 2.74 |
| yarn | one-pot | solution | | |
| 4-Ply Cotton | Surface attachment | Padded w/chitosan | Glutaraldehyde | 3.20 |
| yarn | one-pot | solution | | |
| 4-Ply Cotton | Surface attachment | Coated w/dopamine | Glutaraldehyde | 4.54 |
| yarn | one-pot | | | |
| Viscose | Surface attachment | Coated w/dopamine | Glutaraldehyde | 4.13 |
| fabric | one-pot | | | |
| Electrospun | Surface attachment | Crosslinked w/GA, | Glutaraldehyde | 2.68 |
| PVA nanofiber | one-pot | them coated w/dopamine | | |
| Cheesecloth | Surface attachment | Dip-coated w/chitosan | Glutaraldehyde | 0.16 |
| 90 | multi-step | solution | | |
| Cheesecloth | Surface attachment | Dip-coated w/chitosan | Activated | 0.33 |
| 90 | multi-step | solution | succinate ester | |
| Cheesecloth | Surface attachment | Dip-coated w/chitosan | Activated | 0.26 |
| 90 | multi-step | solution | succinate ester | |
| Cheesecloth | Entrapment | Dip-coated w/chitosan- | N/A | 0.13 |
| 90 | | CA solution (1:0.05) | | |
| Cheesecloth | Entrapment | Dip-coated w/chitosan- | N/A | 0.39 |
| 90 | | CA solution (1:0.1) | | |
| Cheesecloth | Entrapment | Dip-coated w/chitosan- | N/A | 0.79 |
| 90 | | CA solution (1:0.2) | | |
| Cheesecloth | Entrapment | Dip-coated w/chitosan- | N/A | 1.33 |
| 90 | | CA solution (1:0.4) | | |
| Cheesecloth | Entrapment | Dip-coated w/chitosan- | N/A | 3.24 |
| 90 | | CA solution (1:0.08) | | |
| Cheesecloth | Entrapment | Dip-coated w/chitosan- | N/A | 1.24 |
| 90 | | CA solution (1:1) | | |

### Example 12. Adaptation of Microplate Assays for the Measurement of Immobilized CAs

The microplate assay adaptation needed for measuring solid samples essentially involved upscaling a typical 96-well microplate assay to a larger 24-well plate to accommodate a sufficiently large piece of textile sample (with immobilized CA) in each well. Lab scale prototypes of CA-immobilized textile, depending on their dimensions, were either coiled at the perimeter or placed flat at the bottom of the well with the center of the sample cut out for the signal light to pass through.

### Example 13. Activity Yield, Reusability, and Longevity of Immobilized CAs

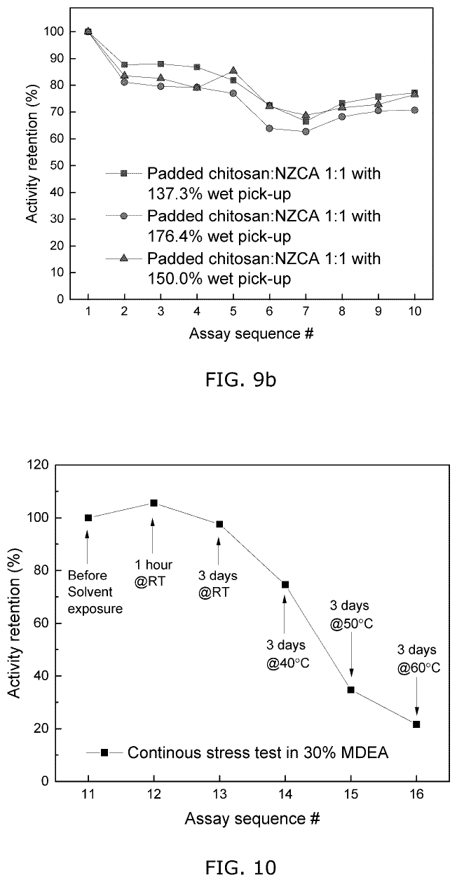

Cotton cheesecloth (Grade 90, Testfabrics Inc., West Pittston, NJ), a fabric with a convenient balance of yarn density for structural stability and inter-yarn porosity for allowing gas and liquid flow, was selected as model textile fabric for testing various coating methods and conditions to achieve useful levels of retained enzyme activity and longevity. A lab-scale dip-coating method was used to entrap varying amounts of CAs on cheesecloth. Fabric samples were cut into donut shapes to fit the 24-well assay plate according to assay adaptation described in Example 12. The esterase activities were calculated and compared to the same amount of dissolved CAs (Table E13). Activity yield after immobilization varied from 49% to up to 76% across the entire CA concentration range explored here. Increasing the CA loading does not sacrifice the outstanding activity yield afforded by the chitosan matrix and even at 1:0.8 chitosan to CA stock solution ratio, the maximum loading capability of chitosan was not reached. If activity yield decreased with increasing enzyme loading, this would signal the saturation of chitosan loading capacity. Variable enzyme loading coupled with sufficiently high activity yield provides vast flexibility in tailoring the formulation needed for up-scaling. As shown in FIG. 9a, all samples regardless of their loading amounts demonstrated good cyclability, with activity retention varying between 68% and 78% at the end of 11 sequential tests.

A method relevant for industrial scale fabrication of CA immobilized textiles involves the use of textile padding equipment. This method can enhance the efficiency of raw material utilization during material production. Because a CA loading ratio of 1:0.8 (g: mL, Chitosan: CA stock solution) did not reach its maximum loading capacity, the loading was increased to 1:1 (g: mL, Chitosan: CA stock solution) in the fabrication of padded entrapment prototypes. In this example, by varying the roller pressure, different wet pickup values were obtained that directly correlated with the amount of CA loading. The higher wet pickup indicated a larger CA loading in CA immobilized textiles, contributing to a higher retained apparent catalytic activity. As can be seen in Table E13, padded entrapment prototypes achieved 51%-62% of the activity yield of an equal amount of dissolved CA. After 10 cycles of repeated washing and testing, these padded entrapment samples retained 71-77% of their original activity over a four-day period, meaning that padding catalytic chitosan coating on cellulosic fabrics can be an efficient approach in manufacturing the CA immobilized textiles (FIG. 9b).

TABLE E13
Fabrication parameters used for making lab scale prototypes
of biodegradable carbonic anhydrase (CA) enzymes immobilized
cheesecloth 90 and their resultant activity yield calculated
based on the activity of an equal amount of dissolved CA.

| | | Chitosan:Stock | | Activity (%) vs. |
|---|---|---|---|---|
| | Chitosan | CA solution | Wet pick | equal amount of |
| Method | conc. (%) | (g/ml) | up (%) | dissolved CA |
| Dip-Coating | 1 | 1:0.05 | 402.31 | 49.22 |
| Dip-Coating | 1 | 1:0.1 | 437.26 | 71.71 |
| Dip-Coating | 1 | 1:0.2 | 431.59 | 71.62 |
| Dip-Coating | 1 | 1:0.4 | 382.04 | 57.43 |
| Dip-Coating | 1 | 1:0.8 | 375.81 | 75.57 |
| Padding | 1 | 1:1 | 137.30 | 62.08 |
| Padding | 1 | 1:1 | 176.40 | 50.52 |
| Padding | 1 | 1:1 | 150.00 | 61.53 |

### Example 14. Heat and Solvent Stress Tests of Immobilized CAs

Assay scale simulations of practical conditions encountered in the absorber were made by incubating samples in aqueous N-methyldiethanolamine (MDEA) and stepwise increasing the incubation temperature. Esterase activities were assayed at each step using the assay adaptations described in Example 12. As evident in FIG. 10, the immobilized CAs were compatible with 30% MDEA at room temperature. As temperature and accumulated time immersed in the solvent increased, the measured activities decreased. The 75% activity retention after continuous 3 days at RT and additional 3 days at 40° C. immersed in pH unadjusted 30% MDEA (pH 10.4) demonstrates a useful longevity level for absorber packing applications.

### Example 15. Absorption tests in small column

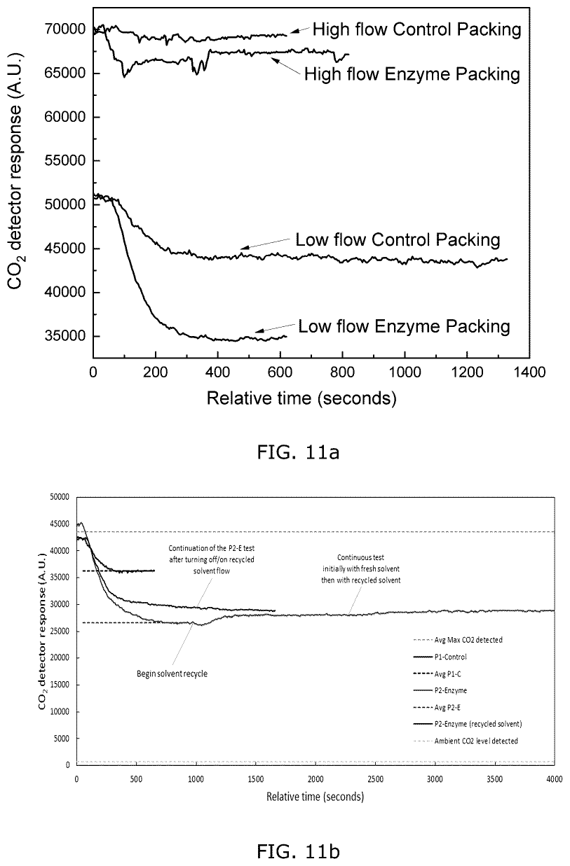

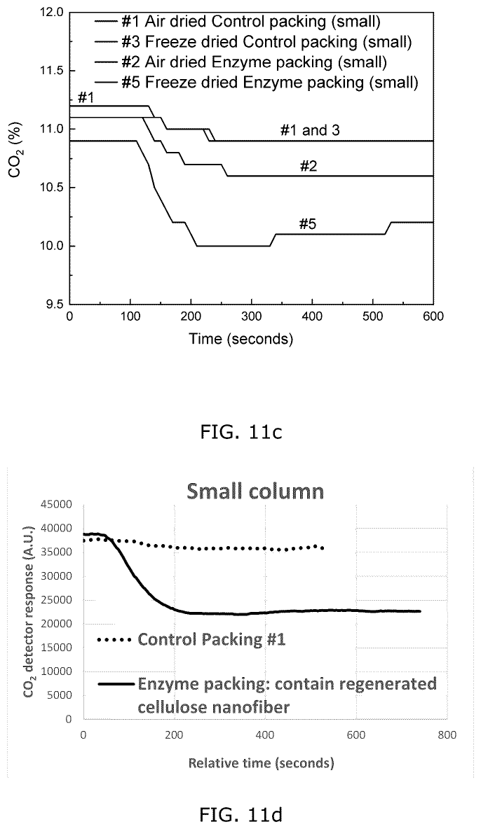

Small packings were first assembled according to Example 6, and then coated with a chitosan solution prepared in Example 1 using the process described in Example 3. Samples #1 (control) and #2 (enzyme) were air-dried and samples #3 (control) and #5 (enzyme) were freeze-dried according to the procedure described in Example 4.
Trial 1: The packing pair #1 (control) and #2 (enzyme) were tested three times on separate days each using slightly different testing conditions, but all of the trials demonstrated the enhancement of CO₂ absorption by enzyme packing (#2) compared to the control packing (#1). The general scrubber set-up and operation procedures are described in Example 9. In the first trial, option (a) CO₂ detector (Example 9) was used. Aqueous 10% K₂CO₃/KHCO₃ (initial pH 10.2) was supplied to and removed from the absorber at a constant rate of 75 mL/min in the absorber-only mode without recirculation. The glass column was pre-wetted to generate a similar starting condition for both the control and enzyme packings. At the high flow rate of CO₂: 0.4/N₂: 9 LPMs, a small difference between the control and enzyme packings was seen (see FIG. 11a.). Taking the dry baseline as 100% detectable CO₂, the control packing yielded 1% and enzyme packing resulted in 3% CO₂ absorption. At lower the flow rate of CO₂: 0.4/N₂: 3.6 LPMs, both control and enzyme packing showed a significant increase in CO₂ absorption. Considering the dry baseline response as 100% detectable CO₂, the increases amount to 32% CO₂ absorption for the enzyme packing and 14% CO₂ absorption for the control packing.
Trial 2: A second trial was conducted with the same packings #1 and #2, after rinsing and air drying and storage at ambient conditions for 1 week. The gas and liquid flow parameters remained at 75 mL/min and CO₂: 0.4/N₂: 3.6 LPMs, respectively. Solvent was freshly prepared aqueous 20%-wt. K₂CO₃ with no added KHCO₃ and no pH adjustment (initial pH 12.2). After fresh solvent was depleted, “recycled solvent” was used to prolong the test. The final pH of the recycled solvent at the end of all tests was pH 11.2. Based on an average maximum CO₂ detected after packings were installed, the control packing #1 (P1-Control in the FIG. 11b.) exhibited 17% CO₂ absorption and the enzyme packing #2 (P2-Enzyme in the FIG. 11b.) exhibited ˜2× higher CO₂ absorption of 39%. By using recycled solvent, continuous performance was achieved for >1 hour, confirming the consistent ability of CA immobilized packing to enhance CO₂ absorption.
Trial 3: In the third trial, option (b) CO₂ analyzer (Example 9) was used. Packings #1 (Control) and #2 (Enzyme) were retested for the third time after 2 months of dry storage. Total mixed gas flow rate was at 4 LPM, and a nominal 10% K₂CO₃/KHCO₃: 85/15 aqueous solvent mixture pH ˜10.5 with solvent flow rate of 75 mL/min was used. As shown in FIG. 11c., #2 enzyme packing had greater CO₂ adsorption compared to the #1 control packing with no immobilized enzyme. Another pair of packings, #3 and #5, made by freeze-drying were also included in this trial. The control packing #3 had closely similar performance to control packing #1 despite a different drying method being used in each case. On the other hand, #5 freeze dried enzyme packing showed better CO₂ absorption compared to the air-dried packing #2. One explanation for the result is that packing #2 had already been used 2 times prior to the current test and also potentially due to the better accessibility of immobilized enzymes in the finer structures created by the freeze-drying process. Regardless of mechanism, this set of results confirmed other observations that enzyme packing performed more than two times better than the control packing and that immobilized enzymes remained active after 2 months storage and after multiple uses.
Trial 4: In a separate trial, small packing containing cellulose nanofiber that was fabricated in Example 5 was tested in the small column using the option (a) CO₂ detector (Example 9) and identical gas and solvent as the trials above. The enzyme packing was constructed from a regenerated cellulose nanofiber mat supported by thin nylon net material and reinforced with cheesecloth 90 on the outer layers. CA was immobilized in chitosan by thin layers dip-coated on the fiber surfaces. The packing fit snugly in a 10 cm length×2 cm inner diameter narrow column. Initially, fresh lean solvent was used, then solvent recirculation, taking “rich” solvent from a collection vessel at the outlet of the absorber, started at 350 seconds after beginning the enzyme packing run. Taking each response curve's initial dry baseline as 100% detectable CO₂, the control packing gave 6.7% and enzyme packing resulted in 43.5% CO₂ absorption (FIG. 11d.). For comparison, previous trials using the same narrow column, gas flows, and CO₂ detector but different solvent compositions each time resulted in 14% vs. 32% and 17% vs. 39% (control vs. enzyme packing) CO₂ absorptions.

To summarize, in all trials using the small column, the immobilized enzyme packings achieved higher CO₂ absorption compared to coated control packings absent of enzyme. In addition, the packings were stable to repeated testing, rinsing, air drying and retesting.

### Example 16. Absorption tests in large column

To increase the experimental scale and level of CO₂ absorption, larger packings were made to increase the contacting areas. All test results discussed in this example were obtained from one or two large columns equipped with option (b) CO₂ analyzer described in Example 9. A total mixed gas flow rate of 4 L/min and nominal aqueous 10% K₂CO₃/KHCO₃ (85/15 mixture pH ˜10.5) solvent flow rate of 150 mL/min were used across all trials.

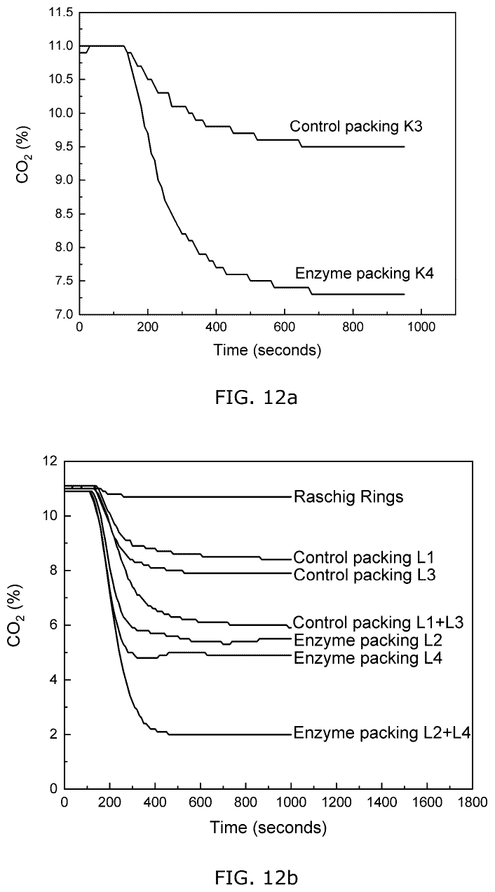

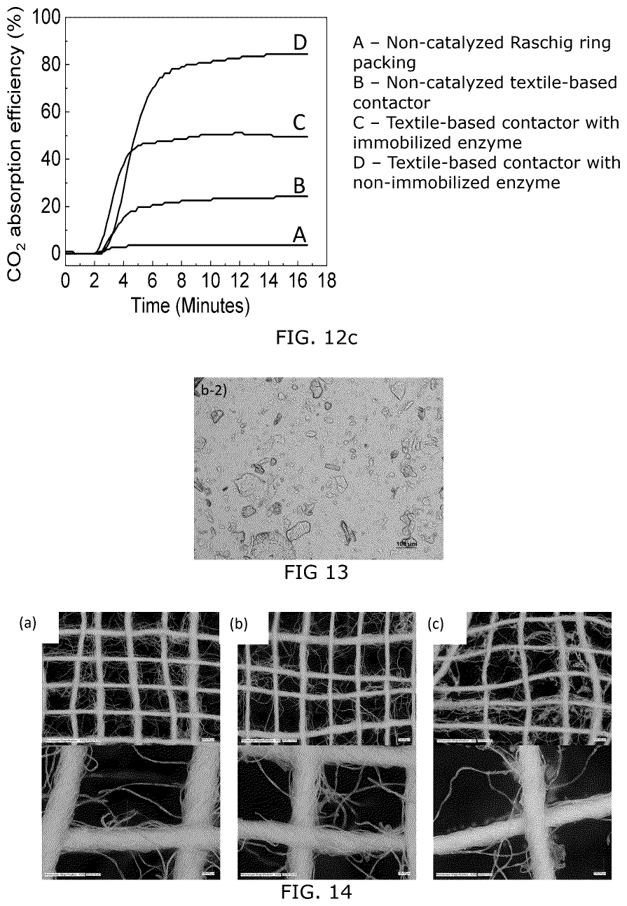

Large cone packings (designated “K”) were made according to the packing design described in Example 8 and were coated according to Example 3. K4 had a CA loading of 1:0.5 (g: mL, Chitosan: CA stock solution), different from the typically tested 1:1 loading. In FIG. 12a., it is evident that the control packing K3 helped lower the level of detected CO₂ (minimum: 9.5%) in the absorber exit gas compared to the small control packings (minimum: 10.9% for packings #1 and #3 in Example 15). The difference in minimum CO₂% is even more prominent for the enzyme packings K4 and #5 (Example 15), with 7.3% vs. 10.0%, respectively.

To maximize gas-liquid contact surfaces, avoid column flooding and direct liquid flow uniformly through the packing volume, a large spiral packing design (designated “L”, Example 7) was made by integrating continuous spiral shaped contacting surfaces within rolled-up walls of vertical contacting surfaces. Two replicates were dip-coated with chitosan without enzymes named L1 and L3 and another two were dip-coated with a chitosan solution containing CA loading of 1:1 (g: mL chitosan: CA stock solution) and were named L2 and L4. The packings were air dried for two days. The dry packings weighed 90+1 g. The packings were presoaked in fresh solvent for 10 minutes before testing. Two pairs of L packings were tested in the following order: (1) each of the two replicate controls one after the other to gauge reproducibility of fabrication; (2) stacking two control packings one on top of the other to demonstrate the stackability and continuity of gas-liquid contact, both physically and in terms of the result enhancement; (3) and (4) repeat the same sequence for the immobilized enzyme packing replicates as those described in (1) and (2) for the controls; and, (5) Raschig ring packings (cut glass hollow tubes 8 mm diameter×8 mm long×1 mm wall thickness; 0.4 g average mass per each ring) filled in the glass column up to the same packing height, as a reference for comparison. As shown in FIG. 12b., glass Raschig ring packing (389 g total mass) only provided very minimal CO₂ absorption capacity compared to textile packing Ls with or without enzyme. In this Raschig ring test, a 2 mm square mesh screen was used at the bottom of the column to support the rings. The results show that variabilities caused by hand fabrication of replicate packings were relatively small, i.e., L1 vs. L3 and L2 vs. L4. Furthermore, it was demonstrated that the textile packings can be stacked to reach higher CO₂ absorption efficiencies. Wet, drained packing materials had an average mass of 157+2 g, which is only 40% of the mass of an equivalent height of Raschig ring packing. Table E16 shows a comparison of the CO₂ absorption efficiencies among different packing materials. Standard Raschig rings filled in the 2.25″×12″ large column only sustained a 3.6% CO₂ absorption from the total CO₂ amount going through the column, while double stacked enzyme packing L2+L4 achieved a high efficiency of 81.7%. This is close to the 84.5% delivered by an uncoated L packing assisted by an approximately equivalent amount of dissolved CAs as was immobilized on L2 or L4. The advantages of using immobilized CAs for a recirculating absorption-desorption system are apparent when compared to the scenario where dissolved CAs would be exposed to a high desorber temperature and lose activity. An even higher CO₂ absorption efficiency of 94.5% was achieved by a high dose of dissolved CAs, about 10 times that of the amount typically immobilized on the textile packing, flowing through an uncoated packing L. An explanation for the better performance of the dissolved CAs originates from its mobility towards the liquid gas interfaces where the absorption reaction takes place. This soluble CA reference value demonstrates that with high enough enzyme dosing and an optimized enzyme distribution inside the packing through structural design (including fine structure and high gas-liquid surface area creation), it is possible to further improve the single enzyme packing from the measured CO₂ absorption efficiency reported here of 56%. Furthermore, the improved CO₂ absorption efficiency was achieved using textile packing that weighs significantly less, even when wet, than a comparable height of solid (glass Raschig ring) packing. Therefore, engineering designs incorporating textile packing may benefit from accounting for lower required mass of packing materials compared to conventional solid packing.

TABLE E16
Comparison of CO₂ absorption efficiencies of different packings.

| | | | | CO₂ |
|---|---|---|---|---|
| Packing | Nominal | Start | End | absorbed |
| sample ID | Column Size | CO₂ (%) | CO₂ (%) | (%) |
| Raschig rings | 2.25″ × 12″ | 11.1 | 10.7 | 3.6 |
| K3 | 2.25″ × 12″ | 11.0 | 9.5 | 13.6 |
| K4 | 2.25″ × 12″ | 11.0 | 7.3 | 33.6 |
| L1 | 2.25″ × 12″ | 11.1 | 8.5 | 23.4 |
| L3 | 2.25″ × 12″ | 11.1 | 7.9 | 28.8 |
| L1 + L3 | 2.25″ × 12″ × 2 | 11.0 | 6.0 | 45.5 |
| L2 | 2.25″ × 12″ | 10.9 | 5.4 | 50.5 |
| L4 | 2.25″ × 12″ | 10.9 | 4.8 | 56.0 |
| L2 + L4 | 2.25″ × 12″ × 2 | 10.9 | 2.0 | 81.7 |
| Uncoated L + | 2.25″ × 12″ | 11.0 | 1.7 | 84.5 |
| Low dose | | | | |
| dissolved NZCA | | | | |
| Uncoated L + | 2.25″ × 12″ | 10.9 | 0.6 | 94.5 |
| High dose | | | | |
| dissolved NZCA | | | | |

### Example 17. Preparation of Mild Chitosan Solutions for Carbonic Anhydrase Entrapment

Solid chitosan flakes were dissolved with mixing in 2% (v/v) aqueous acetic acid solution (pH 2.5) to make a homogeneous 4% (w/w) “chitosan solution A.” Chitosan solution A was poured into a Teflon plate and air dried in a fume hood at ambient temperature for 24 hours. The air drying allowed excess acetic acid to evaporate, leaving behind a solid “chitosan film A.” Chitosan film A obtained in this way was dissolved in sodium acetate buffer (100 mM, pH 5.0+0.1) or deionized water (pH 7.0) to obtain 1-4% (w/w) “chitosan solution B.”

### Example 18. Preparation of Chitosan-NZCA Solution

A weighed amount (436+3 mg) of liquid product of carbonic anhydrase, designated “NZCA” (Novozymes A/S, Bagsvaerd, Denmark) was mixed with chitosan solution B (1% wt., 40 g), from Example 17, to give a chitosan polymer to enzyme product mass ratio of 1:1. This chitosan-NZCA solution was mixed for up to 20 minutes at ambient temperature before use.

### Example 19. Preparation of Chitosan-NZCA Paste and Suspension

A weighed amount (436+3 mg) of liquid product of carbonic anhydrase (NZCA) was diluted with 436 mg sodium acetate (100 mM, pH 5.0) solution. The diluted enzyme product was then mixed with 436+3 mg chitosan powder (ChitoClear®, Primex, Iceland) until a light brown, uniform and sand-like paste was formed. Then 850 mg paste, which has a chitosan polymer to NZCA product weight ratio of 1:1, was mixed with 20 g 1% wt. “chitosan solution B” prepared in Example 17. The suspension was stirred at room temperature for up to 20 minutes before use.

### Example 20. Padding of Chitosan-NZCA Solution to Cellulosic Substrates

Solutions prepared from Example 18 or suspensions prepared from Example 19 (FIG. 13 were added to the sample reservoir of a lab scale padding machine. The coating solution/suspension was then padded onto selected dry cellulosic substrates (e.g., plain woven fabrics, cheesecloth) with pressure levels from 1-3. Obtained textile-based biocatalytic materials were air dried before further tests or characterizations.

### Example 21. Dip Coating of Chitosan-NZCA Solution on Cellulosic Substrates

Pre-wet cellulosic substrates (e.g., plain woven fabrics, cheese cloth) were added to solutions prepared from Example 18 or suspensions prepared from Example 19 (FIG. 13) with a liquor ratio of 1:20. After immersing the textile substrates in the coating solution/suspension for 1 hour, coated textile-based biocatalytic materials were taken out and residual coating solutions/suspensions were removed by squeezing the sample until no dripping was observed. The samples were air dried before further tests or characterizations.

### Example 22. Retained CA Activity and Enzyme Longevity Measured by Esterase Assay

The residual activity of immobilized NZCA prepared in Examples 20 and 21 was measured using an esterase assay adapted to a 24-well plate. Biocatalytic samples and controls were cut into donut shapes with an outside diameter of ⅝ inches and an inner diameter of 5/32 inches. Four replicates of each sample from two batches were used to collect the activity data. Residual activity of immobilized NZCA and activity loss after 8 washes are listed in Table E22. The activity loss was calculated using the equation below:

Activity loss=[(init. residual activity−residual activity after 8 washes)/init. residual activity]×100

NZCA immobilized on cheesecloth #90 prepared by padding showed greater than 60% detectable activity compared to dissolved NZCA (18.7 U/ml) and retained more than 50% residual activity after 8 washes with Tris buffer (pH 7.2). NZCA immobilized on cheesecloth #50 and #90 by padding a suspension of chitosan-NZCA paste showed high (65% and 46%, respectively) initial residual activity. Overall, the results show that the two formulation types and two coating methods can be applied to different loosely woven fabric structures with similar results in the esterase assay. This example shows the textile-based biocatalytic materials retained CA enzyme activity after multiple washes, and the extent of activity retention can be affected by the structure of textile substrates and the preparation methods.

TABLE E22
Residual activity of immobilized NZCA* and activity loss after 8 washes.

| | Initial Residual | Residual activity | Residual activity | Activity loss |
|---|---|---|---|---|
| | activity** | after 4 washes*** | after 8 washes**** | after 8 washes |
| Samples | (%) | (%) | (%) | (%) |
| #50 padding Sample | 31.80 | 28.29 | 26.79 | 15.8 |
| #90 padding Sample | 63.80 | 56.89 | 55.08 | 13.7 |
| #50 padding paste Sample | 64.67 | 54.03 | 45.13 | 30.2 |
| #90 padding paste Sample | 45.67 | 34.99 | 32.75 | 28.3 |
| #50 dip coating paste sample | 43.23 | 40.26 | 38.98 | 9.8 |
| #90 dip coating paste sample | 44.52 | 46.06 | 39.56 | 11.1 |

*Relative to dissolved NZCA activity;
**Residual activity after immobilization;
***Residual activity after 4 washes with Tris buffer;
****Residual activity after 8 washes with Tris buffer.

### Example 23. Microscopic Images of Textile-Based Biocatalytic Materials

Textile-based biocatalytic materials prepared in Examples 19 and 20 using cheesecloth #90 as the cellulosic substrate were characterized using an optical microscope, along with the untreated cheesecloth #90. Samples prepared with the padding method of Example 20 (FIG. 14b) have a similar morphology compared to the untreated control sample (FIG. 14a), while chitosan flakes were observed in samples prepared with the dip coating method of Example 21 (FIG. 14c). This means when different methods were applied to prepare the textile-based biocatalytic materials, the morphology of the final product can be varied. The differences in sample morphology can influence the measured apparent activity of immobilized CA (Table E22) and thus the overall performance as a gas-liquid-solid contactor for CO₂ separation.

In summary, in a laboratory scale counter-current gas-liquid contacting experiment using an aqueous K₂CO₃-based absorption solvent and a 10% CO₂ inlet gas mixture (balance N₂), a water-absorbent textile packing had significantly better CO₂ absorption performance (26% CO₂ absorption) than standard glass Raschig ring packing filled to the same height in the column (3.6% CO₂ absorption). The wet mass of the textile packing was only 40% of the dry mass of the Raschig rings. Therefore, a seven times higher CO₂ absorption performance was achieved by the textile packing with less than half the packing mass compared to conventional Raschig rings. Additionally, in order to conduct the comparison, the perforated plate support supplied commercially with the column and Raschig ring packing had to be replaced by a mesh basket to prevent column flooding, even at low liquid flow rates, whereas column flooding was not observed with the textile packing. Instead, liquid flowed throughout the textile packing material and exited the bottom of the packing without evidence of channeling or wall effects.

An equivalent textile packing with biocatalyst immobilized on the packing had a similar wet mass compared to the textile packing without biocatalyst and exhibited approximately two times higher CO₂ absorption performance (53%) compared to the no biocatalyst textile packing and exhibited approximately 15 times higher CO₂ absorption performance compared to the conventional Raschig ring packing. By stacking two modules of the biocatalyst immobilized textile packing, a CO₂ absorption level of 82% was achieved while maintaining the desirable liquid flow characteristics. In an additional experiment, an amount of biocatalyst was dissolved in the absorption solvent that was flowed through a single module of the textile packing, resulting in 85% CO₂ absorption, which is approximately 24 times higher CO₂ absorption performance compared to conventional Raschig ring packing. By adjusting the amount of biocatalyst in the system, even higher CO₂ absorption levels were achieved. Each textile packing was easily inserted and removed from the column as one coherent unit, therefore, the liquid flow pattern was predetermined by the fabrication of the textile packing and the textile packing offers a lightweight, easily handled, modular approach to achieving high CO₂ gas absorption using benign solvents, such as aqueous K₂CO₃-based solvents

### Example 24. CA Esterase Activity Assay Method

Some carbonic anhydrases (CA) are able to catalyze the hydrolysis of ester bonds of certain ester compounds. In this CA esterase activity assay, active CA catalyzes the hydrolysis of an ester substrate, p-Nitrophenyl Acetate (pNPAc), which releases a chromophore, p-Nitrophenol (pNP). The released pNP product has a yellow color that can be quantified using a spectrophotometer equipped with a microplate reader. Development of a more intense yellow color during the assay indicates higher CA enzyme activity.

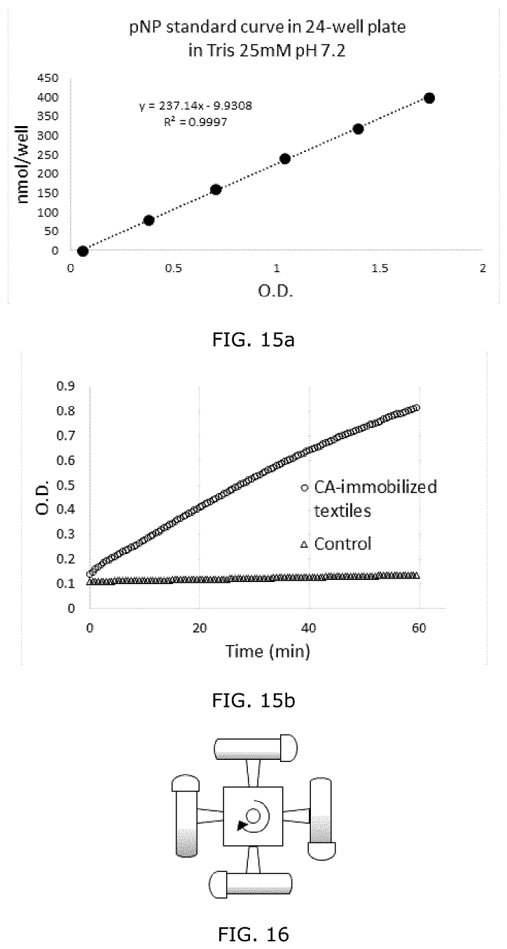

Standard curves were made using the same buffer as the sample. Buffer pH has a large effect on the baseline degradation of acetate. Higher pH promotes acetate hydrolysis. A standard curve was established, relating the optical density (O.D.) value to the amount of pNP in each well, by plotting the average O.D. vs. pNP amount per well. However, it is more convenient to use O.D. as x and Amount of NP as y (FIG. 15a) so that the slope can be simply multiplied by the O.D. change rate obtained for the test samples to yield the pNP release rate.

The kinetics of pNP release were monitored for samples and controls. The control used varied depending on the type of sample. The rule was to keep everything the same except for with or without enzyme. For CA liquid products, the control was Tris buffer, whereas for immobilized CA, the control sample was the corresponding immobilization matrix prepared without CA. When the O.D. values are plotted against time in minutes, the slope of the curve is the O.D. change per minute (FIG. 15b). Using the slope of the pNP standard curve, the pNP release rate with a unit of nmol/minute was obtained. For contribution made by the enzyme, the rate for the Tris buffer (or corresponding control) was subtracted from the rate of the sample.

### Calculation of CA Esterase Activity Values

Definition: One unit of CA activity is the amount of enzyme that catalyzes the release of 1 μmol of pNP per minute from the substrate at 25° C. (U=μmol/min)

a. For a liquid CA product:

$$CA esterase activity = rNP * DF / V ( U / mL )$$

where,
rNP=rate of pNP release due to CA (nmol/min)
DF=dilution factor
V=sample volume (μL)

b. For immobilized CA fabricated from liquid product:

$$CA esterase activity = rNP / V ( U / mL )$$

where,
rNP=rate of pNP release due to CA (nmol/min)
V=volume of liquid product used for fabricating the immobilized CA sample in each well (μL)

$$Unit analysis : ( n mol / min ) / µL = ( n mol / min ) * ( µmo1 / 1000 n mol ) / ( µL * ( mL / 1000 µL ) ) = ( ( µmol / min ) / 1000 ) / ( mL / 1000 ) = ( µmol / min ) / mL = U / mL$$

### Example 25. Assay Scale Low Agitation Durability Test for Immobilized CA

An assay scale durability test was utilized to evaluate the longevity of materials prepared by different CA immobilization methods. Different immobilized CA samples were prepared by first immobilizing CA on a textile matrix by the entrapment method to produce immobilized CA (iCA) textile. Then four different crosslinking conditions were applied to different portions of the iCA-textile, and the resultant crosslinked samples were compared to the non-crosslinked counterpart with the same enzyme loading. In a low agitation durability test, repeated rinsing and testing by the esterase activity (described in Examples 12 and 24) was carried out for 14 cycles on samples contained in the wells of a 24 well assay plate. Under these low mechanical stress conditions, all crosslinked samples retained significant esterase activity and, there was no discernible difference between the % activity retention of the crosslinked samples compared to the non-crosslinked sample. Both the crosslinked and non-crosslinked samples worked well in retaining high activity in these “static” repeated tests, which involved buffer replacement with minimal physical agitation.

### Example 26. Assay Scale Accelerated Long-Term Durability Tests for Immobilized CA

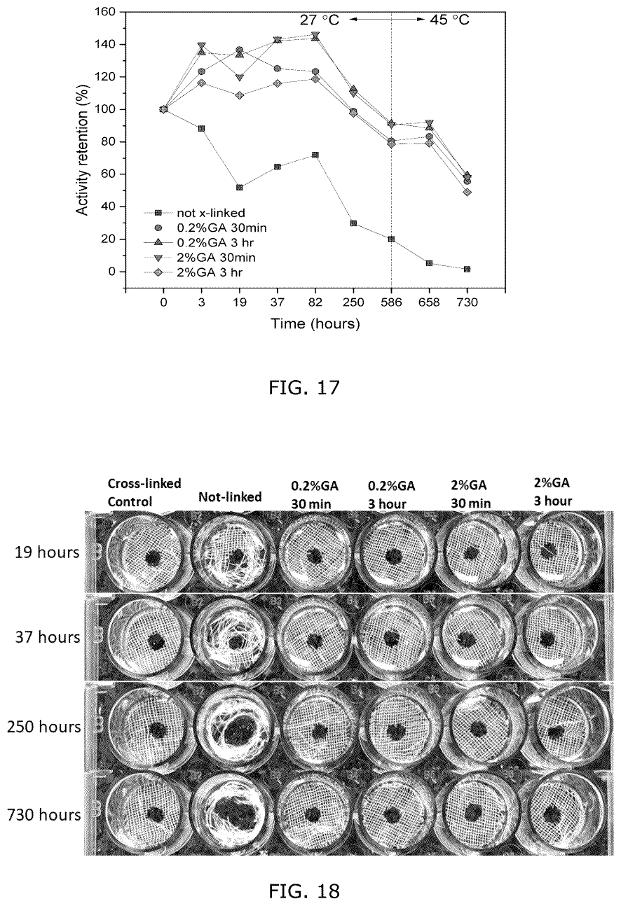

An assay scale accelerated durability and stress test was utilized to evaluate the longevity of materials prepared by different CA immobilization methods. To achieve an accelerated indication of material durability under stressful conditions of mechanical agitation, samples were transferred into Oak Ridge tubes each containing 20 mL (half full) of aqueous solvent. The Oak Ridge tubes were placed in a rotisserie type incubator (see FIG. 16 for schematic drawing) running end-over-end at 25 RPM and at 27° C. Samples retained at the end of the testing in Example 26 were filtered and washed in deionized (DI) water and Tris buffer before retesting. It is noticeable that after 3 hours of rotisserie end-to-end agitation, the activities of the crosslinked and non-crosslinked samples started to diverge (FIG. 17). After overnight mixing in the rotisserie, each sample reached a new baseline level with the non-crosslinked sample had the lowest activity retention and the sample crosslinked for 3 hours using a low glutaraldehyde concentration of 0.2% exhibited the highest activity retention. In addition, the physical appearances of the crosslinked and non-crosslinked samples were drastically different with the non-crosslinked sample falling apart over time while all crosslinked samples (and the crosslinked control) remained intact (FIG. 18). The accelerated durability test in the rotisserie style incubator was continued for a total of 31 days or 730 hours. Among all crosslinked variations, the sample that was crosslinked with 0.2% glutaraldehyde for 3 hours yielded the highest apparent activity as well as % activity retention over time. At the end of the 1-month test, this sample retained about 60% of its starting activity. At the end of the 1-month test, the crosslinked samples exhibited similar % activity retention (FIG. 17), while the non-crosslinked sample lost activity earlier than the crosslinked samples, as indicated by the steeper slope. Additionally, the visual sample appearance (FIG. 18) showed that the non-crosslinked sample was disintegrated under the continuous tumbling motion from the rotisserie style incubator while the crosslinked samples only had a few loose threads with the textile structures remaining mostly intact. At 27° C., the rates of activity loss of the crosslinked samples were low. Continuing the mixing and increasing the temperature to 45° C. for 6 days resulted in additional activity loss. To summarize, the results demonstrated that post-entrapment crosslinking is a viable strategy for improving packing durability and immobilized enzyme longevity.

### Example 27. Assay Scale Continuous Heat and Solvent Stress Test in 30% MDEA at 45° C.

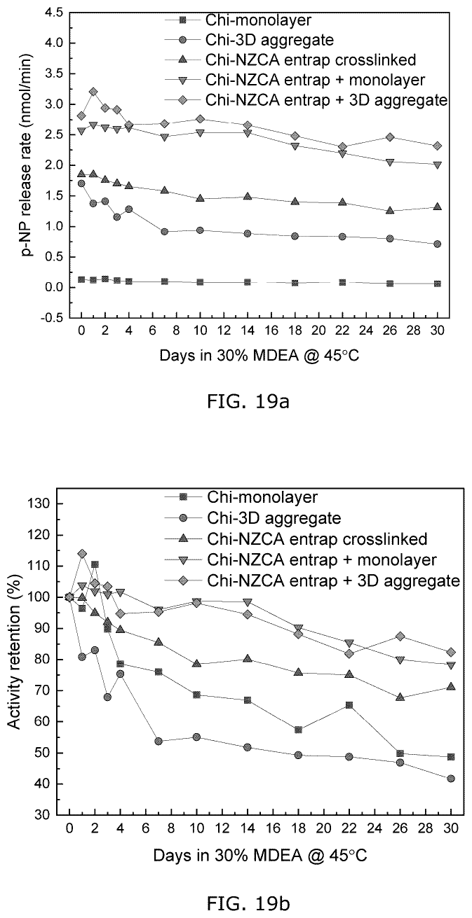

Several immobilization method variations involving the use of crosslinker, including samples prepared using multi-step surface attachment method (generating mono-layer) or one-pot surface attachment method (generating cross-linked 3-D aggregate) described in Example 11, were prepared on textiles that were either pre-coated with chitosan only or coated with chitosan comprising entrapped CA. These were compared to post-entrapment cross-linked samples. All samples were incubated continuously in 30% MDEA (pH 10.5) at 45° C. in a dry bath orbital shaker set at 120 RPM except for when taken out to conduct the esterase activity assay. Samples were filtered and washed in deionized water (DI) water and Tris buffer before being tested periodically. The pNP release rates (FIG. 19a), or percent activity retention (FIG. 19b), were plotted against the number of days the samples were incubated. Based on the esterase assay results, additional covalent immobilization of CA on the surface, either by monolayer or 3-D aggregate immobilization, on top of entrapment immobilization, increased the activity of the samples beyond that of samples made by each individual immobilization method. Therefore, the combination of two immobilization methods was successful in building up the total enzyme loading.

The results show (FIG. 19a) that the initial enzyme loading attainable by a monolayer of CA on the surface was relatively low (<10% vs. entrapment) compared to those immobilized by either entrapment or one-pot surface covalent 3-D aggregate, both of which yielded similar initial esterase activity. In a plot of percent activity retention (FIG. 19b), the two surface covalently immobilized samples exhibited the greatest activity drops after incubation yielding 48.7% and 41.7% activity retention for mono-layer and 3-D aggregate, respectively, at the end of a 30-day incubation period. The crosslinked entrapment sample retained 71.1% of its original activity, and samples that combined both entrapment and surface immobilization exhibited the highest activity retention of 82.3% after 30-day incubation. All samples retained greater than 40% esterase activity after the 30-day incubation, indicating that the chitosan matrix together with crosslinking preserved CA immobilization on the textile matrix.

### Example 28. Surface Covalent Immobilization on Pre-Formed Textile Packing Fiber Surfaces

Covalent immobilization reactions were conducted with pre-formed textile packing, using a column-shaped container. A magnetic stirrer was placed at the bottom of the reaction vessel for homogeneous mixing of the reagents and to facilitate a gentle spinning motion of the packing. For surface covalent immobilization, the preformed packings were first coated with 1% chitosan solution (in 5% acetic acid) and air dried to introduce amino functionality to the cellulosic fiber surfaces for the subsequent chemical crosslinking. Chitosan coated samples were air dried for several days or air dried for at least one day followed by additional oven drying at 60° C. to shorten the time to thoroughly dry the samples, which was monitored by weighing samples until they achieved a constant mass. Two different crosslinking reaction variations were employed: one separated the crosslinker activation and enzyme immobilization into two steps to generate a monolayer of immobilized enzymes on the chitosan coated surface (Multi-step surface attachment, Example 11 (a)), and the other applied crosslinker and enzyme at the same time to generate multiple layers of crosslinked enzyme on the surfaces (One-pot surface attachment, Example 11 (b)). A typical protocol for making monolayer immobilized CA involved activation of chitosan coated surfaces using 0.2% glutaraldehyde in phosphate buffered saline (PBS) pH 7.4 for 3 hours with magnetic stirring at room temperature. The activated packing was then rinsed with copious amounts of deionized water to remove unreacted glutaraldehyde and was hanged to drain until the dripping stopped. The packing was then transferred back into a graduated cylinder containing 5 μL/mL of CA in PBS pH 7.4 with continuous stirring overnight at room temperature. After enzyme immobilization, the packing was rinsed under tap water and soaked in 25 mM Tris buffer pH 7.4 to cap any unreacted free aldehyde. Finally, the packing was rinsed under tap water and air dried. Similarly, for surface 3-D aggregate, the chitosan coated packing was introduced into the graduated cylinder containing both 0.2% glutaraldehyde and 5 μL/mL of CA in PBS pH 7.4 and stirred for 20 hours at room temperature. The final steps for soaking and drying were the same as for the monolayer method. The CO₂ absorption efficiency of the surface covalently immobilized monolayer and 3-D aggregate were, respectively, 70.3% and 66.7%, tested using 10% K₂CO₃/KHCO₃ 85/15 PH ˜10.5 at flow rate of 120 mL/min, CO₂ flow rate of 0.4 LPM CO₂, and N₂ flow rate of 3.6 LPM.

The L surface covalently immobilized NZCA 3-D aggregate packing was used in the 10-test wash dry cycles Example 29. The L surface covalently immobilized NZCA 3-D aggregate packing was additionally used for studying the direct air capture using sea water (Example 34) and buffers (Example 35), effects of CO₂ concentration (Example 36), and solvent saturation and regeneration (Example 37). After that, it was stored in dry ambient condition until retesting 14 months after it was first made (Example 29) The activity retention compared to the first run was 86%. All of the above tests were done for a short period before rinsing and air drying for storage.

### Example 29. Reusability and Longevity Tests of Immobilized CA Packings in a Laboratory Gas Scrubber

The cost savings brought about by immobilized enzymes depend largely on their reusability and longevity. To evaluate reusability in the laboratory gas scrubber, a surface covalently immobilized CA 3-D aggregate packing style L was prepared due to its high initial CO₂ capture efficiency of 66.7% and was tested for 10 times. The capture performances are summarized in Table E29. The packing was repeatedly rinsed, air dried and stored at ambient conditions between each test. The testing occurred over the course of 71 days. Prior to the last test, the packing was soaked for 100 hours in the CO₂ absorption solvent (10% K₂CO₃/KHCO₃ 85/15 pH ˜10.50) at an elevated temperature of 45° C. After the repeated test, rinse, dry and storage cycles and after the final 100-hour incubation in the solvent at a temperature that is typical for a CO₂ absorber column, the L surface covalently immobilized 3-D aggregate packing exhibited full (100%) retention of the CO₂ capture performance, which demonstrates the excellent durability and performance of the packing. After one year of storage, test #1 was repeated as test #11 in Table E29. The activity retention compared to the first run was 86%. After one year of storage and completing the tests of Example 38, test conditions #11 were repeated, except the inlet gas composition included air. The exiting concentration of O2 increased from 9.3% to 9.8% within 10 minutes and remained stable throughout the remainder of the 20-minute run. The CO₂ concentration dropped from 10.5% to 4.6% within 10 minutes and remained stable throughout the remainder of the 20-minute run. The system functioned in the presence of oxygen.

TABLE E29
CO₂ Capture efficiency of L surface covalently immobilized NZCA 3-D aggregate packing.

| # of | | | Starting | Lowest | % CO₂ |
|---|---|---|---|---|---|
| Test | Conditions prior to testing | Solvent | CO₂% | CO₂% | Captured |
| #1 | Stored in Tris buffer | 10% K₂CO₃/KHCO₃ 85/15 pH~10.51 | 11.1 | 3.7 | 66.67 |
| #2 | Rinse and dry storage in open air | 10% K₂CO₃/KHCO₃ 85/15 pH~10.49 | 10.7 | 2.7 | 74.77 |
| #3 | Rinse and dry storage in open air | 10% K₂CO₃/KHCO₃ 85/15 pH~10.47 | 10.9 | 3.4 | 68.81 |
| #4 | Rinse and dry storage in open air | 10% DMG HCl/NaOH adjusted pH ~10.90 | 11.0 | 3.2 | 70.91 |
| #5 | Rinse and dry storage in open air | 5% K₂CO₃/KHCO₃ 85/15 pH ~10.51 | 11.2 | 4.9 | 56.25 |
| #6 | Rinse and dry storage in open air | 5% DMG HCl/NaOH adjusted pH ~10.76 | 11.3 | 3.8 | 66.37 |
| #7 | Rinse and dry storage in open air | 5% MDEA pH ~11.15 | 11.0 | 4.1 | 62.73 |
| #7.5 | Continuous | Tap water | 10.9 | 10.7 | 1.83 |
| #8 | Rinse and dry storage in open air | 10% K₂CO₃/KHCO₃ 85/15 pH ~10.47 | 11.0 | 3.5 | 68.18 |
| #8.5 | Continuous | 30% K₂CO₃/KHCO₃ 85/15 pH ~10.6 | 11.0 | 5.6 | 49.09 |
| #9 | Rinse and dry storage in open air | 10% K₂CO₃/KHCO₃ 85/15 pH ~10.48 | 10.9 | 3.8 | 65.14 |
| #10 | 100 hours at 45° C. in solvent | 10% K₂CO₃/KHCO₃ 85/15 pH ~10.45 | 11.1 | 3.7 | 66.67 |
| #11 | After 1 year storage | 10% K₂CO₃/KHCO₃ 85/15 pH ~10.52 | 11.2 | 4.3 | 57.14 |

### Example 30. Effect of Solvent Types and Concentrations on the CO₂ Capture Efficiency

The CO₂ absorption effectiveness of immobilized CA textile-based packing was evaluated with different CO₂ scrubbing solvents including K₂CO₃ (potassium carbonate), MDEA (N-Methyldiethanolamine), and DMG (N,N-dimethylglycine). As shown in Table E30, all solvent compositions were effective in absorbing CO₂ from the gas mixture and the extent of CO₂ capture was enhanced by CA immobilized textile packing. In Table E30, solvent types are arranged according to the time sequence each packing was tested. Notably, even absent enzyme, the L1 no enzyme textile packing (control) yielded very consistent capture efficiency of 23-24% using the same 10% K₂CO₃ solvent in the first and last scrubber tests. Therefore, differences observed in the tests bracketed by the initial and final measurements can be attributed to actual differences in solvent performance. Among the three solvents tested at 5% concentration without enzymes, DMG performed the best, followed by K₂CO₃ and MDEA. It is also noteworthy that reducing the concentration of the K₂CO₃ from 10% to 5% did not affect the CO₂ capture efficiency of the uncatalyzed absorption process. However, for the catalyzed absorption using L surface covalently immobilized packing, 5% K₂CO₃ exhibited lower capture efficiency than 10% K₂CO₃. An explanation for this is, because of the high capture efficiency resulting from the use of L surface covalently immobilized packing, the 5% K₂CO₃ solvent is considered to have exceeded its CO₂ loading capacity and therefore showed a decrease in capture efficiency compared to the more concentrated 10% K₂CO₃. Overall, DMG had the highest capture efficiency at both 5% and 10% concentrations and in both catalyzed and uncatalyzed processes. Another notable observation is that the more concentrated 20% and 30% K₂CO₃ reduced the capture efficiency of both catalyzed and uncatalyzed absorptions. This can be explained by that the higher viscosities of the concentrated solvent changed the liquid flow behavior or increased liquid film thickness or droplet size and ultimately reduced the liquid-gas-enzyme interfaces which lowered the overall absorption performance. Therefore, in a significant departure from conventional wisdom, the textile-based packings allow low solvent concentrations to perform as well as or even better than higher solvent concentrations, which can result in operational costs savings and an improved environmental health and safety (EHS) and process sustainability profile. This was observed for the no enzyme control packing as well as the immobilized enzyme catalyzed packings. All textile-based packings exhibited much higher CO₂ absorption compared to an equal packing height of conventional 8 mm×8 mm Raschig ring packing.

TABLE E30
CO₂ capture efficiencies of conventional and textile-
based packings using various solvents.

| | 10% | 20% | 10% | 5% | 5% | 5% | 10% | 30% |
|---|---|---|---|---|---|---|---|---|
| | K₂CO₃ | K₂CO₃ | DMG | K₂CO₃ | DMG | MDEA | K₂CO₃ | K₂CO₃ |
| | pH | pH | pH | pH | pH | pH | pH | pH |
| Packing ID | 10.51 | 10.51 | 10.90 | 10.50 | 10.76 | 11.15 | 10.47 | 10.60 |
| Raschig ring | 3.6% | 4.5% | | 5.4% | | | | |
| L1 no enzyme | 23.4% | 20.9% | | 23.6% | 31.3% | 22.0% | 24.3% | |
| L2 enzyme | 48.6% | 32.1% | | 32.1% | | | 33.3% | |
| entrapped | | | | | | | | |
| L surface | 68.8% | | 70.9% | 56.3% | 66.4% | 62.7% | 68.2% | 49.1% |
| covalent 3-D | | | | | | | | |
| aggregate | | | | | | | | |

### Example 31. Effects of Solvent and Gas Flow Rates, Enzyme Loading and Location, Post-Entrapment Crosslinking, and Additional Post-Entrapment Surface Immobilization on the CO₂ Capture Efficiency

The CO₂ capture efficiency of textile-based packing was found to be relatively insensitive to the change of solvent flow rates in the laboratory gas scrubber. As shown in Table E31, when gas flow rate was kept constant at a total of 4 LPM (Row 1 and 4) or 8 LPM (Row 2 and 3), decreasing the solvent flow rate by 60% from 55 RPM to 33 RPM (33/55=0.6) did not reduce the CO₂ capture efficiency to the same extent. Instead, more than 95% and 88% of the initial CO₂ absorption performance was retained. This demonstrated that the textile packing is capable of distributing solvent efficiently throughout the packing even at low liquid flow rates, maintaining uniform gas contact with the wetted solid contacting surfaces across a range of different liquid flow rates, leading to robust CO₂ capture efficiency. When gas flow was doubled, about 63% and 58% of the CO₂ capture efficiency was retained. Importantly, no column flooding and no wall effects (no liquid running along the inside surface of the column) were observed at any of the tested conditions, meaning that the packing allowed excellent liquid and gas transport through the column.

TABLE E31
Effects of solvent and gas flow rates on CO₂ capture
efficiency of L surface covalent immobilized packing

| | | CO₂ | | | | | | |
|---|---|---|---|---|---|---|---|---|
| Solvent | N₂ flow | flow | | | | Effect of | Effect of | Liquid to |
| flow rate | rate | rate | Starting | Lowest | % CO₂ | gas flow | solvent flow | gas ratio |
| (RPM)* | (LPM) | (LPM) | CO₂ % | CO₂ % | Captured | increase | decrease | (mL/L) |
| 55 | 3.6 | 0.4 | 10.9 | 3.4 | 68.81 | | | 30 |
| 55 | 7.2 | 0.8 | 11.1 | 6.3 | 43.24 | 62.85% | | 15 |
| 33 | 7.2 | 0.8 | 11.0 | 6.8 | 38.18 | 58.08% | 88.30% | 9 |
| 33 | 3.6 | 0.4 | 10.8 | 3.7 | 65.74 | | 95.54% | 18 |

*55 RPM~120 mL/min; 33 RPM~72 mL/min

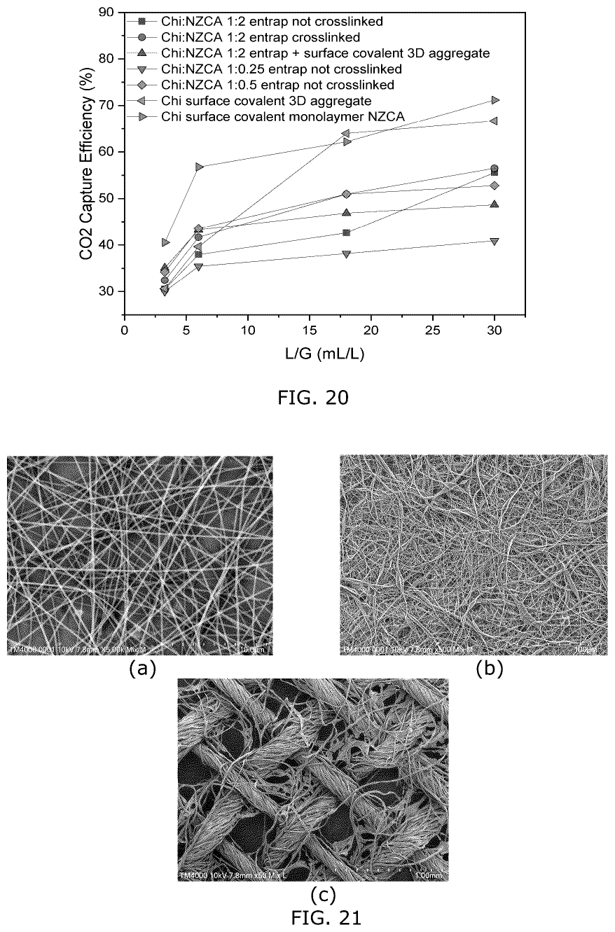

To further evaluate the effect of liquid to gas ratio at a wider range, the solvent flow rates were varied from 120 mL/min down to 13 mL/min at a constant total gas flow rate of 4 LPM, which resulted in an L/G ranging from 3.3 to 30 mL/L (FIG. 20). The results showed a dramatic increase in the capture efficiency between the L/G of 3.3 and 6 mL/L. Beyond that the additional enhancement was more gradual. In other words, the textile packings were operated at a low L/G of ˜6 mL/L without a drastic decrease in the capture efficiency. Operating the CO₂ absorber at a low L/G can be desirable for minimizing the amount of solvent that needs to be heated during the CO₂ stripping process and thereby saving energy.

Also, in FIG. 20, a comparison of the L packings with different amounts of entrapped CA shows that increasing of CA (NZCA) loading from Chi: NZCA 1:0.25 to 1:0.5 resulted in a significant enhancement in the capture efficiency while the increase from 1:0.5 to 1:2 yielded lesser improvement. Therefore, the CA-to-chitosan loading ratio can be optimized for performance and minimized to reduce cost. Also, as shown in FIG. 20, comparisons between the L packings with entrapped CA loading of Chi: NZCA 1:2 with or without post-entrapment crosslinking were plotted. The crosslinking treatment did not adversely affect the CO₂ capture efficiency of the packing. Notably, L surface immobilized CA monolayer packing achieved the highest overall CO₂ capture performance even though, according to the esterase activity assay (FIG. 19a), this packing only had an estimated 7% total enzyme loading compared to an entrapped CA with chi: NZCA ratio of 1:1. Therefore, presence of CA near the gas-liquid interface in the packing is important for achieving high CO₂ capture efficiency.

### Example 32. SEM Images of Fibrous Structures

Electrospun polyvinyl alcohol (PVA) and cellulose acetate fibers and cheesecloth samples were observed using scanning electron microscopy (SEM), shown in FIGS. 21a, 21b, and 21c, respectively. Fiber and yarn diameters as well as fabric structural dimensions were estimated from SEM images using Image J software (Table E32a and E32b). Electrospun PVA fiber (FIG. 21a) has uniform fiber diameter distribution with an average diameter of 246+43 nm. Crosslinking of the PVA nanofibers slightly increased the fiber diameter. In addition, entrapment of NZCA enzyme in the fiber did not significantly change fiber morphology. This is a non-limiting example of nano-scale diameter fibers comprising entrapped enzymes and comprising a synthetic hydrophilic polymer, PVA, that can be modified by crosslinking to change its solubility properties, i.e., cross-linked PVA has lower water-solubility than PVA.

As shown in FIG. 21b, the electrospun cellulose acetate fibers have a large fiber diameter distribution range from 100 nm to 2 μm, and the average diameter determined was 344+392 nm. The deacetylation process slightly increased the fiber diameter due to fiber swelling caused by the alkaline solution. Coating the electrospun cellulose (deacetylated cellulose acetate) nanofibers with 1% chitosan did not change the morphologies of the nanofiber mats, meaning chitosan was coated onto the fibers at a single fiber level and did not fill the space between the fibers. Similarly, no enzyme aggregate is visible at a higher magnification when 1% NZCA was coated onto the nanofiber mats and air dried.

One of the fabrics used in the packing fabrication was cheesecloth (Grade 90, Testfabrics Inc., West Pittston, NJ) made from single ply cotton yarns with an average diameter of 220+53 μm. The average length of a side of the square opening in the fabric structure is 433+54 μm and the average widest cross-sectional width of the cotton fibers making up the cotton yarn is 15+4 μm. The cheesecloth fabric has a loose plain weave fabric construction, with about 17 warp yarns per centimeter and 12.5 fill yarns per centimeter. The fabric weight is 41 g/m². At ambient conditions, the yarn linear density was 14.0 tex (equivalent to 14.0 g/km), which corresponds to approximately 40 Ne in the English cotton count system. It was observed that the crosslinked chitosan coating on the cotton fiber appeared smooth and extremely thin. It was also observed that attaching a monolayer of NZCA on the fiber surface did not produce any observable changes to the surface morphology. On the other hand, the one-pot surface covalent attachment method generated visible enzyme aggregate in the spaces between the fibers and yarns (FIG. 21c), which is in agreement with the high apparent activity detected by the esterase assay (Example 27).

TABLE E32a
Average diameters of electrospun
fibers estimated from SEM images.

| | Average |
|---|---|
| Electrospun fiber | diameter (nm) |
| PVA | 246 ± 43 |
| PVA-crosslinked | 268 ± 37 |
| PVA-NZCA entrapped | 227 ± 51 |
| PVA-NZCA entrapped-crosslinked | 274 ± 67 |
| Cellulose acetate (CA) | 344 ± 392 |
| Cellulose (deacetylated CA) | 486 ± 585 |

TABLE E32b
Average dimensions of cheesecloth structural
components estimated from SEM images.

| | Average |
|---|---|
| Cheesecloth | dimension (μm) |
| Length of one side of the square spaces | 433 ± 54 |
| Yarn diameter | 220 ± 53 |
| Cotton fiber width | 15 ± 4 |

### Example 33. Packing Made with Cotton Yarn

A packing design was made using 4-ply cotton yarn, cheese cloth (Grade 90, Testfabrics Inc., West Pittston, NJ), and 50/50 polyester/cotton latch hook canvas (5 Mesh, Dimensions, IG Design Group Americas Inc., Atlanta, GA) as a rigid support. The packing diameter was made to fit inside a 2.25 inch inside diameter glass column. The fabrication procedure comprised the following steps. Step 1: Yarn was woven onto the canvas support with an alternating manner (front to back). Step 2: The yarn assembled canvas sheet was then laid flat together with a support sheet made of cheese cloth and canvas and the two sheets were rolled up together into a cylinder shape. The support sheet was made following steps 1-3 in Example 7. The strands of the yarn at the top of the packing were bundled together to form a cone shape, c). Step 3: The fully assembled packing material was then dip-coated in chitosan solution (control) or in chitosan solution comprising enzyme, as described in Example 3, and air dried completely for at least 48 hours prior to testing.

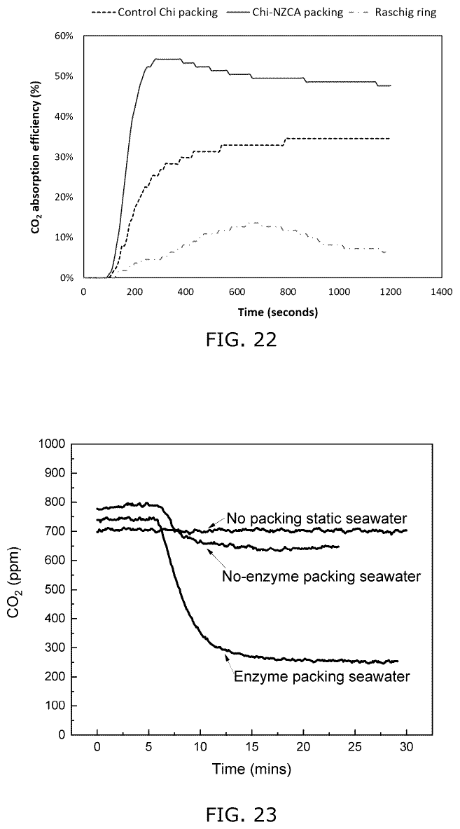

CO₂ absorption testing was run in single-pass counter-current mode as illustrated in FIG. 7. Referring to the test result curves in FIG. 22, at 1100 seconds in the CO₂ scrubbing test, the yarn assembled packing without enzyme (Chi) exhibited 34.6% CO₂ absorption. The wet packing comprising enzyme (Chi-NZCA, 290.4 g), which exhibited a 47.8% CO₂ absorption at 1100 seconds, weighed 25% less than dry Raschig ring packing (389 g), which exhibited a CO₂ absorption of 6.4% at 1100 seconds. The CO₂ absorption of the contactor control (FIG. 22, Chi), contactor comprising enzyme (FIG. 22, Chi-NZCA), and Raschig ring packing with the same height at 300 seconds were 26.7%, 54.2% and 4.5%, respectively. For the Chi-NZCA packing, without being bound by any specific mechanism, an explanation for the higher CO₂ absorption at 300 seconds compared to 1100 seconds is that the initial part of the curve represents the initial wetting of the column with absorption solvent. During this period, the textile yarns are not yet fully saturated with absorption solvent, allowing individual fibers within the yarns to serve as surface area for gas-liquid contact. When these exposed individual fibers have CA coated on the surface, they are able to efficiently catalyze CO₂ absorption. As the yarns become saturated with absorption solvent, some of the individual CA-coated fibers become fully immersed within the solvent, which decreases their ability to contribute to CO₂ absorption. Therefore, optimization of yarn structure and composition that exposes CA to the gas-liquid interface can lead to improved CO₂ absorption effects. The overall CO₂ absorption rate enhancement by the control Chi packing is lower compared to the Chi-NZCA packing, and, in this example, does not exhibit an initial “boosting” effect. In FIG. 22, the apparent increase in CO₂ absorption between around 600-800 seconds for the Raschig ring packing was due to temporary column flooding. In this example, the column flooding caused by the Raschig ring packing and the perforated plate supporting the packing diminished after a period of time, as evidenced by the lower CO₂ absorption at 1100 seconds compared to 700 seconds. Column flooding occurs when liquid does not drain sufficiently quickly through the column resulting in accumulation of a liquid “plug” across the column diameter. This “plug” acts as a bubble tank, causing pressure to build up inside the scrubber below the plug and forcing the gas to bubble through the liquid. This results in higher CO₂ absorption, but is undesirable because column flooding can cause more energy to be required to push gas through the column. The textile-based packings did not exhibit column flooding and performed better than conventional 8 mm×8 mm Raschig ring packing at all times, even when the Raschig ring packing was temporarily behaving as a bubble tank. The design of the textile-based packings eliminated the need for a perforated support plate. Also, the mass of the wet textile packing was significantly lower than the dry mass of the Raschig ring packing. Lower mass of materials can be an advantage in the construction and operation of gas-liquid contactors.

### Example 34. Direct Air Capture Using Simulated Seawater

A large column scrubber test (Single-pass flow through absorption mode, as described in Example 9 and illustrated in FIG. 7) in which seawater (sea salt mix for aquarium, pH adjusted to 10.0 using 1N NaOH) was flowed downwards at 120 mL/min (starting at time 5 minutes) through the packing (L surface covalently immobilized NZCA 3-D aggregate packing, Example 28) while 1.5 L/minute air (supplied by laboratory compressed gas system) flowed upwards. Results are shown for when no enzyme was present in the contactor and when the immobilized enzyme was present. Results are also shown for a test where seawater was present in the reservoir of the reactor (but not actively moving) while air was delivered to the reaction chamber across the water surface. Clearly, the process of seawater flowing through the packing enhanced the carbon uptake (19.6% CO₂ capture efficiency), and with enzymes present the carbon uptake was even higher (66.9% CO₂ capture efficiency). These results demonstrated the effectiveness of the packing at enhancing CO₂ absorption even from low CO₂ concentration gas mixtures, such as ambient inside air (600-800 ppm), and using low solute content solvents, such as naturally abundant seawater. Although the inlet air CO₂ concentration tested was higher than the global atmospheric air concentration (409.8 ppm in 2019 as reported by NOAA), passage through the enzyme packing lowered the CO₂ level to around 250 ppm, indicating that the packing will also perform CO₂ absorption with inlet gas comprising 400 ppm CO₂.

### Example 35. Direct Air Capture Using Buffer: The Effect of Air and Liquid Flow Rate on Carbon Uptake

This example presents the effects of air and liquid flow rates on the direct air CO₂ capture efficiency and on the carbon uptake rate (in the unit of grams of elemental carbon per hour). The adoption of a buffered system allows the change in the pH to be monitored in the continuous recirculating mode. As listed in Table E35, the maximum capture efficiency of the no-enzyme and enzyme packings afforded CO₂ capture efficiencies of 21% and 65.3%, respectively, similar to that of the same packings tested using a 10% CO₂ gas mixture and 10% K₂CO₃/KHCO₃ pH 10.5 solvent. This confirmed the effectiveness of the packing in low CO₂ concentration conditions. The unique characteristic of direct air capture lies in the fact that there is no limit or requirement on the CO₂ concentration of treated air released back to the environment. Consequently, the capture efficiency alone is not as important in the direct air capture scenario as it is for applications like flue gas scrubbing. As presented in Table E35, by increasing the air flow by 20-fold, although the CO₂ capture efficiency was decreased by 6-fold, the total carbon capture was increased by more than 3-fold. This increase in the total carbon uptake benefits the overall goal of capturing more carbon per hour and ultimately more carbon per dollar. Alternatively, at a fixed air flow rate, when the liquid flow rate was increased by 2-fold, the capture efficiency was increased by ˜50%, and the total carbon captured increased by ˜50%.

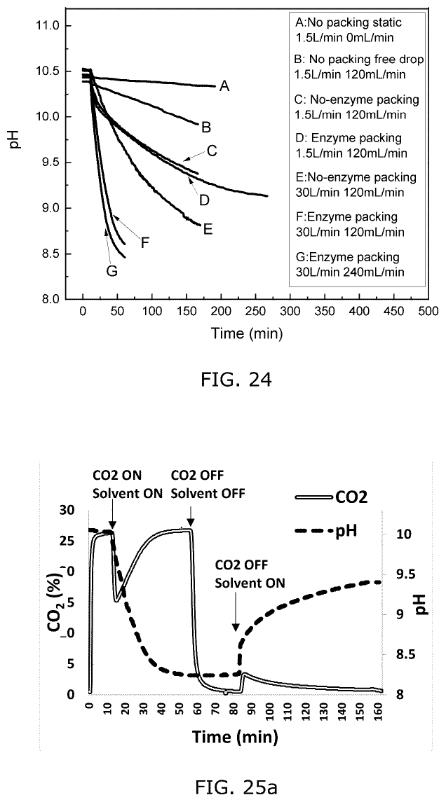

FIG. 24 summarizes the pH changes of disodium phosphate buffer over time in a series of direct air capture CO₂ absorption scrubber tests running in continuous recirculating mode. Inspection of the curves from the top to the bottom (from the slowest to the fastest), shows that the absorption of CO₂ into the buffer through a static liquid surface was slow. Addition of a liquid flow that sprinkled freely in drops from the top of the column and through the empty column interior space increased the pH change rate. Adding a packing inside the column, either with or without immobilized enzyme, dramatically accelerated the rate of pH decrease. At a low air flow rate (1.5 L/min), the effect of immobilized enzyme on rate of pH decrease was modest due to the low amount of CO₂ delivered to the packing compared to the buffer strength. In other words, at the low air flow rate, the rate of change in pH that occurs when CO₂ is absorbed was hidden by the liquid's buffer capacity. Increasing the air flow rate by 20-fold (to 30 L/min) increased the total amount of CO₂ delivered to the packing and resulted in a much faster drop in pH in the presence of immobilized enzyme compared to the no-enzyme packing, which also exhibited a more rapid pH drop compared to the low gas flow condition. As shown in Table E35, the CO₂ capture efficiency of the immobilized enzyme packing was higher than the no-enzyme control packing at both low and high air flow rate conditions. The test condition of high air flow combined with high liquid flow together with immobilized enzyme packing gave the highest carbon uptake rate (0.108 g/hour) even though the percent CO₂ capture efficiency was lower than the low air with low liquid flow condition. The trends of the pH results shown in FIG. 24 agree with CO₂ absorption efficiency observations shown in Table E35. Therefore, by balancing the capital and operating costs of moving air and liquid through the system, an optimized cost-effective solution can be achieved.

TABLE E35
Single packing performance of L-type packing using
disodium phosphate buffer (25 mM, pH 10.50).

| | | | Max. | | | |
|---|---|---|---|---|---|---|
| | Starting | Lowest | Capture | Air flow | Liquid | Carbon |
| | CO2 | CO2 | Efficiency | rate | flow rate | Captured |
| Sample ID | (ppm) | (ppm) | (%) | (L/min) | (mL/min) | (g/hour) |
| No-enzyme | 697 | 551 | 21.0 | 1.5 | 120 | 0.007 |
| packing (low air | | | | | | |
| flow) | | | | | | |
| Enzyme packing | 691 | 240 | 65.3 | 1.5 | 120 | 0.022 |
| (low air flow) | | | | | | |
| No packing free | 853 | 758 | 11.2 | 1.5 | 120 | 0.005 |
| fall (low air | | | | | | |
| flow) | | | | | | |
| No-enzyme | 684 | 682 | 0.4 | 30 | 120 | 0.002 |
| packing (high air | | | | | | |
| flow) | | | | | | |
| Enzyme packing | 693 | 621 | 10.5 | 30 | 120 | 0.070 |
| (high air flow) | | | | | | |
| Enzyme packing | 744 | 632 | 15.0 | 30 | 240 | 0.108 |
| (high air flow + | | | | | | |
| higher liquid | | | | | | |
| flow) | | | | | | |

### Example 36. CO₂ Capture Efficiency at Low and High CO₂% Levels

In addition to CO₂ levels of 10-14% typically present in flue gas generated at coal-fired power plants, lower percent CO₂ levels, such as in the flue gas of natural gas fired power plants, and a higher percent CO₂, such as in raw biogas sources, are also important for CO₂ capture. Nominal 5% and 25% CO₂ levels were used to evaluate and compare the effectiveness of the packings at these ranges (Table E36). At 10% CO₂ level with the gas flow rate of 4 LPM and solvent flow rate of 120 mL/min, L1 no-enzyme control and L surface immobilized enzyme exhibited 23.1% (Example 16) and 66.7% (Example 29) CO₂ capture efficiencies, respectively. Keeping total gas flow rate and solvent flow rate the same, reducing the CO₂ concentration to 5% resulted in an increase in the CO₂ capture efficiencies for both the control and enzyme packing. Increasing the CO₂ concentration to 25% while keeping the gas and solvent flow rates the same decreased the CO₂ capture efficiencies. At the same high CO₂ concentration of 25%, reducing the gas flow rate improved the capture efficiency. These results can be explained by the change in the gas molecule residence time as well as the absorption capacity of the solvent relative to the amount of CO₂ being delivered. These results pertain to the single packing capture efficiencies. In real applications the number of grouped (column width) and stacked packings (column height), solvent and gas flow rates, as well as solvent types and concentrations would be optimized for a desired captured efficiency and an overall lower cost.

TABLE E36
Single packing CO₂ capture efficiencies of L1 no-
enzyme and L surface immobilized enzyme packings.

| | Gas | Solvent | | | | CO₂ Capture |
|---|---|---|---|---|---|---|
| | flow | flow | L/G | Starting | Lowest | efficiency |
| Packing ID | (LPM) | (mL/min) | (mL/L) | CO₂ % | CO₂ % | (%) |
| L1 no- | 4 | 120 | 30 | 5.8 | 4.4 | 24.14 |
| enzyme | | | | | | |
| control | | | | | | |
| L surface | 4 | 120 | 30 | 5.8 | 1.8 | 68.97 |
| immobilized | | | | | | |
| L1 no- | 4 | 120 | 30 | 26.2 | 21.6 | 17.56 |
| enzyme | | | | | | |
| control | | | | | | |
| L surface | 4 | 120 | 30 | 26.1 | 13.3 | 49.04 |
| immobilized | | | | | | |
| L1 no- | 1.6 | 120 | 75 | 24.6 | 14.9 | 39.43 |
| enzyme | | | | | | |
| control | | | | | | |
| L surface | 1.6 | 120 | 75 | 24.7 | 3.0 | 87.85 |
| immobilized | | | | | | |

### Example 37. Solvent Saturation and Regeneration Assisted by Enzyme Immobilized Packing

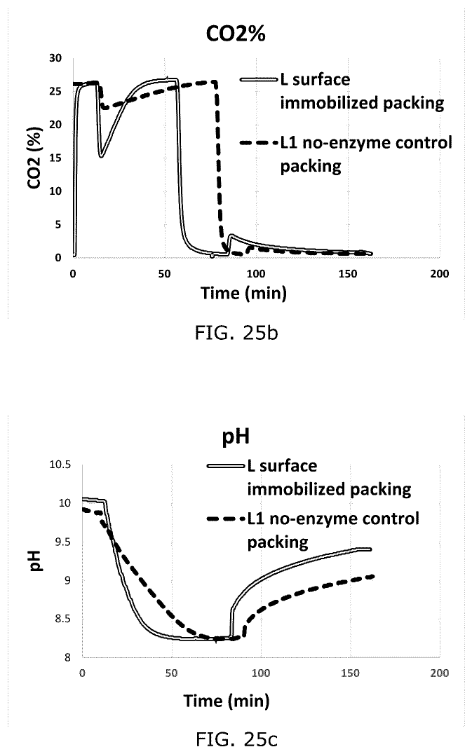

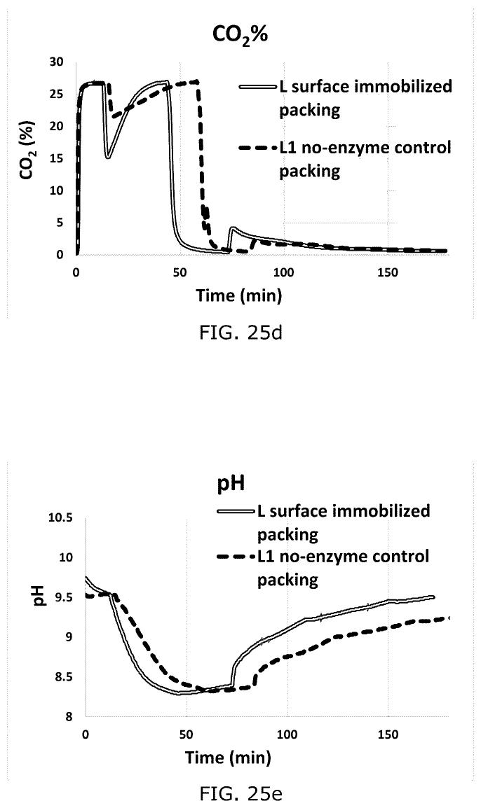

In this example, the laboratory gas scrubber was running at room temperature in a recirculated mode where rich solvent in the bottom reservoir of the absorber (or desorber at the desorption stage) was pumped back up and delivered to the top shower head of the absorption (desorption) column. After packing was installed in the column, CO₂ was supplied to the absorber at a rate of 1 LPM with 3 LPM N₂ as the carrier gas (25% CO₂). Once the CO₂ detector (detector b from Example 9) reached a stable CO₂% reading, the solvent recirculation began followed by a sharp decrease in the CO₂% reading and solvent pH (FIG. 25a). As the absorption process proceeded, the CO₂% reading started to revert back and plateaued at the starting value while the pH reached a low plateau indicating an equilibrium for the absorption of 25% CO₂ into the 10% K₂CO₃ solvent had been established, at which point both CO₂ and solvent recirculation were turned off. N₂ flow was then increased to 4 LPM keeping the total flow rate constant. Gradually, more and more CO₂ gas molecules in the column space were replaced by the N₂ molecules, and the CO₂% approached a baseline reading of 0.5%, which can be attributed to equilibrium out-gassing from the solvent. At the same time, the pH value was largely unchanged with N₂ purging, confirming the slow desorption rate. However, after solvent recirculation through the enzyme immobilized packing resumed (now considered a desorption process) the pH value increased rapidly along with a much higher CO₂% in the carrier gas. As the desorption proceeded further, the rate of pH change flattened and CO₂% in the carrier gas decreased, which are signs of the recirculated solvent approaching a new equilibrium with lower CO₂ in the solvent after exposure to enzyme immobilized packing which assisted the CO₂ desorption process.

Following the same process steps as illustrated in FIG. 25a, FIG. 25b shows a comparison of CO₂% readings between the L1 no-enzyme control packing and the L surface immobilized enzyme packing. Importantly, this result emphasizes the benefit of enzyme catalysis in both the absorption and desorption processes at room temperature. During absorption, for the L1 no-enzyme control packing the CO₂% level decreased from the initial gas concentration of around 27% CO₂ to 22.5% before reverting back to the initial level, whereas the enzyme immobilized packing was able to reach a much lower CO₂% reading of 15.3%, meaning more CO₂ was removed from the gas mixture and absorbed into the solvent, which was also reflected in the faster kinetics and shorter time to reach equilibrium. Similar enhancement behavior was observed for the desorption process, where a higher amount of CO₂ was desorbed for the L surface immobilized packing (Table E37) compared to the L1 no-enzyme control packing. The observed differences in CO₂% readings for catalyzed and non-catalyzed processes were also observed as the differences in the rate of pH change shown in FIG. 25c, where the L surface immobilized packing enhanced pH change rates for both absorption and desorption.

Elevating the solvent temperature to 45° C. resulted in minimal change to the absorption performance (Table E37), while the maximum CO₂% in the desorption process was enhanced by the heat supplied to the system. Both the non-catalyzed and catalyzed packings exhibited increased desorption at 45° C. Nevertheless, the non-heated L surface immobilized enzyme packing (MAX: 3.3% at RT) performed better than the L1 no-enzyme control at both room temperature (MAX: 1.5%) and 45° C. (MAX: 2.2%), a promising application of the enzyme immobilized packing for low energy desorption. The process profiles at 45° C. are shown in FIG. 25d for CO₂% change and in FIG. 25e for pH change.

TABLE E37
Comparison of minimum and maximum CO₂% reading in
the exiting gas mixture during absorption and desorption
processes for L1 no-enzyme control packing and L
surface immobilized packing at RT and 45° C.

| | L1 no-enzyme | L surface |
|---|---|---|
| | control | immobilized |
| | packing | packing |
| | (RT/45° C.) | (RT/45° C.) |
| Absorption MIN CO₂% reached | 22.5/21.5 | 15.3/15.2 |
| Desorption MAX CO₂% reached | 1.5/2.2 | 3.3/4.1 |

### Example 38. Textile Packing Performance Over Time During Continuous Liquid Recirculation using 10% K₂CO₃/KHCO₃

After Example 37 was completed, the L surface immobilized packing module was stored in dry ambient conditions. Then, this packing module was tested again using the conditions described in Example 29 and recirculating liquid through the system continuously for 500 hours. To perform each measurement, the recirculation was paused and a freshly prepared liquid comprising 10% K₂CO₃/KHCO₃ was used throughout the measurement period. After the measurement was complete, the recirculation was resumed. Results in Table E38 show that the starting CO₂ capture efficiency was 57.7% and the ending CO₂ capture efficiency was 57.1%. The average of the 11 data points collected was 56.9% with a standard deviation of 1.0%. The packing had stable performance with narrow day to day variation and no loss of activity in the continuous scrubber test.

TABLE E38
CO₂ capture efficiency during long-term run.

| Time from start (hours) | CO₂ capture efficiency (%) |
|---|---|
| 0 | 57.7 |
| 25 | 56.3 |
| 48 | 55.0 |
| 72 | 57.5 |
| 96 | 58.0 |
| 120 | 56.4 |
| 190 | 55.4 |
| 240 | 57.7 |
| 335 | 57.1 |
| 409 | 57.3 |
| 500 | 57.1 |
| Average | 56.9 |
| STDV | 1.0 |

### Example 39. Smocked Fabric Packing with Rigid Rod Supports

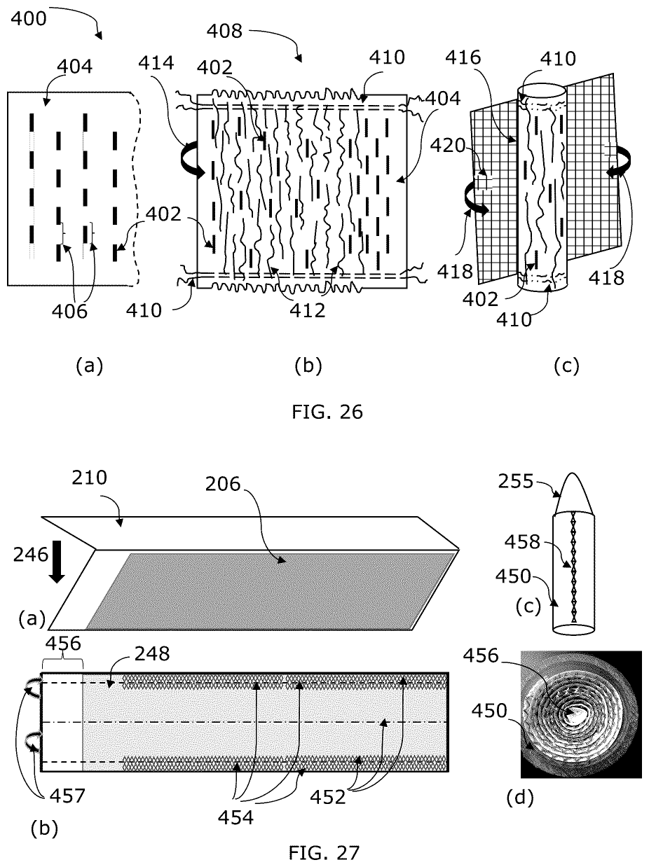

FIG. 26 is a schematic of a process for making another embodiment of the present invention. A nominal 80 mm diameter cylindrical packing module was made using 100% jute burlap plain weave fabric 404 purchased from a fabric retailer. The fabric 404 construction was 5 warp yarn ends/cm and 3.4 weft yarn picks/cm. The burlap fabric had a liquid hold-up of 169% when measured as described in Example 7. The fabric 404 was cut into 25 cm tall (machine direction) by 90 cm wide (horizontal) rectangles. Any selvage on 25 cm edges was left in place or raw 25 cm edges were overlock stitched to secure them from unraveling (not shown). Rigid rods 402 (2 cm long by 3.5 mm diameter bamboo skewers) were interlaced 406 in a vertical direction of the burlap fabric 404 to provide vertical support to the 25 cm packing height of fabric 404. Rod-fabric interlacing 406 was performed as shown in FIG. 26a, with approximately 2-2.5 cm between vertical over-and-under interlacings 406 and approximately 1-1.5 cm distance between rigid rods 402 across the 90 cm fabric 404 width. Once first-phase assembly 400 was made, two weft filling yarns 410 near each of the top and bottom edge of the first-phase assembly 400 were pulled (smocked), causing the fabric 404 to bunch and form gathers 412 until the horizontal dimension of the fabric 404 was decreased from 90 cm to 43 cm., forming a smocked assembly 408 (FIG. 26b). Then the smocked burlap/bamboo skewer assembly 408 was rolled 414 into a cylinder shape 416, and wrapped 418 with a stabilizing wrapper 420 (FIG. 26c) that was sewn in place at the vertical edges (not shown). The stabilizing wrapper 420 was made by sewing 100% cotton cheesecloth (Grade 90, Testfabrics Inc., West Pittston, NJ) (not shown) onto both sides of a 31 cm wide by 22 cm tall rectangle of 5 mesh 50/50 polyester/cotton latch hook canvas 420. A heavy thread loop (not shown) was sewn to the top of the packing module for ease of hanging and handling. Fully assembled gas-liquid contactor modules (not shown) were optionally tested “as is” (control) or were prepared with surface covalently immobilized enzymes (enzyme), as described in Example 28, and air dried at least overnight before testing. The contactors were tested in an 80 mm diameter absorber column. A completed contactor assembly rested firmly against the lower packing support lip of the column, ensuring that gas would pass upwards through the packing. In this design, the approximate 1 mm square-shaped holes throughout the burlap fabric's woven construction allowed gas to easily pass through the assembly. The purpose of gathering the fabric was to create three-dimensional tortuous paths for gas molecules to travel as they pass through the packing, which enhances interaction between gas molecules and packing materials. Enhancing these interactions enhances gas-liquid contact when the packing materials are wet with solvent. CO₂ capture efficiencies of the control and enzyme packings were 23.2% and 64.3%, respectively, using 10% K₂CO₃/KHCO₃ 85/15 PH ˜10.5 at a liquid flow rate of 120 mL/min, CO₂ gas flow rate of 0.4 LPM, and N₂ gas flow rate of 3.6 LPM. In addition, no flooding was observed even at a high air flow rate of 120 LPM together with a high liquid flow rate of 700 mL/min. This example demonstrates that packing modules of the present invention can be fabricated using various materials and constructed in various designs, and that packing module performance can be controlled by choice of materials and design. This example further illustrates that well-performing packing modules can substantially be made using naturally-derived materials, e.g., in this case jute, bamboo, cotton, chitosan and enzymes. In this design, the size of the holes in the burlap fabric were sufficiently large to allow passage of gas and liquid without causing flooding, while also being sufficiently compact to provide high gas-liquid contact and high CO₂ absorption efficiency, especially in the presence of enzymes. The jute fiber of the burlap yarns allowed liquid to spread evenly and drain quickly through the packing. This can improve CO₂ capture efficiency by rapidly delivering fresh solvent and transporting products away from enzyme active sites. Without being bound by any particular theory, one explanation for the relatively higher CO₂ absorption performance of the burlap packing compared to the cheesecloth packing (Example 41) may be that the lower liquid hold-up of burlap (this Example) compared to cheesecloth (Example 8) allowed for more interaction between the gas, the liquid and the solid, thereby promoting the CO₂ absorption reaction, and this was further enhanced by the presence of enzyme. In this case, a textile-based packing material with a relatively lower liquid hold-up could be preferred.

### Example 40. Large Spiral Packing Comprising Metal Spacers

A scaled-up version of the large spiral packing design described in Example 7 was fabricated. As shown in FIG. 27, 100% cotton cheesecloth 210 (Grade 90, Testfabric Inc., West Pittston, NJ) was cut into 166 cm wide×44 cm high rectangles. Latch hook canvas 206 (50/50 polyester/cotton, 5 mesh, approximate 5.2 mm center-to-center distance per opening, approximate 4 mm opening size, approximate 1.2 mm yarn thickness) was cut into 152 cm wide×22 cm high rectangles. Packing modules 450 were assembled as follows: a) cheesecloth 210 was folded 246 over canvas 206 to form a sandwich 248 with loose cheesecloth 456 shown on the left side; b) upper and lower edges and the middle of the sandwich 248 were secured together by machine sewn stitches 452 across the width; c) metal spacers 454 were laid along the upper and lower sandwich 248 edges; d) the assembly was rolled into a tight spiral, with the metal spacers 454 on the inside and starting with the end 456 having loose cheesecloth 210 (this fills the center of the spiral 456); e) the assembly was test fitted in a 3-inch diameter sample column pipe (not shown) and adjustments were made to fit in and fill the diameter; f) the fitted assembly 450 was sewn along the loose wrapped edge 458 to hold the whole assembly securely together; and, g) a thread loop 255 was sewn to the top of the module for ease of handling. FIG. 27d is a photograph taken from above assembly 450. Metal spacers were made using raised diamond shaped galvanized steel metal lath or welded grid stainless steel wire mesh (4 mesh size, approximate 6 mm opening, approximate 1 mm wire diameter) purchased from home improvement and hardware retailers. These materials provided rigidity to the packing structure, porosity to allow gas and liquid flow, and corrosion resistance to withstand the process conditions. Other shapes and materials having these properties could also be used. Metal spacers used in step “c” above were cut as 3.5 cm×68 cm strips, then two strips were laid end-to-end along each upper and lower edge, aligned to the end, before rolling the assembly into a spiral. The assembled packing modules were coated using a scaled-up version of the surface covalent enzyme immobilization method described in Example 28. Briefly, 20 g chitosan powder (ChitoClear® 44020-fg95LV, Primex ehf, 580 Siglufjordur, Iceland) was dissolved in 2 L of 5% acetic acid solution and filled in a 2 L graduated cylinder. An assembled packing module was immersed in the chitosan solution for 15 minutes, then removed, drained, air dried in a fume hood for 1-2 days, then oven dried at 60° C. to a constant weight. Phosphate buffered saline solution (1.5 L, pH 7.4, 0.01 M phosphate buffer, 0.0027 M potassium chloride and 0.137 M sodium chloride) and NZCA enzyme (7.5 mL) were combined in a clean 2 L graduated cylinder with stirring at 200 RPM using a 2-inch magnetic teflon coated stir bar. A chitosan-coated packing module was fully immersed in the solution and suspended there by the thread loop, followed by immediate addition of 6 mL of 50% glutaraldehyde. Constant mixing was continued for 18 hours at room temperature while the enzyme immobilization reaction occurred, after which the packing was removed, rinsed thoroughly with water, drained, and then suspended in a clean 2 L graduated cylinder containing 1.5 L of 25 mM pH 7.4 Tris buffer with 200 RPM magnetic stir bar mixing for 4 hours. The textile packing with immobilized enzyme was removed, rinsed thoroughly with water, air dried for at least 1 day, and was tested in a laboratory gas scrubber system fitted with an 80 mm diameter glass column. Several packing modules prepared and tested in this way gave CO₂ absorption efficiencies ranging from 48% to 55%, which is higher performance than packings prepared by the same steps, but excluding NZCA. The packings without NZCA gave CO₂ absorption efficiencies ranging from 17.0% to 20.9%. In addition, each packing was subjected to a counter-current flooding test and all packings were found to be flooding free up to the highest tested gas flow rate of 120 LPM and up to 700 mL/min liquid flow. Therefore, including spacer materials in a spiral packing design is useful for the fabrication and performance of the packing modules, and various shapes and types of materials can be used as spacers.

### Example 41. Comparison of Textile-Based Packings Operating in Counter-Current and Co-Current CO₂ Absorption Mode

Gas scrubbers operating in co-current mode, where gas and liquid flow in the same direction, offer the benefit of accommodating high flow rates (Arthur L. Kohl and Richard B. Nielsen, Gas Purification, 5th Ed., Gulf Publishing, 1997). Two different 3-inch diameter textile-based packing designs of the present invention were tested in both counter-current and co-current mode, with other laboratory scale test conditions remaining constant. CO₂ absorption efficiency results are shown in Table E44. CO₂ capture efficiency in co-current mode was almost as high as the corresponding efficiency in counter-current mode for each tested packing type, demonstrating the operational versatility of textile-based packing modules. This example also shows that CO₂ capture efficiency can be controlled by changing the textile packing design. The burlap packing design gave higher CO₂ capture efficiency in both counter-current and co-current mode than either mode of the large spiral packing design.

TABLE E41
Comparisons of CO₂ capture efficiencies
in counter- and co-current mode

| | CO₂ capture |
|---|---|
| Packing Description | efficiency (%) |
| Counter-current Enzyme immobilized burlap packing | 64 |
| Co-current Enzyme immobilized burlap packing | 58 |
| Counter-current Enzyme immobilized large spiral | 44 |
| packing with stainless steel mesh spacer | |
| Co-current Enzyme immobilized large spiral packing | 37 |
| with stainless steel mesh spacer | |

### Example 42. Comparison of Column Flooding in Counter-Current and Co-Current Mode

Textile-based packing modules assembled with very dense structures were made as in Example 7 (FIG. 5), except they were larger (3 inches diameter versus 2.5 inches) and the excess cheesecloth at the bottom was cut off instead of being gathered. Textile-based packing modules can achieve high levels of CO₂ absorption. However, at high gas flow rates, dense packings may exhibit flooding when operated in counter-current gas contacting mode. Flooding occurs when the rate of gas flowing upwards through the packing prevents liquid from flowing downwards, causing liquid to accumulate in the packing. Dense textile packing P4 achieved 79% CO₂ absorption when tested in counter-current mode at a total gas flow rate of 4 LPM, and no flooding was observed. This P4 packing was subsequently subjected to a flooding test, in which the packing was installed in the laboratory column and exposed to different levels of gas (air) flow rate and liquid (water) flow rate. As shown in Table E42, when operated in counter-current mode, P4 packing flooded across all air flow rates (10-120 LPM) tested, which were all higher than the total gas flow rate of 4 LPM used to obtain the CO₂ capture efficiency measurement. However, no flooding was observed at any air flow rates tested when the same P4 packing was operated in co-current mode. Even at the maximum air flow rate of 120 LPM and liquid flow rate of 700 mL/min, no flooding was observed in co-current mode. When gas and liquid flowed in the same direction, flooding did not occur at all, even for the very dense P4 packing structure. Therefore, operation in co-current mode is one effective way of overcoming flooding, should that arise when using textile-based packings. Furthermore, as illustrated in Example 41, the CO₂ absorption efficiency can remain high when operating in co-current mode.

TABLE E42
Laboratory column flooding test of P4 textile-
based packing in co-current mode

| Air flow (LPM) | Liquid flow (mL/min) | Counter-current | Co-current |
|---|---|---|---|
| 10 | 300 | Flooded | No flooding |
| 20 | 300 | Flooded | No flooding |
| 30 | 300 | Flooded | No flooding |
| 40 | 300 | Flooded | No flooding |
| 50 | 300 | Flooded | No flooding |
| 80 | 300 | Flooded | No flooding |
| 120 | 300 | Flooded | No flooding |
| 120 | 700 | Flooded | No flooding |

### Example 43. Compatibility of Cotton with CO₂ Absorption Solution

The ability of cotton to withstand exposure to an alkaline CO₂ absorption solution was demonstrated by incubating 3 cm wide×15 cm long (weft direction) strips of 100% cotton fabric (bleached plain weave, 98 g/m², Style 400, Testfabrics, West Pittston, NJ) at each of the following conditions: untreated fabric stored at ambient conditions (control); immersed in deionized water at ambient temperature (22° C.); immersed in deionized water at 115° C.; or, immersed in 30% MDEA (pH 10.4) at 115° C. Five replicates of each treatment were prepared. The fabric strips exposed to liquid were rolled up and each placed in separate 20 mL glass screw cap vials to which 10 mL of treatment liquid was added, which completely immersed each strip, and the lids were securely sealed. Vials were kept at ambient temperature or were placed in a heated dry bath set at 115° C., covered with aluminum foil to maintain temperature. After a treatment time of 160 hours, liquid-treated samples were removed from the vials and washed in running tap water for one minute, then squeezed of excess water and laid flat on a rack to air dry. After air drying, samples were conditioned for at least 24 hours at 70° F. and 65% relative humidity. Sample tensile properties were then measured using a MTS Q-Test5 Constant Rate of Elongation (CRE) Tensile Tester set up with a 1000 lb load cell, 75 mm gauge length, and 300 mm/min crosshead speed. Measurements were performed according to ASTM D5053 Standard Test Method for Breaking Force and Elongation of Textile Fabrics (Strip Method) using the raveled strip specimen method, with each sample raveled to a 23 mm width prior to testing. As shown in Table E43, the average test results were similar across the different treatments and similar to the untreated control, indicating that cotton fabric withstands prolonged exposure to a typical alkaline CO₂ absorption solvent, even at elevated temperature.

TABLE E43
Average tensile properties of incubated cotton fabrics.

| | | | Elongation at Peak | |
|---|---|---|---|---|
| | Peak Stress (MPa) | | Load (%) | |
| | | Std | | Std |
| Treatment | Average | Dev | Average | Dev |
| Untreated (control) | 30 | 1.6 | 27 | 1.1 |
| Water, 22° C. | 29 | 2.0 | 30 | 0.9 |
| Water, 115° C. | 27 | 1.4 | 29 | 1.2 |
| 30% MDEA, 115° C. | 28 | 1.9 | 29 | 1.8 |

Although the invention is illustrated and described herein with reference to specific embodiments, the invention is not intended to be limited to the details shown. Rather, various modifications may be made in the details within the scope and range of equivalents of the claims and without departing from the invention. What is claimed:

1. A textile packing comprising:
a) hydrophilic fibers; and
b) a support structure,
wherein the support structure holds the hydrophilic fibers, wherein a top end and a bottom end of at least a portion of the hydrophilic fibers are fluidly connected, and wherein the support structure also ensures space between the hydrophilic fibers for a gas to pass through.

2. The textile packing of claim 1, further comprising c) an active enzyme, wherein the active enzyme is attached to the hydrophilic fibers.

3. The textile packing of claim 1, wherein a filament, a yarn and/or a textile comprises the hydrophilic fibers.

4. The textile packing of claim 1- or 2, wherein at least a portion of the hydrophilic fibers comprise cellulosic fiber, protein fiber, polyamide fiber, acetate fiber, triacetate fiber, modified cellulosic fiber, acrylic fiber, modacrylic fiber, polyvinyl alcohol fiber (vinal), poly(ethylene oxide) (PEO) fiber, crosslinked poly(ethylene glycol) diacrylate fiber, polyester fiber, hydrophilic modified polyester fiber, poly(lactic acid) fiber, poly(hydroxyalkanoate) fiber, polyalanine (PANI), chitaline, polyvinyl pyrrolidone (PVP), crosslinked PVP, and/or poly(etheretherketone) (PEEK) fiber.

5. The textile packing of claim 3, wherein the yarn and/or textile comprise hydrophobic fibers, and wherein at least a portion of the hydrophobic fibers comprise olefin, fluorocarbon, vinyon, glass, metallic, rubber, polyvinylidene chloride (Saran®), and/or carbon fiber.

6. The textile packing of claim 1, wherein the support structure comprises a mesh and/or rigid rods, a textile comprises the hydrophilic fibers, and the textile packing further comprises a spacer attached to the textile and/or to the mesh.

7. The textile packing of claim 6, wherein the textile packing is in a spiral shape or in the shape of a jelly roll formed by layering the textile and the mesh to form layers and winding the layers together in a horizontal direction.

8.-11. (canceled)

12. The textile packing of claim 3, wherein the filament, the yarn, and/or the textile comprises immobilized antibiotic or metal nanoparticles or protease.

13. (canceled)

14. The textile packing of claim 2, wherein the active enzyme is selected from the group consisting of an oxidoreductase, a transferase, a hydrolase, a lyase, an isomerase, and/or a ligase; or wherein the active enzyme comprises a carbonic anhydrase.

15. The textile packing of claim 14, wherein the active enzyme attachment is selected from the group consisting of entrapment in the hydrophilic fibers, entrapment in a polymeric coating on the hydrophilic fibers, entrapment in a chitosan material coating on the hydrophilic fibers, covalent bonding to the hydrophilic fibers, covalent bonding to the polymeric coating, and/or covalent bonding to the chitosan material coating.

16-19. (canceled)

20. The textile packing of claim 2, wherein a retained enzyme activity after 10 cycles of washing the textile packing in a Tris buffer (pH 7.2) and drying the textile packing is at least 20% of an initial enzyme activity.

21. (canceled)

22. (canceled)

23. A process for removing CO₂ from a gas, the process comprising:
a) feeding a first CO₂-rich gas to a first reactor,
b) feeding a CO₂-lean absorption liquid to the first reactor
c) reacting CO₂ in the first CO₂-rich gas with a component of the CO₂-lean absorption liquid as the first CO₂-rich gas and the CO₂-lean absorption liquid flow through a first reaction zone to form a CO₂-lean gas and a CO₂-rich absorption liquid;
d) removing the CO₂-lean gas from the first reactor; and
e) removing the CO₂-rich absorption liquid from the first reactor,
wherein the first reactor comprises the first reaction zone, wherein the first reaction zone contains a gas-liquid contact enhancer, and the gas-liquid contact enhancer comprises at least one of the textile packings, wherein the textile packing comprises
i) hydrophilic fibers; and
ii) a support structure,
wherein the support structure holds the hydrophilic fibers, wherein a top end and a bottom end of at least a portion of the hydrophilic fibers are fluidly connected, and wherein the support structure also ensures space between the hydrophilic fibers for a gas to pass through.

24. The process of claim 23, wherein the first reaction zone comprises at least one section, and the gas-liquid contact enhancer for each of the sections is independently selected from the group consisting of the textile packing, structured packing, and/or random packing, wherein the structured packing and/or random packing consist essentially of metal, glass, ceramic, and/or plastic.

25. The process of claim 23, wherein the gas-liquid contact enhancer proximate to the top of the first reaction zone is the textile packing, and wherein an active enzyme is attached to the hydrophilic fibers or wherein the active enzyme is dissolved in the CO₂-lean absorption liquid.

26. The process of claim 24, wherein a cross-sectional area of at least one of the sections is substantially filled with multiple ones of the textile packings, and wherein the textile packings are grouped in close contact and substantially fill the cross-sectional area of the at least one of the sections.

27. The process of claim 23, wherein the component of the CO₂-lean absorption liquid comprises aqueous alkanolamines selected from the group consisting of monoethanolamine (MEA), diethanolamine (DEA), N-methyldiethanolamine (MDEA), 2-amino-2-hydroxymethyl-1,3-propanediol (Tris or AHPD), diglycolamine (DGA), 1-amino-2-propanol (A2P), 2-amino-2-methyl-1-propanol (AMP), methylmonoethanolamine (MMEA), dimethylmonoethanolamine (DMMEA), diethylmonoethanolamine (DEMEA), diisopropanol amine (DIPA), triisopropanolamine (TIPA), aqueous soluble salts (e.g., sodium or potassium salts) of N-methylaminopropionic acid or N,N-dimethylaminoacetic acid or N-methylalanine, N-methylglycine (sarcosine), N,N-diethylglycine, N,N-dimethylglycine (DMG), beta-alanine (3-aminopropanoic acid) or other natural or modified amino acids (e.g., N-substituted amino acid derivatives), 2-(2-aminoethylamino) ethanol (AEE), triethanolamine (TEA); aqueous soluble salts of glycine (e.g., sodium or potassium glycinate) and taurine.

28. (canceled)

29. The process of claim 23, wherein the CO₂-lean absorption liquid comprises preservatives and/or antimicrobial agents.

30. The process of claim 23, wherein a source of the first CO₂-rich gas is selected from the group consisting of natural gas, biogas, industrial process gas, combustion flue gas, contained environments, respiration gas, and ambient air.

31-35. (canceled)

36. The process of claim 23, further comprising:
f) feeding the CO₂-rich absorption liquid to a pond;
g) releasing CO₂ from the CO₂-rich absorption liquid as the growth medium for a biological system; and
h) recovering the CO₂-lean absorption liquid from the pond.

37-41. (canceled)

42. The process of claim 23, wherein the absorption liquid and the component are selected from the group consisting of aqueous solutions comprising NaOH, KOH, LiOH, alkali-metal carbonate salts (e.g., lithium, sodium, potassium, or ammonium), alkali-metal bicarbonate salts, alkali-metal phosphate salts, or borate salts; seawater or pH adjusted seawater; industrial process water comprising divalent cations or pH adjusted industrial process water comprising divalent cations; saline aquifer water or pH adjusted saline aquifer water; aqueous ammonium (NH₄OH); and/or aqueous electrolyte solutions and promoters.
